(19) United States
(12) Patent Application Publication
(10) Pub. No.: US 2008/0090034 A1
(43) Pub. Date: Apr. 17, 2008

(54) Colored glass frit

(76) Inventors: Daniel J. Harrison, Pittsford, NY (US); Pamela A. Geddes, Alden, NY (US); Bernard Balling, Lockport, NY (US); William C. La Course, Alfred, NY (US); Walter Mason, Alfred, NY (US)

Correspondence Address: HOWARD J. GREENWALD P.C., 349 W. COMMERCIAL STREET SUITE 3075, EAST ROCHESTER, NY, 14445-2408, US

(21) Appl. No.: 11/901,378

(22) Filed: Sep. 17, 2007

Related U.S. Application Data
(60) Provisional application No. 60/845,290, filed on Sep. 18, 2006.

(51) Int. Cl. B41M 5/00; C03C 8/14; C09D 11/00

(52) U.S. Cl. 428/32.71; 106/31.13; 501/17

(57) ABSTRACT

A colored glass frit with a specific surface area of less than 2 square meters per gram that contains from about 1 to about 80 weight percent of metallic element material and from about 30 to about 80 mole percent of glassy network forming oxide material. The frit has a transmission density per micron of thickness of at least about 0.1; when formed into a continuous film of 3 microns thickness and deposited onto a glass substrate, its transmission density is at least 0.3. The glassy network forming oxide material is homogeneously disposed in the flit, and the metallic element material is inhomogeneously dispersed within the glassy network forming oxide material. The metallic element material is in particulate form and has a particle size distribution such that at least 95 weight percent of its particles are smaller than 300 nanometers.

### CROSS-REFERENCE TO RELATED PATENT APPLICATION

This application claims priority based upon applicants' provisional patent application 60/845,290, filed on Sep. 18, 2006.

### FIELD OF THE INVENTION

A colored glass frit comprised of from about 1 to about 80 weight percent of metallic element material and from about 30 to about 80 mole percent of glassy network forming oxide material; when formed into a film with a thickness of 3 microns and coated onto a glass substrate, the colored glass frit has a transmission density of at least about 0.3.

### BACKGROUND OF THE INVENTION

Glass articles, such as glass sheets, are often decorated using glass coating compositions that contain one or more glass frits. These glass frits are well known to those skilled in the art. Reference may be had, e.g., to U.S. Pat. Nos. 3,607,180 (bonding with a glass frit coating applied by a knurled roller), 3,772,043 (cermet protective coating glass frit), 3,951,672 (glass frit containing lead ruthenate or lead iridate), 4,021,253 (method for manufacturing glass frit), 4,049,872 (glass frit composition for sealing window glass), 4,355,115 (borosilicate glass frit with MgO and BaO), 4,390,636 (glass frit of diopside crystal precursors), 4,446,241 (lead-free and cadmium-free glass frit compositions), 4,554,258 (chemical resistant lead-free glass frit compositions), 4,731,347 (glass frit composition), 4,892,847 (lead-free glass frit compositions), 5,608,373 (glass flit compositions compatible with reducing materials), 5,710,081 (black glass frit), 6,100,209 (glass frit), 6,333,116 (crystallizing glass frit composition), 7,079,374 (glass frit for dielectrics), and the like. The entire disclosure of each of these United States patents is hereby incorporated by reference into this specification.

U.S. Pat. No. 5,710,081 discloses and claims a particular black glass frit made by a process in which a metal-oxide-containing glass melt is contacted with reducing agent. In the process of this patent, metal-oxide forming glass raw materials (including iron oxide at a concentration of from 0.5 to 3.0 weight percent) and sulfur are melted at a temperature of from 1,000 to 1,200 degrees Centigrade in a reducing gas atmosphere to form a melt; and the melt is then quenched to form a frit. Without wishing to be bound to any particular theory, applicants believe that the glass made by the process of this invention is not strongly absorbing and does not create an intense color when applied as thin films (i.e., films less than 30 microns, preferably less than 20 microns, and more preferably less than 10 microns). The process described in U.S. Pat. No. 5,710,081 reduces iron oxide to iron sulfide in the melt in a reducing atmosphere, but the colored pigments which are formed in such process tend precipitate out of the melt; and the frit that is formed from such glass melt thus has a relatively low concentration of the colored pigments and relatively poor optical properties.

In the process described in U.S. Pat. No. 5,612,262, silicon metal is used to reduce titania in the glass melt to produce a blue color. However, this color is not intense in thin films because the melt process can only tolerate minor amounts of the reducing agent Si. The amount of Si required to reduce large amounts of TiO₂ would result in inhomogeneous glass with a very high glass temperature. In addition, the temperatures required to incorporate large quantities of TiO₂ into the glass composition is not practical.

U.S. Pat. No. 6,100,209 provides an alternative process for preparing a colored glass frit. In the process of the '209 patent, a glass frit is heated in the presence of a reducing agent in order to reduce the “metal moiety” in the frit and produce color. The glass frit used in the process of the '209 patent must be “ . . . appropriate . . . ” (see lines 50-52 of column 3). At lines 56-67 of such column 3, “appropriate” is described as follows: “The initial glass flit (sic) which is heated usually contains at least one of the following constituents: bismuth oxide, lead oxide, antimony oxide, titanium dioxide, arsenic oxide, and cadmium oxide; usually in a total content of 5-70, preferably 15-60, especially 35-55% by weight. Other constituents such as silica, titania, boric oxide, alumina, lanthanum oxide, zirconia, ceria, tin oxide, magnesia, calcium oxide, strontium oxide, lithium oxide, sodium oxide and potassium oxide can be employed to optimize the desired physical properties of the frit, for instance so that the thermal expansion matches that of the glass, especially window the glass,”

At column 4 of U.S. Pat. No. 6,100,209, and at lines 2-6 thereof, it is disclosed that: “ . . . . Bismuth oxide, optionally plus titanium dioxide, is preferably present. The present metal is preferably bismuth. The initial frit can be prepared in the usual way, by melting components together and then quenching . . . .” There does not appear to be any suggestion in U.S. Pat. No. 6,100,209 of comminuting the frit produced by quenching prior to contacting it with reducing gas. There does not appear to be any description in such patent of the particle size of the frit that is subjected to contact with reducing gas.

At column 4 of the patent (see lines 8-18), it is disclosed that “The glass structure of the initial glass frit must clearly contain metal moiety capable of this reduction . . . . Preferably the reduced metal moiety is present throughout the glass frit, not only on its surface . . . . The reduced metal moiety may be in the form of colloidal particles”

It does not appear that, with the exception of the Examples, any other description occurs of the glass frit used in the process of the '209 patent. In the Examples, certain frits are described by reference to trade names, but such a description is usually inadequate. As is disclosed at page 600-98 of the August, 2005 (revision 3) edition of the Manual of Patent Examining Procedure, “The relationship between a trademark and the product it identifies is sometimes indefinite, uncertain, and arbitrary. The formula or characteristics of the product may change from time to time and yet it may continue to be sold under the same trademark. In patent specifications, every element or ingredient of the product should be set forth in positive, exact, intelligible language, so that there will be no uncertainty. Arbitrary trademarks which are liable to mean different things at the pleasure of the manufacturers do not constitute such language.”

In “EXAMPLE 1A AND COMPARATIVE EXAMPLE 1B,” reference was made to “A bismuth-containing glass frit available from Cookson Matthey Ceramics plc under the designation B5236MF (Glass transition temperature 460° C.) . . . .” With the exception of its glass transition temperature, there was no other description of the physical or chemical properties of this frit. Thus, e.g., there was no description of the particle size distribution of this frit.

The experiments described in “EXAMPLE 1A AND COMPARATIVE EXAMPLE 1B,” and also in “EXAMPLE 2,” were the only experiments described in U.S. Pat. No. 6,100,209 in which a gaseous reducing agent (5% hydrogen, 95% nitrogen) was used. In these experiments, the “reduced frit composition” was comminuted (in a ball mall) “ . . . to a B.E.T. surface area of approximately 3 m² g⁻¹ . . . .”

The “reduced frit composition” described in such example was “ . . . mixed with 3.33 g of a black copper chromite pigment and 4 g of an IR ink medium based on pine oil . . . . The components were triple milled to form a paste and printed onto a float glass substrate to form a layer approximately 27 um thick. After drying this, a silver paste was printed over areas of the black paste . . . .”

There is no description in U.S. Pat. No. 6,100,209 of the optical properties of the “black paste” of such example. However, without wishing to be bound to any particular theory, applicants believe that such paste did not have an adequately high color density per unit volume. Such high color density per unit volume is essential for imaging onto glass and ceramic substrates. In particular, to achieve high contrast on transparent substrates (such as glass) requires images to be highly opaque and to have a high transmission density. This may be accomplished by applying a thick image layer of 25 or more microns to the transparent substrate with analog imaging methods, such as silk screen printing. However, many digital imaging methods (such as thermal transfer printing, electro-photographic printing and ink jet printing) can not easily apply such a thick image layer. Such digital imaging methods are often limited to applying imaging layers of 15 microns in thickness or less to a substrate. Because of this limitation in thickness, the thinner digitally applied imaging layer must be higher in opacity or transmission density per unit thickness than a thicker imaging layer applied by analog means in order to achieve a comparable image.

It is known to those skilled in the art that the transmission density is inversely proportional to the amount of light which passes through an image. The transmission density is equal to the log₁₀ (1/transmittance). The transmittance is the fraction of incident light at a specified wavelength that passes through an image. The lower the percent transmittance, the higher the transmission density will be. In one embodiment, it is preferred that the transmission density of the digital frit image on glass be greater than 1 (<10% transmittance). It is more preferred that the transmission density of the digital frit image on glass be greater than 1.5 (<3% transmittance). It is further preferred that the transmission density of the digital frit image on glass be greater than 2 (<1% transmittance).

As is known to those skilled in the art, the effective contrast of an imaging technology is related to the transmission density of the printed image per unit thickness of the image. Although digital imaging technologies may not be capable of applying thick imaging layers, they may still be capable of achieving high contrast so long as the transmission density of the image, per unit thickness of the image is high

It is an object of one embodiment of this invention to provide a digitally applied image comprised of glass frit with a transmission density (“Td”) of at least 0.3 as determined by a test in which the frit is formed as a continuous film with a thickness of 3 microns on a glass substrate and thereafter tested. It is preferred that the transmission density be at least 1.0; and it is more preferred that such transmission density be at least 1.5.

The transmission densities of glass frit are discussed in U.S. Pat. No. 5,710,081, the entire disclosure of which is hereby incorporated by reference into this specification. Claim 7 of this patent discloses a particular black glass with a transmission thereof for a 30 micron thick stoved glass layer of less than 2 percent.

Example 1 of U.S. Pat. No. 5,710,081 discloses a product with a percent transmission at 550 nanometers of 47.1 percent, corresponding to a transmission density of 0.337 and a Td/micron of thickness of 0.0109. Example 2 of this patent discloses a product with a percent transmission at 550 nanometers of 1.4%, corresponding to a transmission density of 1.854 and a Td/micron of thickness of 0.0618. Example 3 in this patent discloses a product with a percent transmission at 550 nanometers of 0.9 percent, corresponding to a transmission density of 2.046 and a Td/micron of thickness of 0.0682. Example 4 in this patent discloses a product with a percent transmission at 550 nanometers of 0.8 percent, corresponding to a transmission density of 2.097 and a Td/micron of 0.0699.

The frit described in U.S. Pat. No. 6,100,209 is designed to reduce the migration of silver ions through the bulk of the fired frit. While the frit of the '209 patent it described as black, it is also said to only contain up to 30 weight percent of reduced metal moieties. In the '209 patent flit is applied to substrates using analog printing methods (such as silk screen) and examples reveal image thicknesses of 26 to 27 microns. The examples of the '209 patent also disclose frit particle sizes of 10 to 12 microns. The '209 patent disclosed the use of pigments to enhance the opacity of image and to improve firing. Such pigment is advantageously added before reduction of the metal oxides. Said pigments may be added at a level of up to 50 weight percent of the composition. Such pigments should not contain copper, to avoid the formation of a reddish brown color.

By comparison, and in the instant invention, the inventors have discovered that, in order to achieve high transmission densities per micron in digitally printed images less than 15 microns in thickness, the proportion of metal oxide moieties that are reduced in the frit should preferably be higher than 30 percent and more preferably, higher than 40 percent. It has also been discovered that the frit should be small in particle size, preferably less than 10 microns in average particle size. It has also been discovered that the addition of pigment to the imaging layer increases the transmission density; however, the proportion must not exceed about 30 weight percent. Pigments containing copper, such as copper chrome ferrite, have been found to work well in the instant invention, as well as manganese ferrite. Typically, pigments are preferably added to the frit after reduction of the metal oxide moieties so that they do not interfere with the reduction process. It is preferred to use from about 5 to about 30 weight percent of such pigment. In a more preferred embodiment, from about 10 to about 20 weight percent of such pigment is used.

### SUMMARY OF THE INVENTION

A colored glass frit with a specific surface area of less than 2 square meters per gram that contains from about 1 to about 80 weight percent of metallic element material and from about 30 to about 80 mole percent of glassy network forming oxide material. The frit has a transmission density per micron of thickness of at least about 0.1; when formed into a continuous film of 3 microns thickness and deposited onto a glass substrate, its transmission density is at least 0.3. The glassy network forming oxide material is homogeneously disposed in the frit, and the metallic element material is inhomogeneously dispersed within the glassy network forming oxide material. The metallic element material is in particulate form and has a particle size distribution such that at least 95 weight percent of its particles are smaller than 300 nanometers.

### BRIEF DESCRIPTION OF THE DRAWINGS

The invention will be described by reference to the following drawings, in which like numerals refer to like elements, and wherein:

FIG. 1 is a flow diagram of one preferred process of the invention;

FIGS. 2, 3, and 4 each present a schematic of a thermal ribbon assembly comprised of colored frit;

FIG. 5 is a schematic of a covercoat assembly;

FIG. 6 is a schematic of one preferred process for producing the colored frit of this invention; and

FIG. 7 is a schematic sectional view of one preferred flit particle.

### DESCRIPTION OF THE PREFERRED EMBODIMENTS

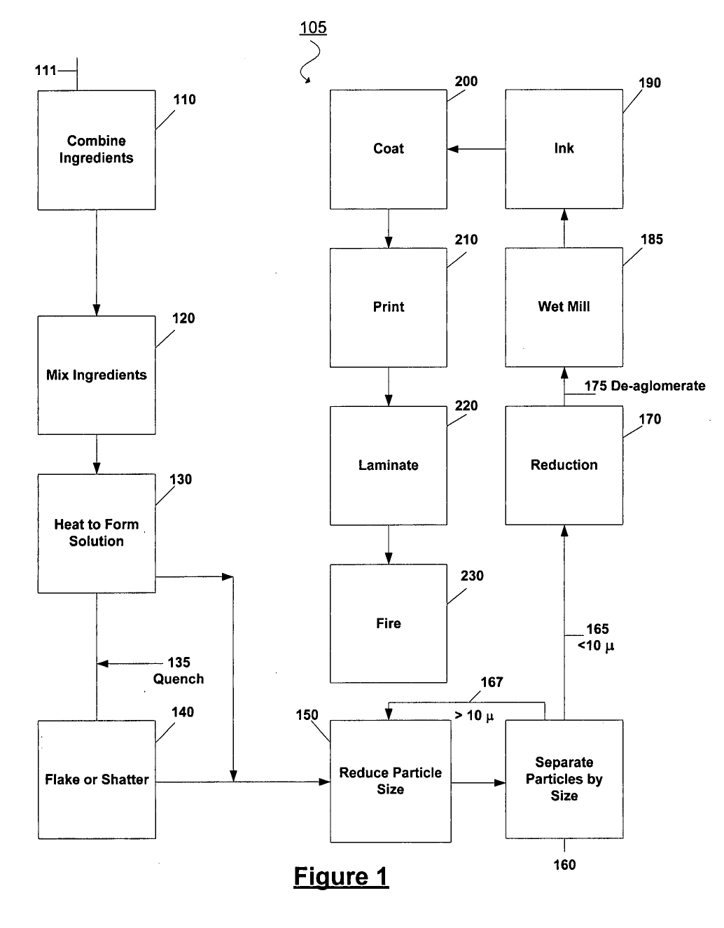

A preferred process 105 for producing a colored glass frit is shown in FIG. 1. In step 110 of this process the ingredients used in this process are weighed out and combined together. For example one or more glassy network forming oxides are combined with intermediates, modifiers and reducible metal compound moieties.

The glass batch produced in steps 110 and 120 may contain many different combinations of ingredients which, upon fusing, form glass.

There are a number of general glass families, some of which have many hundreds of variations in composition. It has been estimated that there are over 50,000 “glass formulas,” i.e., combinations of materials for the glass batch. Many of these can be used to produce the glass frit of this invention, provided that the glass batch is comprised of specified amounts of the reducible metal compound moieties used in the process of the invention.

Steps 110, 120, and 130 of FIG. 1 describe various batching processes used to make the glass batch of this invention and melt it. These batching processes may be conducted in substantial accordance with prior art batching processes. Reference may be had, e.g., to U.S. Pat. Nos. 3,601,367 (mixing glass batch materials), 3,607,189 (melting particulate glass batch), 3,607,190 (method and apparatus for preheating glass batch), 3,753,743 (method for preparing glass batch), 3,914,364 (method of pelletizing glass batch), 3,941,574 (method of preparing glass batch for melting silicate glass), 3,942,991 (SiO₂—AlPO₄ glass batch compositions), 3,969,100 (method of pelletizing glass batch materials), 4,026,691 (making a pelletized glass batch for soda-lime glass manufacture), 4,045,197 (glassmaking furnace), 4,054,459 (method of preparing glass batch), 4,074,989 (method of preparing anhydrous boric acid-containing glass batch), 4,074,990 (method of preparing colemanite-containing glass batch), 4,074,991 (method for preparing boric acid-containing glass batch), 4,235,618 (glass manufacturing process employing glass batch pellets), 4,238,216 (heating glass batch material), 4,319,903 (method and apparatus for preheating glass batch), 4,328,016 (method and apparatus for drying glass batch pellets), 4,329,165 (method for enhancing melting of glass batch), 4,381,934 (glass batch liquefaction), 4,422,847 (preheating glass batch), 4,551,161 (organic wetting of glass batch), 4,726,830 (glass batch transfer arrangements between preheating stage and liquefying stage), 5,632,795 (reduction of nitrogen-containing glass batch materials using excess oxygen), and the like. The entire disclosure of each of these United States patents is hereby incorporated by reference into this specification.

Referring again to FIG. 1, and to the preferred process 105 depicted therein, one may prepare a glass batch comprised of one or more “network formers.” As is known to those skilled in the art, elements that can replace silicon in the glass are referred to as “network formers.”

The network former(s) may be, e.g., silica, B₂O₃, etc. The network former is preferably homogeneously dispersed throughout the frit produced in the process of this invention. Such homogeneous dispersions are well known to those skilled in the art; reference may be had, e.g., to U.S. Pat. Nos. 4,516,996 (electrical resistor and method of making the same), 4,683,168 (method of producing a complex body), 4,764,486 (sintered glass-powder product), 6,133,174 (machinable leucite-containing porcelain compositions), and the like. The entire disclosure of each of these United States patents is hereby incorporated by reference into this specification.

By comparison, the metallic element (such as, e.g., bismuth or copper) that comprises the frit produced in the process of this invention is inhomogeneously disposed within the frit. Such inhomogeneous dispersions are well known. Reference may be had, e.g., to U.S. Pat. No. 4,814,182 (controlled release device) and published United States patent applications 20040243241 (implants based upon engineered metal matrix composite) and 20060293434 (single wall nanotube composites); the entire disclosure of each of these United States patents and patent publications is hereby incorporated by reference into this specification.

Although applicants do not wish to be bound to any particular theory, they believe that an inhomogeneous dispersion of the metallic element within a homogeneously produced oxide material is produced by the aggregation of the reducible metallic element as it transitions from its oxide state to its reduced state. It is believed that, e.g., when bismuth oxide is reduced to bismuth, the elemental bismuth forms nanoparticulate metallic clusters which are dispersed on the surface and in the bulk the flit particle. The same phenomenon appears to occur with, e.g., oxides of copper, gold, silver, and titanium as they are reduced to their elemental states.

In one preferred embodiment, the preferred network formers have a coordination number of 3 or 4. In one aspect of this embodiment, the network formers are selected from the group consisting of Si, B, P, Ge, As, and Be. When silica is present as a network former, it is preferred that at least 45 mole percent of the flit, calculated by total moles of all of the oxide material in the frit, be comprised of silica.

In one embodiment, from the frit produced by the process of this invention is comprised of from about 30 to about 80 mole percent of glassy network forming oxide material, calculated by total moles of oxide material in the frit. In one aspect of this embodiment, the frit is comprised of from about 40 to about 60 mole percent of such glassy network forming oxide material. In another aspect of this embodiment, at least about 50 mole percent of the oxide material in the frit is comprised of silica.

When B₂O₃ is present as network former, it is preferred at least about 10 mole percent of B₂O₃ (and preferably from about 10 to about 15 mole percent of such B203) be used, calculated based upon the total moles of oxide material in the frit. When B₂O₃ is present as network former, it is preferred that at least 50 mole percent of silica also be present in the frit.

The glassy network oxide material is preferably an oxide of an element selected from the group consisting of silicon, boron, phosphorous, germanium, arsenic, beryllium, and mixtures thereof.

As is known to those skilled in the art, the term “coordination number” refers to the number of nearest neighbors of a point in a space lattice, of an atom or ion in a solid, or of an anion or cation in a solution. Reference may be had, e.g., to the claims of U.S. Pat. Nos. 3,994,744 (no-scrub cleaning compounds), 4,002,571 (cleaning compositions), 4,278,735 (aqueous metal coordination compounds), 5,270,143 (developer), 5,319,424 (developer), 5,744,276 (toner), 6,255,031 (near infrared absorbing film), 6,867,064 (method to alter chalcogenide glass), 7,084,084 (highly durable silica glass), and the like. The entire disclosure of each of these United States patents is hereby incorporated by reference into this specification.

Referring again to FIG. 1, these “network formers” are preferably network forming oxides, and they have been described, e.g., in the patent literature.

Thus, e.g., U.S. Pat. No. 3,905,792, describes (in claim 1 thereof) a networking forming oxide that may be, e.g., silica, PbO, B₂O₃, As₂O₃, etc. Silica and B₂O₃ are two of the more preferred glassy network forming oxide materials used in the process of this invention.

In one embodiment, the frit produced in the process of this invention is comprised of at least 50 mole percent of a network forming material, by total weight of all oxide material in the flit; in one aspect of this embodiment, the network forming oxide is silica. In another aspect of this embodiment, the network forming oxide is boron oxide (B₂O₃),

U.S. Pat. No. 4,264,347, the entire disclosure of which is hereby incorporated by reference into this specification, discusses such network forming oxides in column 6 thereof, stating that: “Examples of such products are glass forming oxides which can singly form a stable glass network, and satisfy the well-known glass forming criteria of Zachariasen (as described, for example, in T. Moritani et al, “Glass Technology Hand-Book”, 10th ed. Tokyo, Asakura-Shoten, 1973, Page 5). Preferred examples of the glass forming oxides are those having a bonding strength (Kcals.) (the value of dissociation energy of oxide [kcals.] divided by the coordination number thereof) of at least about 60, such as oxides or boron, phosphorus, selenium, arsenic, antimony, etc.”

In claim 1 of U.S. Pat. No. 4,931,078, the entire disclosure of which is hereby incorporated by reference into this specification, reference is made to “ . . . a network forming oxide containing a combination of B₂O₃ and at least one member selected from the group consisting of SiO₂ and P₂O₅ . . . .”

In claim 1 of U.S. Pat. No. 5,674,789, the entire disclosure of which is hereby incorporated by reference into this specification, reference is made to “ . . . 4 to 22 mole % La₂O₃ as network-forming oxide . . . .”

In column 3 of U.S. Pat. No. 5,869,548, the entire disclosure of which is hereby incorporated by reference into this specification, reference is made to a network-forming oxide that may be “ . . . mainly SiO₂ or B₂O₃, P₂O₅, Al₂O₃, ZrO₂, or Sb₂O₅.”

U.S. Pat. No. 6,511,763, the entire disclosure of which is hereby incorporated by reference into this specification, discloses that “ . . . Si oxide and Al oxide . . . are network-forming oxides which can form glass.”

In one preferred embodiment, the network forming oxides are glassy network forming oxides selected from the group consisting of the oxides Si, B, P, Si, Ge, As, and Be. The “cations” of such oxides preferably have valences of 3 or more. These glassy network forming oxides are some of the more preferred oxides that may be used in the process of this invention.

In one embodiment, the network formers are glassy network formers, and they preferably comprise at least about 50 mole percent of the frit composition.

Referring again to FIG. 1, and in one preferred embodiment thereof, the glassy network forming material(s) are combined in step 110 and, in step 120 and are also mixed with the other glass-forming materials, such as intermediates for the glass. It is preferred in one aspect of this embodiment to use less than about 30 mole percent of such intermediate.

As is discussed on pages 35-36 of W. Vogel's “Chemistry of Glass” (The American Ceramic Society, Columbus, Ohio, 1985), “Intermediates may either reinforce the network (coordination number 4) or further loosen the network (coordination number 6-8) but cannot form a glass per se.”

Intermediates are materials which are preferably selected from the group of metal oxides whose cations have a valence of 2 or more. In one embodiment, such cations are preferably selected from the group consisting of Al, Zn, Pb, Fe, Zn, Y, La, and mixtures thereof.

As is known to those skilled in the art, these intermediates do not form glasses on their own, but they fit into glass networks. Intermediates may be used to alter the properties of the glassy network, such as, e.g., for example the coefficient of thermal expansion of the glass. By way of illustration and not limitation, suitable intermediates include, e.g., the oxides of such cations as Al, Zn, Pb, Fe, Zr, Y, La, and the like.

In one embodiment, such intermediates reinforce the glass network, they have a coordination number of 4 or 6, but they cannot form a glass per se.

In another embodiment, the intermediates loosen the glass network, they have a coordination number of from 6 to 8, but they also cannot form a glass per se.

Referring again to FIG. 1, and to steps 110 and 120 thereof, the glass batch formed in steps 110 and 120 may comprise one or more modifiers such as, e.g., Na₂O, CuO, SrO, BaO, and the like. These modifiers are preferably metal oxides with a valence of from 1 to 2, and they preferably act to reduce the softening point and melt viscosity of the composition.

In one embodiment, the network modifier has a coordination number of 6 or greater and is selected from the group consisting of oxides of sodium, potassium, calcium, barium, and like.

In one embodiment, the modifier is comprised of a compound whose cation has a valence of 1. Such compounds, usually in an oxide form, are preferably added to the glass batch at a mole percent concentration of less than 20 mole percent.

In another embodiment, the modifier is comprised of a compound whose cation has a valence of 2. Such modifiers, usually in an oxide form, are preferably added to the glass batch at a mole percent concentration of 40 percent or less.

In one embodiment, the modifier is potassium oxide. The use of potassium oxide as a glass modifier was discussed in column 5 of U.S. Pat. No. 5,710,081, the entire disclosure of which is hereby incorporated by reference into this specification. As is disclosed in this patent, “Potassium oxide is typically used as the sole alkali metal component. As a typical network modifier, this substance greatly reduces the viscosity of the melt and should thus be present in a quantity of at least 10 mol. %. Since the coefficient of thermal expansion of the glass frit rises sharply with an increasing K₂O content, the upper limit is set at 17 mol. %. A higher K₂O content results in stresses when the glass frit is used on glass substrates. The glass frit preferably contains 13 to 16 mol. % of K₂O. Boric acid reduces the melting point of the flit, but at a quantity of around and in particular of above 25 mol. %, acid resistance is degraded. A quantity of 18 to 23 mol. % of B₂O₃ is preferred. The presence of titanium dioxide, on the one hand, increases acid resistance and, on the other, at concentrations of above 15 mol. %, reduces the viscosity of the glass melt. Surprisingly, despite the relatively high titanium dioxide content in the glass composition, the glass frit according to the invention may be melted homogeneously and without premature crystallization phenomena. A preferred TiO₂ content is between 17 and 25 mol. %. SiO₂ acts as the glass former; a content of below 30 mol. % of SiO₂ results in an unwanted reduction in acid resistance; a content of at least 35 mol. % of SiO₂ and in particular of 40 to 45 mol. % is preferred. A small quantity of aluminum oxide may be present as an optional constituent in the glass composition. The presence of bismuth oxide, on the one hand, increases chemical resistance and, on the other, reduces the melting point.”

Referring again to FIG. 1, the glass batch used in step 120 is also comprised of one or more reducible metal compound moieties that, in their reduced state, are capable of altering the spectral characteristics of impinging electromagnetic radiation. Such metal compound moieties are preferably comprised of one or more of the following elements: Bi, In, Sn, Pb, Cu, Ni, Ag, Cd, Hg, Ru, Os, Mo, Ta, Ti, and the like. In some aspects of this embodiment, one may also use Zn and/or Fe.

The reducible metal compound moieties are present in a non-reduced state in the glass batch, and in such non-reduced state they are preferably homogeneously dispersed within the glassy network former material. However, when the glass batch is subjected to reducing conditions, the reducible metal compounds become reduced to their elemental state and, during such process, become inhomogeneously dispersed throughout the glass frit.

In one preferred embodiment, the reducible metal compound moiety produces a color upon being contacted with forming gas at a flow rate of one liter per minute while being heated at a temperature of 375 degrees Celsius for 24 hours. As is known to those skilled in the art, the formation of such color is a complicated phenomenon.

In a preferred embodiment, the reducible metal is an oxide of a metal selected from the group consisting of bismuth, nickel, copper, and mixtures thereof.

The “formation of color” is discussed in Arun K. Varshneya's “Fundamentals of Inorganic Glass” (Academic Press, Inc., 1994), wherein it is disclosed that: “Selective absorption of various wavelengths in the visible region gives rise to the appearance of colors in glass. The source of absorption is of three types (i) electron transitions within the unfilled orbits or the transition elements, (ii) plasma . . . resonance . . . , and (iii) electron transitions along the bandgap . . . .” (See section 19.2.3 of such text, “Absorption in the Visible Region [Colors in Glass]”.)

It is also disclosed in the Varshneya text that “There are four possible transition element series in the periodic table. Of these, the first series from Sc to Ni (including the divalent Cu ion) produces strong colors because of absorption of selected wavelengths . . . . The transition elements are characterized by an unfilled electron shell . . . .”

At page 10 of the Varshneya text, a discussion is presented of a naturally-occurring “Australasian glass” that has a black to dark brown color and is believed to be of extraterrestrial origin. It is disclosed at such page that: “The Australasian tektites are black to dark brown in color, typically 75SiO₂.13Al₂O₃/Fe₂O₃.3.5MgO/CaO.4Na₂O.0.7TiO₂ (wt %) . . . . O'Keefe has suggested that many of the characteristics of the tektites, in particular the homogeneity, indicate the glasses were molten for long times in space. After calculating possible trajectories, O'Keefe concluded that the Australasian tektites had to be of lunar volcanic origin, as opposed to being the result of a terrestrial meteoritic impact.”

Referring again to FIG. 1, and to steps 110 and 120 thereof, in one embodiment the reducible metal compounds are oxides of one or more cations selected from the group consisting of Bi, In, Sn, Pb, Cu, Ni, Ag, Cd, Hg, Ru, Os, Mo, Ta, Ti, and mixtures thereof. In one preferred aspect of this embodiment, such cation is bismuth. In another preferred aspect of this embodiment, the reducible metal compound is comprised of at least 90 weight percent of an oxide of bismuth.

In one embodiment, the glass batch is comprised of at least about 1 weight percent of one or more reducible metal compounds. In another embodiment, the glass batch is comprised of at least 5 weight percent of one or more reducible metal compounds. In another embodiment, the glass batch is comprised of at least 10 weight percent of one or more reducible metal compounds. In another embodiment, the glass batch is comprised of at least 35 weight percent of one or more reducible metal compounds. In another embodiment, the glass batch is comprised of at least 40 weight percent of one or more reducible metal compounds. In another embodiment, the glass batch is comprised of at least 50 weight percent of one or more reducible metal compounds.

A sufficient amount of such reducible metal compound is used in the glass batch so that, after the glass batch is subjected to reducing conditions and the frit is produced, the frit will contain from about 1 to about 80 weight percent of a metallic element such as, e.g., elemental bismuth and/or elemental copper. In one embodiment, the frit so produced contains from about 20 to about 50 weight percent of said metallic element(s).

In one embodiment, the reducible metal compounds charged to the glass batch comprise one or more compounds of bismuth and, additionally, one or more compounds of a metal other than bismuth. Such metal may, e.g., be selected from the group consisting of nickel, copper, arsenic, indium, tin, lead, silver, cadmium, mercury, ruthenium, osmium, molybdenum, tantalum, titanium, mixtures thereof, and the like. Without wishing to be bound to any particular theory, applicants believe that the inclusion of such “other metal compounds” producing an “alloying effect” that improves the properties of the frit composition. It is believed that the presence of such other metal compounds lowers the vapor pressure and makes the metals more stable.

Referring again to FIG. 1, and in the preferred embodiment depicted therein, in one aspect of this embodiment the glass batch produced in step 120 is comprised of less than about 10 mole percent of a zinc compound (such as zinc oxide), and more preferably less than about 4 mole percent of such zinc compound. In one embodiment, the glass batch is comprised of less than about 2 mole percent of such zinc compound

When a mixture of bismuth compound and “other metal compound,” it is preferred that such mixture comprise from about 1 to about 20 moles of the bismuth compound for each mole of the “other metal compound(s). In one embodiment, such mole ratio is from about 1/1 to about 10/1. In another embodiment, such mole ratio is from about 1/1 to about 6/1. In another embodiment, such mole ratio is from about 1/1 to about 4/1. In another embodiment, such mole ratio is greater than about 1.5.

In one embodiment, the glass batch produced in step 120 is comprised of less than 20 mole percent of an oxide selected from the group consisting of the oxides of iron, zinc, and chromium, and mixtures thereof. In one aspect of this embodiment, the glass batch if comprised of less than about 10 mole percent of such oxide(s) and, more preferably, less than about 4 mole percent of such oxide(s). In another embodiment, the glass batch is comprised of less than about 2 mole percent of such oxide(s).

As is discussed elsewhere in this specification, such metal oxide(s) may be reduced by one or more of the following reducing agents: H₂, CO, S, HS, CNH, Zn, C, Li, Na, B, Si, Si₃N₄, SiC, and the like.

In one preferred embodiment, the “reducible metal oxide” is an oxide of bismuth, and such bismuth oxide may be used in large quantities, as high as 30 mole percent. Reduction of such metal oxide(s) by gaseous reducing agents, in appropriate circumstances, produces extremely black colors in thin coatings (coatings less than about 30 microns in thickness, and preferably less than 20 microns in thickness).

The colored glass frit produced by the process of this invention is preferably comprised of from about 1 to about 80 weight percent of metallic element material, based upon the total weight of the frit. In one aspect of this embodiment, the frit is comprised of from about 20 to about 50 weight percent of said metallic element material. In one aspect of this embodiment, the frit is comprised of from about 50 to about 60 mole percent of silica.

The 50 to 60 mole percent of silica is based upon the total moles of all the oxide materials in the flit, including the silica. Alternatively, or additionally, the frit may be comprised of a network former other than silica such as, e.g., an oxide of a material selected from the group consisting of boron, phosphorus, germanium, and arsenic.

In one preferred embodiment, the “reducible metal oxide” is an oxide of titanium, and such titanium dioxide may be used in large quantities, as high as 15 mole percent.

In one preferred embodiment, the glass batch contains at least 12 mole percent of an oxide of Group IIIB of the Periodic Table, such as the oxides of boron, aluminum, gallium, indium, and terbium

In one preferred embodiment, the glass batch contains at least 6 mole percent of a group IA oxide selected from the group consisting of oxides of lithium, sodium, potassium, rubidium, cesium, francium, and mixtures thereof.

In one preferred embodiment, the glass batch is comprised of less than about 15 mole percent of an oxide of a metal of group IIA of the Periodic Table, such as Barium and Strontium.

Referring again to FIG. 1, in step 120 of said process the ingredients of the composition are mixed. It is preferred that the mixing be thorough such that all of the components are uniformly dispersed throughout the mixture. One may use a mechanical blender such as a V-blender or a double ribbon blender. Typical mixing times are one the order of 5 minutes. However, mixing is dependent upon the amount of energy which the mixer can transfer to the mixture, and thus mixing time will vary depending upon the equipment used. In any case, sufficient time should be used to uniformly mix the ingredients together. Often, one or more of the ingredients will have a visible color. The uniform distribution of such colored components can be used to gauge the relative uniformity of the mixture.

Referring again to FIG. 1, in step 130 of process 105 the mixture is heated. Such processes are frequently referred to as melting. In such processes, the ingredients of the composition are brought into a liquid state and a solution of the ingredients is formed. This melting process is preferably conducted in a kiln which is heated hot enough to form a solution of the components. Typically, the minimum melting temperature is about 1100° Celsius. Other compositions may require temperatures as high as 1450° Celsius. The kiln may be ramped up in temperature to the soak temperate at a rate of 1 degree Celsius per minute to 100 degrees Celsius per minute. Kilns are typically heated with electrical heaters. However, for very high melting temperatures, gas fired kilns may be required. The melted composition may be very corrosive and, in such a case, is thus contained in a corrosion-resistant vessel, for example a crucible. Crucibles may be used that are made of mullite (Al₃[SiO₂]₂) from DFC ceramics of Colorado, or Platinum, fused silica, fire clay and the like. It will be understood by those skilled in the art that the crucible material must be designed with the process temperature and mixture composition in mind. Without such precautions, significant contamination of the mixture by the crucible may occur. Such processes are frequently referred to as melting.

In one embodiment, the composition is added to the crucible at room temperature and then placed in the kiln. Alternatively, the crucible may reside in the heat kiln and the composition may be added to it. Heat times for the composition will vary, depending upon the size the melt. Once the desired temperature is achieved, the melted composition is generally held at temperature for approximately one hour or more; this is referred to as the soak time. Soak time may vary from as little as 30 minutes to as long as 8 hours. The atmosphere surrounding the crucible may be oxidizing, or inert or reducing. It is preferred to have an inert atmosphere at this stage. It will be understood by those skilled in the art that the soak time will be dependent upon the soak temperature, the composition of the mixture, and the size of the batch. While the composition is soaking, it often is advantageous to stir or mix the melted mixture. Typically, no special precautions are required to exclude air form the melted mixture.

In general, one may use conventional means for melting the frit glass batch. Reference may be had, e.g., to U.S. Pat. Nos. 3,397,972 (glass batch melting process), 3,606,825 (process for melting glass), 3,854,496 (glass melting furnace and process), 4,006,003 (process for melting glass), 4,473,388 (process for melting glass), 4,544,394 (Vortex process for melting glass), 4,725,299 (glass melting furnace and process), 4,892,573 (process and device for melting glass), 4,981,504 (process and device for melting glass), 5,194,081 (glass melting process), 5,709,725 (process for producing a glass melt), 5,779,754 (process and horseshoe flame furnace for the melting of glass), 5,906,119 (process and device for melting glass), and the like. The entire disclosure of each of these United States patents is hereby incorporated by reference into this specification.

Referring again to FIG. 1 and step 135 thereof, the molten glass mixture formed in step 130 is quenched, preferably with a quench time of less than a second. As is known to those skilled in the art, quenching involves rapidly reducing the temperature of the mixture from the soak temperature to a temperature below the glass point of the mixture. Because no crystallization occurs during this rapid process, the quenched material will have an amorphous or glass-like structure.

Quenching the molten glass mixture is well known to those skilled in the art. Thus, one may use one or more of the processes or devices described in U.S. Pat. Nos. 3,802,860 (method of liquid quenching of glass), 3,873,295 (quench apparatus), 4,300,937 (quench devices), 4,305,743 (method and system for quenching), 4,343,645 (quenching apparatus), 5,620,492 (apparatus for quenching glass), 6,412,309 (glass quenching apparatus), and the like. The entire disclosure of each of these United States patents is hereby incorporated by reference into this specification.

In one embodiment, the glass melt is quenched from the melt temperature to ambient conditions. Quenching may be performed in a variety of way. For example, the hot composition may be transferred directly into water in a process often called fritting. Reference may be had, e.g., to U.S. Pat. Nos. 3,772,043 (cermet protective coating glass frit), 4,057,702 (fritting of ceramic products), 4,352,890 (diopside crystal precursor glass frit flux), 4,353,991 (glass composition), 4,364,877 (fritted alumina), 4,772,436 (fritting of a metal oxide based infrastructure), 5,608,373 (glass frit compositions), 6,043,298 (solid fritted bonding material), and the like. The entire disclosure of each of these United States patents is hereby incorporated by reference into this specification.

Referring again to FIG. 1, and to step 140 thereof, additionally or alternatively, the hot composition may be flaked by passing it through a chilled roller nip. After quenching such glassy compositions are typically referred to as frit.

Flaking may be effected by conventional means such as, e.g., the means disclosed in U.S. Pat. Nos. 4,526,602 (equipment and method for manufacturing thin glass flakes), 5,002,827 (agglomerated glass flakes), 5,017,207 (method and apparatus for forming glass flakes), 5,201,929 (apparatus for producing flakes of glass), 5,294,237 (process for producing flakes of glass), and the like. The entire disclosure of each of these United States patents is hereby incorporated by reference into this specification.

Referring again to FIG. 1, and to the process 105, in step 150 of this process the particle size of the frit is reduced such that substantially all of the particles have a particle size of less than 100 microns.

In one preferred embodiment, the particle size of the frit is reduced so that at least 90 weight percent of its particles are smaller than 20 microns. In another preferred embodiment, the particle size of the frit is reduced so that at least 90 weight percent of its particles are smaller than about 10 microns. In one aspect of each of these embodiments, at least about 50 weight percent of such frit particles are smaller than about 6 microns.

The particle size of the frit may be reduced by conventional means such as, e.g., the grinding means disclosed in many different United States patents.

In on preferred embodiment, the glass frit has a glass transition temperature between 500 to 650 degrees Celsius.

Thus, e.g., one may use the dry grinding process disclosed in U.S. Pat. No. 5,710,081 (the entire disclosure of which is hereby incorporated by reference into this specification) to reduce the particle size of the frit. As is disclosed in the specification of such patent, “The black glass frit according to the invention is obtainable by melting a mixture of conventional metal oxide forming glass raw materials in a molar composition of 10 to 17 mol. % of K₂O, 10 to 25 mol. % of B₂O₃, 15 to 30 mol. % of TiO₂, 30 to 55 mol. % of SiO₂, 0 to 5 mol. % of Al₂O₃, 0 to 5 mol. % of Bi₂O₃, 0.05 to 3 mol. % of Fe₂O₃ and oxides from the range PbO, CdO, ZnO, Li₂O, Na₂O, MgO, CaO, SrO, BaO and P₂O₅, each in a quantity of less than 0.5 wt. %, relative to the glass flit, and additionally a source of sulfur in a molar quantity which exceeds the quantity remaining in the glass frit of 0.1 to 3 mol. %, under reducing conditions at 1000° to 1200° C., quenching the melt and grinding the resultant brittle material.”

Thus, e.g., one may use the dry grinding process disclosed in U.S. Pat. No. 6,100,209 (the entire disclosure of which is hereby incorporated by reference into this specification) to reduce the particle size of the frit. In the process described in the '209 patent, a flit is first prepared, then it is subjected to reducing conditions to convert metal oxide(s) in the frit to lower oxidation states, and then it is ground.

The process of the '209 patent contains a “metal moiety” that is capable of being reduced to a “reduced metal moiety;” some or all of the “metal moieties” of the '209 patent may be used in the process of this invention as one of the “reducible metal moieties.

As is disclosed at lines 7 to 21 of column 4 of U.S. Pat. No. 6,100,209, “The initial glass frit is modified in the present process; the metal moiety in the glass structure is reduced to the reduced metal moiety. The glass structure of the initial glass frit must clearly contain metal moiety capable of this reduction. The metal moiety is reduced to a lower oxidation state. This may be the zero oxidation state (i.e., the reduced moiety is metal itself). Where there is one, this may alternatively be an intermediate oxidation state. Preferably the reduced metal moiety is present throughout the glass frit, not only on its surface; it can be seen that dispersion throughout the flit better places the reduced metal moiety to have its effect, especially to encounter migrating silver ions. The reduced metal moiety may be in the form of colloidal particles. The present frit is normally much darker in colour than the initial frit.”

The reduction process used in the '209 patent appears to form “lumps” that often require that the reduced frit be ground in order to reduce its particle size. Thus, as is disclosed at lines 22 to 36 of column 4 of such patent, “The present process involves reducing metal moiety in the initial glass frit. The higher the reduction temperature, the faster the reduction. On the other hand, at the higher temperatures sintering tends to occur to form lumps, which may then need to be broken down. The reduction is preferably carried out at a temperature below the melting or softening point of the frit. To alleviate the need for grinding, it is preferred that the reduction be performed at a temperature below the softening point of the frit, especially at a temperature within 100 degrees Celsius., particularly 50 degrees Celsius., either side of its glass transition temperature (Tg). The temperature is preferably below the Tg. For powder starting materials, lower temperatures may be appropriate than for more bulky starting materials. These temperatures apply particularly in the case of the reduced moiety being reduced bismuth moiety.”

At column 7 of U.S. Pat. No. 6,100,209, at lines 8 to 37 thereof, an experiment was described in which a bismuth-containing glass frit was prepared, contacted with reducing gas, and thereafter ball-milled to increase its surface area. As is disclosed in this column 7, “A bismuth-containing glass frit available from Cookson Matthey Ceramics plc under the designation B5236MF (Glass transition temperature 460 degrees Celsius) was heated in a tube furnace under a flowing gas atmosphere of 5% hydrogen 95% nitrogen. The temperature was ramped up at 10° C. per minute to 400° C. and then held for two hours. The gas atmosphere was then kept constant until the material had cooled to 200° C. Before this reduction heat treatment, the flit was white in appearance. Afterwards it was black. 10 g of the reduced frit, after ball-milling to a B.E.T. surface area of approximately 3 m² g⁻¹, was mixed with 3.33 g of a black copper chromite pigment and 4 g of an IR ink medium based on pine oil and available from Cookson Matthey Ceramics plc under the designation 456-63. The components were triple-roll-milled to form a paste and printed onto a float glass substrate to form a layer approximately 27 μm thick. After drying this, a silver paste was printed over areas of the black paste. The silver paste had the composition, by weight: 70% silver powder within the particle size range of 0.1-0.8 micron, and having an average particle size of 0.6-0.7 micron; the sizes being measured by scanning electron microscope (SEM); 10% silver flake of B.E.T. surface area 1.3-2.1 m² g⁻¹ and of particle size 4-5 μm as measured visually from SEM; 2% lead-based frit available from Cookson Matthey Ceramics plc under the designation 5263F; and 18% IR printing ink available from Cookson Matthey Ceramics plc under the designation 578-63.” The particle size of the frit in Example 1A of the '209 patent was not disclosed. However, in Examples 3A, 4A, 5 and 6 the particle size of the reduced frit is reported to be 10 to 12 microns. No mention is made in these examples of the B.E.T. surface area.

By comparison, applicants' process preferably produces a black flit with a BET surface area of less than 2 square meters per gram after milling and a particle size distribution such that 90% of the colored (preferably black) flit particles are smaller than 10 microns. In a preferred embodiment, applicants have found that a black frit with a B.E.T. surface area of less than 1 square meter per gram and an average particle size less than 10 microns is extremely black and forms dense films with high durability. As is known to those skilled in the art, as the surface area of a particle increases for a given average particle size, the porosity of the particle must also decrease. Not wishing to be bound to any particular theory, applicants believe that reduced frits of low surface area are dense with high specific gravities and, when fired, unexpectedly form dense films which high transmission density and good chemical resistance to attack by acid.

In one embodiment, at least about 90 weight percent of the metallic material in the glass frit is comprised of particles that are smaller than 100 nanometers.

It should be noted that the experiment of U.S. Pat. No. 6,100,209 produced a relatively coarse black frit even though the melting temperature of the glass batch used was at least 60 degrees lower than the glass transition temperature. The glass transition temperature of the B5236MF frit used in the experiment described in U.S. Pat. No. 6,100,209 was 460 degrees Celsius, and the “reduction temperature” was 60 degrees lower than this, 400 degrees Celsius.

Without wishing to be bound to any particular theory, applicants believe that the fact that they grind their glass frit to a fine compact (at least 90 percent finer than 10 microns) prior to subjecting it to reducing conditions might be responsible for the unexpectedly beneficial results produced in applicants' process.

Referring again to step 150 of process 105 (see FIG. 1), one may use wet grinding to reduce the particle size of the flit. One such wet grinding process is described in claim 1 of U.S. Pat. No. 6,279,351, the entire disclosure of which is hereby incorporated by reference into this specification. Claim 1 of this patent describes: 1. A method for making glass and particularly ceramic frits, comprising the steps of: introducing in a wet grinding unit, after a metering step according to chosen proportions, raw materials having a course particle size and natural moisture content and which have not been preliminarily dried or ground which constitute a mixture to be melted, and performing wet grinding unit in said wet grinding unit of said raw materials to grind said raw materials into ground particles of limited size to produce a slurry; screening and collecting said slurry in a storage tank; introducing and collected slurry in a melting furnace to make a liquid component of the slurry evaporate; and forming a melted paste of vitreous material, adapted to be converted into a ceramic frit.” In the “BACKGROUND . . . ” section of this patent, it is disclosed that: “Conventional methods for producing glass-like materials, such as sheet glass, bottle glass and ceramic frits, entail feeding the melting furnaces with mixtures of various materials in powder form with controlled particle size and humidity. The raw materials that compose the mixture must be first dry-ground, transferred to the glassmaking site, stored and then metered with the aid of machines such as vibrating hoppers or fluids for extraction from the storage silos, screw feeders or belts, dosage chambers mounted on load cells, mixers, and finally conveyed with the aid of a pneumatic conveyance systems. The various steps of this production process have several financial and production-related drawbacks, linked to the dry grinding of the individual raw materials, to the steps for transferring and storing the powders, and to their mixing; theses production plants are further burdened by a high level of management complexity.”

Referring again to step 150 of process 105 (see FIG. 1), and in one preferred embodiment thereof, the particle size of the frit is reduced so that the at least 95 weight percent of the flit particles are smaller than about 10 microns.

As will be apparent to those skilled in the art, the particle size of the frit may be reduced by a variety of means.

In one embodiment, a ball mill is employed that preferably contains hard media, such as zirconia, alumina, silica, pebbles, agate and the like. In this embodiment, the frit and media are either rolled, stirred or vibrated such that impacts of the media against the frit will cause the frit to fracture into smaller and smaller particles. This process may be conducted in a dry state or a wet state. In the wet state, a liquid is used to help facilitate a finer grind with a smaller particle size. Grinding times will vary, depending upon the frit composition, the media used and the energy of the grinding process. For example in a rolling 18″ diameter ball mill, grinding times may be as long as 24 hours. If wet grinding is used, a variety of liquids may be utilized such as, e.g., water, alcohol, toluene, and the like. After wet grinding, it is necessary to dry the liquid out of the ground frit. Such drying is dependent upon the grinding liquid selected, the amount of liquid used, the evaporation rate of the liquid, the composition of the frit and the particle size of the flit. Sufficient drying should be done such that no more than about 5% by weight of the liquid remains with the frit.

Wet milling with water may pose certain problems, depending upon the composition of the frit. For flits comprised of alkali or alkaline earth modifiers, dissolution of these components into the water may occur. Alcohols may be added to the water to reduce this propensity for dissolution of these ionic components.

Dry grinding is an efficient process, but it quickly reaches a particle size limit. It is advantageous to separate the finely ground particles from the larger particles to keep this process operating at high efficiency, as is illustrated step 160 of process 105 (see FIG. 1). A particle classifier such as a sieve or an air classifier (such as, for example a C1 Particle Classifier supplied by Vortex Corporation of California) may be used in this step 160 of process 105. The frit particles below the desired particle size can be carried on to the step 170 of process 105 while the flit particles larger than the desired particle size can be returned to step 150 of process 105 for additional dry grinding.

Whether wet milled or dry milled, the dry frit of the desired particle size and composition may now be used in step 170 of process 105. In this process, the reducible metal oxides in the frit are reduced to alter the appearance of the flit. For example, before reduction, the frit may be white or gray in appearance. After reduction, the frit may be black, red, blue or some other color. Unexpectedly, the inventors have discovered that when such reduction processes are carried out of finely ground glass frits (such as, e.g., 90 percent smaller than 10 microns), intense colors can be easily produced. Without wishing to be bound to any particular theory, applicants believe that the surface area of the finely ground frit might enable the reduction to be carried out on the surface of the frit without necessarily reducing entire composition.

The specific surface area of the frit produced in the experiment described in Example IA of U.S. Pat. No. 6,100,209 was “ . . . approximately 3 m² g⁻¹ . . . .” By comparison, the specific surface area of the flit produced by the process of this invention is less than about 2 square meters per gram and, more preferably, less than about 1 square meter per gram.

Referring again to step 170 in FIG. 1, and to the preferred process illustrated in such Figure, the reductions of the “reducible metal moieties” are preferably carried out just below the glass temperature of the frit such that minimal agglomeration of the particles occurs. In one embodiment, a temperature of from about 350 to about 390 degrees Centigrade is used.

As used herein, the term “glass temperature,” also known as “glass transition temperature” (or T_{g}) is the temperature at which an amorphous material (such as, e.g., the frit of this invention) changes from a brittle vitreous state to a plastic state. In one embodiment, the frit of this invention has a glass transition temperature of from about 400 to about 470 degrees Celsius.

The Nano-Particles in the Frit

In one preferred embodiment, the frit produced by the process of this invention is comprised of at least about 35 weight percent of nano-particles with a particle size less than about 300 nanometers. In another embodiment, the frit produced by the process of this invention is comprised of at least 40 weight percent of nano-particles with a particle size less than about 200 nanometers. In yet another embodiment, the frit produced by the process of this invention is comprised of at least about 40 weight percent of nano-particles with a particle size less than about 100 nanometers. In yet another embodiment, the frit is comprised of at least 45 weight percent of nano-particles with a particle size less than about 75 nanometers.

In one embodiment, the nano-particulate material is comprised either of an elemental metal (such as copper [red color], gold [red color], silver [yellow to brown color], iron [black color], bismuth [black color]), nickel [black color], titanium), and mixtures thereof. In this embodiment, the frit preferably contains from about 1 to about 80 weight percent of particulate elemental metallic material (such as, e.g., bismuth and/or copper) wherein at least about 90 weight percent of the particles in such material are smaller than about 100 nanometers. In one aspect of this embodiment, at least about 80 weight percent of the particles of such elemental material are smaller than about 45 nanometers. In another aspect of this embodiment, such nanoparticulate elemental material comprises from about 20 to about 50 weight percent of such frit.

In one embodiment, the nano-particulate material is comprised of both an elemental metal (such as, e.g., bismuth) and, additionally, one or more oxides of such metal (such as, e.g., bismuth oxide). In one aspect of this embodiment, the nano-particulate material is comprised of a first metal (e.g., bismuth), a first metal oxide (e.g., bismuth oxide), a second reduced metal (e.g., copper), and a second reduced metal oxide (e.g., copper oxide).

When such a mixture of such elemental metal and its metal compound is present, it is preferred, in one embodiment, that at least about 50 percent of such mixture comprise the elemental metal (e.g., at least 50 weight percent of bismuth, and at least about 1 weight percent of such mixture comprise the metal oxide (e.g., bismuth oxide). In one embodiment, at least 60 weight percent of the mixture is elemental bismuth. In another embodiment, at least 70 weight percent of the mixture is elemental bismuth. In another embodiment, at least 80 weight percent of the mixture is elemental bismuth. In yet another embodiment, at least 90 weight percent of such mixture is elemental bismuth.

Referring again to FIG. 1, FIG. 100, and to step 170 of process 105, the reduction of the finely ground glass frit is preferably carried out at a temperature just below the glass transition temperature of the frit. In one embodiment, the glass transition temperature of the frit is 435 degrees Centigrade, and the temperature at which the reduction process occurs is 375 degrees Centigrade.

The reducing agents used in this process 105 may be gasses and/or liquids and/or or solids uniformly mixed with the finely ground glass frit. For example, one may use reducing gasses such as, e.g., H₂, CO, S, HS, CNH, Zn, C, Li, Na, B, Si, Si₃N₄, SiC, etc. Without wishing to be bound to any particular theory, applicants believe that the function of these reducing agents in one preferred embodiment is to remove oxygen from the reducible metal oxides described in step 110 of this process 105.

By way of illustration and not limitation, hydrogen gas may be used to reduce a finely ground glass frit. In such a process, the finely ground glass frit is preferably placed in a reaction chamber, for example a stainless steel vessel. Thereafter, a mixture of hydrogen and inert gas (such as, e.g., 4% hydrogen/96% nitrogen) is introduced into the vessel and mixture is heated to about 375 degrees Celsius. The mixture is continuously purged with forming gas for about 24 hours until the reducible metal oxides have been reduced. For example, if the frit is comprised of Bi₂O₃, the reduction process will alter its appearance from white to black. If Cu₂O is used, the reduction process will alter the appearance from blue to red.

One may use any of the reducing agents in process 105 that are described, e.g., in U.S. Pat. No. 6,100,209, the entire disclosure of which is hereby incorporated by reference into this specification. Claim 1 of such patent describes a “ . . . process for preparing a glass frit adapted to be applied to a glass member (c) and also adapted to have a metallic element (a) deposited thereon wherein, upon firing of said frit, together with said metallic element and said glass member, said frit prevents migration of metallic ions from (a) to (c), which process comprises heating an initial glass frit in the presence of a reducing agent so as to reduce at least one metal moiety ion in the glass structure of said frit and then cooling said frit for subsequent deposition on said glass member, and for receiving said metallic element thereon.” The reducing agent described in such claim is discussed, e.g., at lines 37 to 65 of column 4 of such patent, wherein it is disclosed that: “The reducing agent can be gaseous, for instance methane, ammonia, sulfur dioxide or carbon monoxide, but especially hydrogen. Pure hydrogen gas is not necessary; for safety, a gas containing hydrogen in amount up to 5% is preferably employed, for instance a mixture of 5% hydrogen and 95% nitrogen.”

U.S. Pat. No. 6,100,209 also discloses that “The reducing agent is conveniently solid, for instance carbon, sugar (preferably sucrose, for instance in the form of cane sugar), boron, iron, aluminum, bismuth, antimony, wood, hay, flour, rice, cellulose, sodium oxalate, ferrous oxalate, zinc, tin, tin(II) oxide, manganese, molybdenum, boron carbide, copper, chromium, vanadium, nickel, molybdenum disilicide, sodium thiosulphate or aluminum boride. Sulfur has been found to be ineffective. Wood, hay, flour, rice or sugar have each been found to be particularly good reducing agents, especially sugar.”

U.S. Pat. No. 6,100,209 also discloses that “The reducing agent can be liquid, for instance an aqueous solution of sodium thiosulphate, an aqueous solution of glucose and KOH, a solution (e.g. in toluene or xylene) of an alkyl or aryl thiolate, liquid paraffin, or molten tartaric acid. The reducing agent can be a solution or dispersion of a suitable polymer in an organic carrier. Such solution can be a medium used in the production of screen printing inks, for instance an IR drying medium such as medium 650-63 (which is a solution in pine oil and which is commercially available from Cookson Matthey BV, Holland) or a UV curing medium. The solution can alternatively be such a UV curing medium which has been cured.”

U.S. Pat. No. 6,100,209 also discloses that: “The reducing agent can be a plurality of reducing agents.”

U.S. Pat. No. 6,100,209 also discloses (in the last paragraph of column 4 thereof) that: “The reduction treatment is carried out for long enough to form the desired product. Using hydrogen at 85 to 95% of the Tg in ° C., for instance, a time of 2 hours is often appropriate, though some degree of silver hiding is obtained using a shorter time.”

In one preferred embodiment, before the comminuted frit particles are preferably contacted with gaseous reducing agent, they are mixed with one or more color toners. Thus, e.g., the colors produced in this process 105 may be further modified by adding color toners such a Silver, Gold, Copper, Platinum, Palladium and the like. Without wishing to be bound to any particular theory, it is believed that such color toners will impact the nucleation and resulting size, shape and composition of the nano metal and metal oxide particles in the flit.

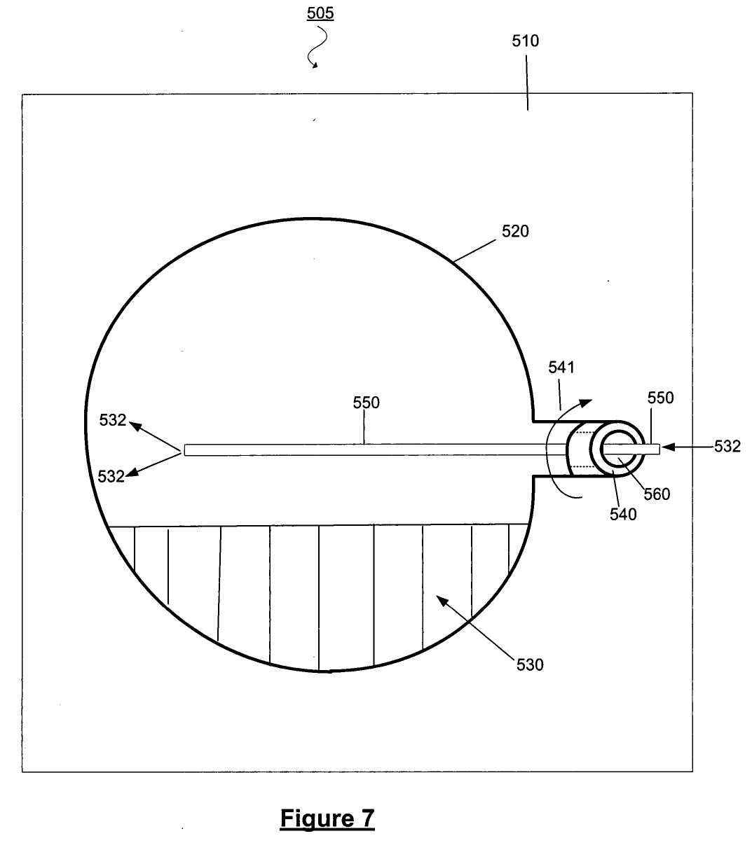

The Process Depicted in FIG. 7

FIG. 7 depicts a process 505 in which the finely-divided frit 530 produced in steps 150 and 160 of process 105 (see FIG. 1) is subjected to reducing conditions while being mixed to insure the maximum contact between it and gaseous reducing agent. In one aspect of this embodiment, the finely-divided frit used in the process has a specific surface area of less than about 2 square meters per gram.

In one aspect of this embodiment, the finely-divided frit is mixed with a solid reducing agent such as carbon black or cane sugar.

In one embodiment, the finely-divided frit used in the process has a glass transition temperature of less than about 500 degrees Centigrade.

Referring to FIG. 7, and to the preferred embodiment depicted therein, it will be seen that the frit 530 is tumbled by the rotation of rotary union 540 in the direction of arrow 541. As the flit 530 is so tumbled, it is intimately contacted with hydrogen gas 532 introduced via port 550. The hydrogen gas 532 forms reaction products with the frit 530, some of which are gaseous (such as, e.g. water vapor). These reaction products are preferably exhausted via vent gap 560 in rotary union 540.

In the embodiment depicted, the process is continued until the frit 530 is preferably comprised of particles of bismuth that are smaller than 100 nanometers and, additionally, particles that are smaller than 100 nanometers of at least one other metal (such as, e.g., copper). In one aspect of this embodiment, the process is continued until at least 60 weight percent of the frit is comprised of particles bismuth and/or bismuth oxide that are smaller than 100 microns.

In one embodiment, the process is continued until the flit 530 is preferably comprised of particles of a first metal (that may be, but need not be, bismuth) that are smaller than 100 nanometers and, additionally, particles that are smaller than 100 nanometers of at least one other metal (such as, e.g., copper). In one aspect of this embodiment, the process is continued until at least 60 weight percent of the flit is comprised of particles of such first metal and/or its oxide that are smaller than 100 microns.

In one preferred embodiment, the process is continued until the frit 530 has a density of at least about 3 grams per cubic centimeter. In one aspect of this embodiment, the process is continued until the flit 530 has a density of at least about 3.5 grams per cubic centimeter.

In one preferred embodiment, the frit 530, when imaged and fired onto the non-tin side of a float glass substrate at a thickness of 5 microns has an L* value of less than 30.

Measurement Using the CIELAB Color Space

In one preferred embodiment, the optical properties of the frit of this invention are measured using “Lab” color space. “Lab” is the abbreviated name of two different color spaces, the best known of which is “CIELAB” (also referred to as “CIE 1976 L*a*b*”). Both of these spaces are derived from the “master” space, CIE 1931 color space. CIELAB is calculated using cube roots, and Hunter Lab is calculated using square roots. Reference may be had, e.g. to a web site appearing at http://en.wikipedia.org/wiki/Lab_color_space.

CIELAB has been widely described in the patent literature. Thus, e.g., it is described in both the claims and the disclosures of U.S. Pat. Nos. 5,751,484 (coatings on glass), 5,932,502 (low transmittance glass), 5,512,521 (cobalt-free, black, dual purpose enamel glass), and the like. The disclosure of each of these United States patents is hereby incorporated by reference into this specification.

“CIELAB” has also been described in applicants' patent documents, including, e.g., U.S. Pat. Nos. 6,629,792 (thermal transfer ribbon with frosting ink layer), 6,722,271 (ceramic decal assembly), 6,796,733, etc.; the disclosure of each of these United States patents is hereby incorporated by reference into this specification. Thus, e.g., it is disclosed in the '733 patent that “The measurements were taken on fired glass samples. The whiteness was calculated according to CIE Lab color space measurement standard of 1976 with a D65 illuminate and a 10 degree observation angle.”

In the present invention, when using the CIE Lab color space measurement standard of 1976, it is preferred to use a Datacolor International Spectraflash 600 Spectrophotometer (Lawrenceville, N.J.). The imaged glass is placed in the sample holder with the image facing the light source. The white portion of a Morest chart is used as a backing for the glass.

ΔL or delta is the difference in lightness between a sample and a standard. The more positive the value of the ΔL, lighter the sample, the smaller the value of ΔL, the darker the sample.

Δa or delta a is the difference in red green component of the sample. Positive values are more red (less green) and negative values are more green (less red).

Δb or delta b is the difference in yellow-blue component. Positive values are more yellow (less blue), negative values are more blue (less yellow).

ΔH* or delta H* is the difference is hue. Positive values indicate that the sample is moving relative to the standard counter-clockwise around the hue circle, negative values indicate clockwise movement.

ΔC or delta C is the difference in chroma. Positive values relative to a standard indicate that the sample is more intense; higher chroma. Negative values indicate that the sample is less intense; lower chroma.

ΔE or delta E is the total color difference between the sample and the standard. The higher the value of ΔE, the larger and more obvious the color difference.

The “rationale” for the CIE (ICI) system of color specification is described, e.g., at pages 17-2 to 17-5 of George W. McLellan et al.'s “Glass Engineering Handbook,” Third Edition (McGraw-Hill Book Company, New York, N.Y., 1984). It is disclosed in the McLellan text that: “The human eye distinguishes in a qualitative manner between radiations of different wavelengths within the visible spectrum. The sensation of color responds to the dominant wavelength of the light. These wavelengths, corresponding to the different colors, are somewhat arbitrary, but they may be given roughly as follows (wavelengths in nanometers): Violet (400-450), Blue (450-490), Green (490-550), Yellow (550-590), Orange (590-630), Red (630-700).”

The McLellan text also discloses that “The eye can also determine in a general manner whether the light is confined to a relatively narrow band of wavelengths or dispersed more broadly across the spectrum. In terms of color, the narrowness of the band is referred to as saturation of hue. White light has no dominant wavelength, as the energy is radiated quite uniformly across the visible spectrum.”

The McLellan text also teaches that “Color qualities of surfaces result from the elective absorption characteristics of the surfaces so that some bands of wavelengths are reflected to a greater extent than others. A surface which absorbs the shorter wavelengths but reflects the longer ones will exhibit an orange or red color. It also follows that the color of reflected light is responsive to the color quality of the light source. Objects viewed in the light of an incandescent lamp will appear more red than in the light of a mercury-vapor lamp. These same effects result from the selective absorption of light in a transparent medium . . . .”

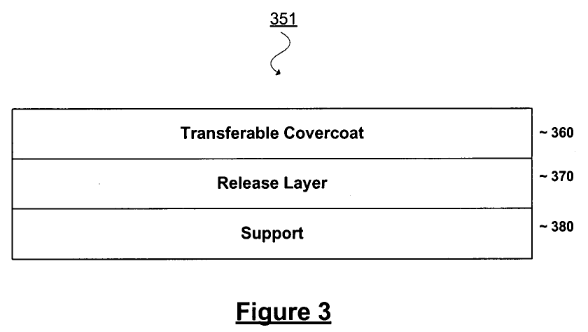

The McLellan text refers (at page 17-4) to certain spectrophotometric curves depicted in a FIG. 17-3, and it discloses that: “Spectrophotometric curves such as A, B, and C of FIG. 17-3 define the color quality of light in a purely scientific manner. These curves will show precision of detail, such as narrow absorption bands, and energy radiated at individual lines of the spectrum which cannot be discriminated by the eye. Other methods of color indication, which conform more nearly with the limitations of the eye, are more adaptable for the purposes of illumination.”

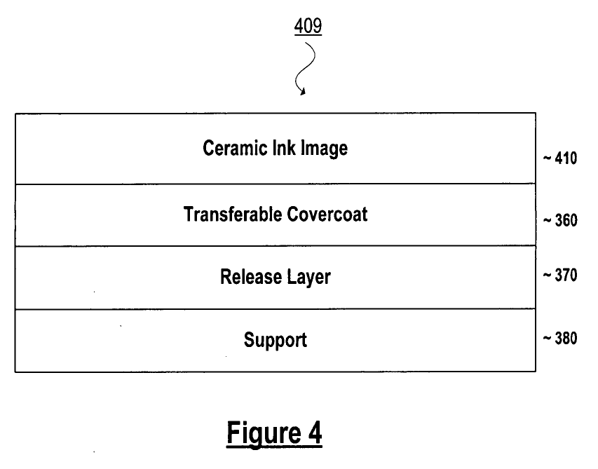

In the last paragraph of page 17-4 of the McLellan text, the CIE system is discussed. It is disclosed that “The CIE (ICI) system of color specification meets this requirement. It is based upon the hypothesis that color sensation results from three distinct nerve responses which have their peak values at different wavelengths. The tri-stimulus values of this system are shown in FIG. 17-4, the middle curve being identical with the standard luminosity curve (FIG. 17-1). When a spectrophotometric curve of energy is evaluated in terms of the tri-stimulus values, the three components, which define color quality, can then be expressed in two dimensions, or x and y coefficients.”

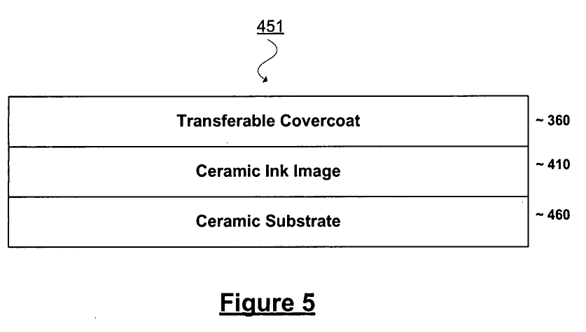

The McLellan text also discloses that: “The whole range of color can in this way be represented by an area on coordinate paper. The locus of the boundary of this area, roughly parabolic in shape (FIG. 17-5), corresponds to the sensations produced by monochromatic light radiations of a single wavelength. These wavelengths in nanometers are indicated in FIG. 17-5. The rectangle marked ‘equal energy,’ sometimes called the white point, refers to the radiant energy distributed uniformly across the visible spectrum. The relative position of any point between the equal energy rectangle and the boundary indicates the purity of color, of saturation of hue—the closer to the boundary, the purer, or more saturated the color of light. The solid line passing near the equal-energy point is the locus of color temperatures of a blackbody. These color temperatures are indicated in Kelvin . . . .”

Other Properties of the Reduced Frit of this Invention

In certain embodiments of this invention, the frit produced by the process of such invention has certain novel properties. Some of these properties, in addition to being described elsewhere in this specification, are also described in this section of the specification.

Elsewhere in this specification applicants have discussed the fact that, in one preferred embodiment, the frit of this invention is comprised of a substantial amount of nano-particulate material. In one embodiment, such nano-particulate material is inhomogeneously dispersed with the particles of the frit.

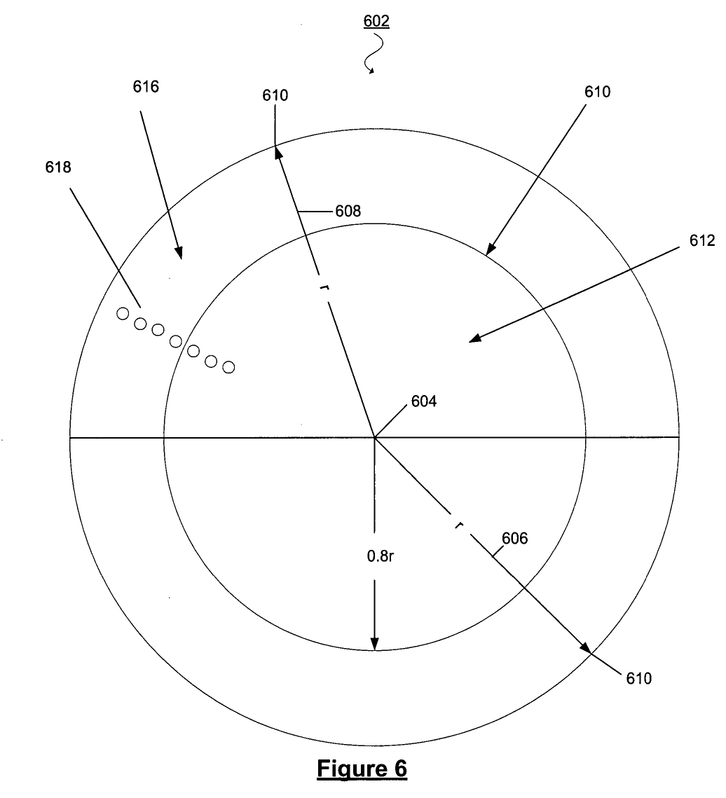

FIG. 6 is a sectional view of a frit particle 602 that, in the embodiment depicted is substantial spherical. The flit particle 602 has a center-point 604 and radii 606, 608 etc. that extend from center-point 604 to the outer surface 610 of the particle 602 over a distance r. The cross-sectional area of particle 602 is equal to (pi)r², wherein pi is equal to about 3.1457.

If one draws a circle around center-point 604 with a radius that is about 80 percent of r, one will define a cross-sectional area 612 with a circumference 614 that is equal to (pi) (0.8 r²). The cross-sectional area 612 will be only 0.64 times as great as the total cross-sectional area of the particle 602, and the cross-sectional area of outer section 616 will be 0.36 times as great as the total cross-sectional area of the particle 602.

In the embodiment depicted, at least fifty percent of the nano-particulate matter 618 in the particle 602 is in a outer section 616 of the surface of particle 602 that represents no more than 40 percent of the total cross-sectional area of such particle 602. In another embodiment, at least fifty percent of the nano-particulate matter 618 in the particle 602 is in an outer section 616 of the surface of particle 602 that represents no more than 30 percent of the total cross-sectional area of such particle 602. In yet another embodiment, at least fifty percent of the nanoparticulate matter 618 in the particle 602 is in a outer section 616 of the surface of particle 602 that represents no more than 20 percent of the total cross-sectional area of such particle 602. In yet another embodiment, at least fifty percent of the nano-particulate matter 618 in the particle 602 is in an outer section 616 of the surface of particle 602 that represents no more than 10 percent of the total cross-sectional area of such particle 602.

In one preferred embodiment, the BET specific surface area of the frit produced by the process of this invention is less than 2 square meters per gram. As is known to those skilled in the art, BET surface area is measured by a gas adsorption technique in accordance with the principle that the amount of gas needed to form a monomolecular layer on a solid surface can be determined from measurements of the volume of gas adsorbed as the pressure is increased by small increments at constant temperature. The BET (Brunauer, Emmet, and Teller) equation relates the adsorbed gas volume, the applied pressure P, and the saturation vapor pressure P_{f}. Reference may be had, e.g., to pages 258-261 of J. P. Sibilia's “A Guide to Materials Characterization and Chemical Analysis” (VCH Publishers, Inc., New York, N.Y., 1988). Reference also may be had, e.g., to the claims of U.S. Pat. Nos. 4,829,103, 5,504,254, 6,673,134, and 6,958,138 (in which the words “B.E.T. specific surface area” appear in the claims), and also to the claims of U.S. Pat. Nos. 5,645,810, 5,801,106, and 5,993,768 (in which the words “B.E.T. surface area” appear in the claims). The entire disclosure of each of these United States patents is hereby incorporated by reference into this specification.

In one preferred embodiment, the transmission properties of the frit of this invention appear to be substantially different than the transmission properties of prior art frits. In another preferred embodiment a digitally applied image comprised of glass frit has a transmission density of at least 1 and a thickness of less than 10 microns. It is more preferred that the transmission density be at least 1.5 and the thickness be less than 10 microns. It is further preferred that the transmission density be at least 2 and the thickness less than 6 microns.

The frit described in U.S. Pat. No. 6,100,209 is designed to reduce the migration of silver ions through the bulk of the fired frit. While the frit of the '209 patent it described as black, it is also said to only contain up to 30 weight percent of reduced metal moieties. In the '209 patent, frit is applied to substrates using analog printing methods such as silk screen and examples reveal image thicknesses of 26 to 27 microns. The examples of the '209 patent also disclose frit particle sizes of 10 to 12 microns. The '209 patent disclosed the use of pigment to enhance the opacity of image and to improve firing. Such pigment is advantageously added before reduction of the metal oxides. Said pigment may be added at a level of up to 50 weight percent of the composition. Such pigment should not contain copper, to avoid the formation of a reddish brown color.

In the instant invention, and in one embodiment thereof, the inventors have discovered that, in order to achieve high transmission densities in digitally printed images of less than 15 microns in thickness, the frit should preferably be small in particle size, preferably less than 10 microns in average particle size. The applicants have also found that the addition of pigment to the imaging layer increases the transmission density. However, the proportion should not exceed about 30 weight percent. Pigments containing copper, such as copper chrome ferrite, have been found to work well in the instant invention, as has manganese ferrite. Typically, pigments are preferably added to the frit after reduction of the metal oxide moieties so that they do not interfere with the reduction process.

The transmission properties of the glass frit of this invention are preferably tested by forming such frit into a continuous film with a thickness of 3 microns and testing the optical properties of the film so formed. In the test used, a continuous film with a thickness of 3 microns is formed on a float glass substrate that is 6 millimeters thick. This film may be formed on the float glass substrate by conventional means.

Thus, e.g. (and as is illustrated in the Examples), the flit to be tested may be incorporated into an organic binder and printed onto a decal with a transferable covercoat. The decal, in turn, may then be used to print the frit onto the glass substrate. The printed glass substrate may then be heated to a temperature of about 700 degrees Celsius to form a continuous film with a thickness of 3 microns. The glass substrate/glass frit assembly is then tested using light with a wavelength of 550 nanometers.

In the claims of this case, when reference is made to the transmission density of the glass frit, it will be understood that it is referring to the transmission density of the glass flit/glass substrate assembly formed in the manner described above (or by a comparable method that produces a 3 micron continuous film of the frit bonded to the float glass substrate) that is tested using light with a wavelength of 550 nanometers. When reference is made to “transmission density per micron of thickness,” it will be understood that this term refers to the transmission density of the glass frit as determined by the process described in the preceding paragraph divided by the thickness of the continuous film of frit disposed on the substrate (which, in the preferred procedure, is 3 [microns]).

It is preferred that, when the glass frit is formed into the 3 micron coating assembly described above and tested, it have a transmission density of at least 0.3 and, more preferably, at least 1.5. In one aspect of this embodiment, under these conditions, the transmission density is at least 2.7.

In one preferred embodiment, when the flit of this invention is used to coat a glass substrate, it produces a coating that is substantially more durable than prior art coated glass substrates.

To increase the darkness or transmission density of images prepared with non-reduced glass frits, color pigments are typically introduced. Applicants have found that, in order to achieve a transmission densities above 1 for a digital image with a thickness of less than 5 microns frit, concentrations as high as 1 part flit to 1 part pigment are preferably used. However, at such high loadings, other problems have been identified. For example, when using a copper manganese ferrite pigment at a ratio of 1 part flit (Ferro 20-8413 from Ferro Corporation of Washington, Pa.) to 1 part copper manganese ferrite pigment (Black 1795, from Ferro Corporation of Washington, Pa.) the fired image has a transmission density of 1.17. However, the image is low in durability. Because the copper manganese ferrite pigment is not well incorporated into the matrix of the fired frit, when the image was cleaned with window cleaner and a soft synthetic cloth, a significant amount of black pigment rubbed off onto the cloth. At lower frit to binder ratios the image was more durable, but the transmission density dropped below 1.

Digital image samples were prepared with a manganese ferrite pigment, and the non-reduced glass flit had high a transmission density. For example, when digital images were prepared and fired using 2 parts of Ferro 20-8413 borosilicate glass frit with 1 part of Shepherd Black 444 manganese ferrite pigment (Shepherd Colors, 4539 Dues Drive, Cincinnati, Ohio 45246), a transmission density of 1.8 was achieved with an image thickness less than 5 microns. However, the fired glass flit image was badly cracked. Applicants believe that the black pigment embrittled the imaging layer. When flexiblizers were added to the image formulation, the cracking was eliminated. However the transmission density of the fired image dropped to 0.84.

Without wishing to be bound to any particular theory, applicants believe that high loadings of pigment in thin imaging layers are problematic. At high concentrations, and in one embodiment, the flit does not appear to be completely encapsulated by the pigment and the resulting image was weak and easily abraded away. At lower concentrations of this pigment, the imaging layer was durable but had low darkness. The pigment was inherently darker, and offered higher transmission densities at concentrations which remained durable. However, the loading of the pigment was still sufficiently high to create other problems such as, for example, layer cracking.

The embrittlement of the imaging layer may be attributed to a number of factors. For example, the pigment might have been partially soluble in the frit, altering its mechanical properties. Alternatively, or additionally, the pigment used had a very small particle size of 0.5 microns, relative to that of the glass frit. The packing density of the pigment and the frit might have been sufficiently high to embrittle the layer. Alternatively, or additionally, the pigment is extremely black and IR absorption might cause it to heat and expand at a fast enough rate to cause the image to crack. Applicants believe that, because of compatibility, durability, darkness and other issues, relying on pigments to provide darkness to a thin imaging layer is quite problematic.

Images prepared with the reduced frit of this invention have been found to be resistant to image abrasion during cleaning, high in transmission density, and free of cracking. Such reduced frits, in one embodiment, are further darkened by the addition of pigments. However, to avoid compatibility issues, pigment loading is preferably limited to no more than about 1 part pigment to 2 parts frit.

To quantify the durability, ASTM Test D4060 (“Standard Test Method for Abrasion Resistance of Organic Coatings by the Taber Abraser”) may be used; this standard test is adapted to evaluate the abrasion resistance of a fired image on said substrate. The test utilizes Taber CS-17 abrasive wheels loaded with 1000 grams weights. In one preferred embodiment, the fired image on said substrate has no visual signs of wear after 100 cycles of Taber Abrasion, using ASTM Test D4060. In another preferred embodiment, the fired image on the substrate has no visual signs of wear after 400 cycles of Taber Abrasion, using ASTM Test D4060. In yet a further preferred embodiment, the fired image on the substrate has no visual signs of wear after 800 cycles of Taber Abrasion, using ASTM Test D4060.

Additionally, ASTM Test D3450 (“Standard Test Method for Washability Properties of Interior Architectural Coatings”) may be used to evaluate durability of the fired image on the substrate after repeated washing cycles. In one preferred embodiment, said fired image on said substrate showed no signs of image degradation after 25 cycles of ASTM Test D3450 Washability Test. In another preferred embodiment, said fired image on said substrate showed no signs of image degradation after 50 cycles of ASTM Test D3450 Washability Test. In yet a further preferred embodiment, said fired image on said substrate showed no signs of image degradation after 100 cycles of ASTM Test D3450 Washability Test.

Such fired images are adhered to the glass or ceramic substrate in such a manner that they cannot be mechanically separated from said substrate without damaging the substrate. However, even if said fired image has good mechanical bonding and adhesion to said substrate, the fired image may still be removable from said substrate by means of acid etching. If said fired image is inadequately fired, sufficient chemical bonds between said fired image and said substrate may not have formed. An inadequate density of such chemical bonds may enable the fired image to be solubilzed by the action of an acid and substantially removed from said substrate. Adequate firing of the image results in the chemical and physical incorporation and integration of the components of the fired image into the surface of said substrate.

A measure of the strength of the bond between said fired image and said substrate can be made using ASTM Test C 724-91 (Reapproved 2000), “Standard Test Method for Acid Resistance of Ceramic Decorations on Architectural-Type Glass.”

In one preferred embodiment, the fired image has an acid resistance (according to ASTM Test C 724-91) on said substrate of 1. In another preferred embodiment, the fired image has an acid resistance according to ASTM Test C 724-91 on said substrate of less than 3. In yet a further preferred embodiment the fired image has an acid resistance according to ASTM Test C 724-91 on said substrate of less than 6.

The Thermal Transfer Ribbon of this Invention

In accordance with one embodiment of this invention, there is provided a thermal assembly that comprises a thermal transfer ribbon and a covercoated transfer sheet. Such assemblies may be used to transfer a ceramic image from a thermal transfer ribbon to a covercoated transfer sheet by means of thermal transfer printing.

In one embodiment, the thermal transfer ribbon comprises a support and, disposed above said support, a ceramic ink layer. The ceramic ink layer is preferably present at a coating weight of from about 2 to about 15 grams per square meter, and preferably comprises from about 15 to about 94.5 weight percent of a solid carbonaceous binder, and at least one of a film-forming glass frit.

In a preferred embodiment, the thermal transfer ribbon comprises a colorant. The film-forming frit is present in the ceramic ink layer at a level of from at least about 33 volume percent; and the colorant may be present in the ceramic ink layer at a level of from about 0 to about 66 volume percent.

The covercoated transfer sheet preferably comprises a flat, flexible support and a transferable covercoat releasably bound to said flat, flexible support. The transferable covercoat is present at a coating weight of from about 2 to about 30 grams per square meter, and it comprises from about 15 to about 94.5 weight percent of a solid carbonaceous binder, 0 to about 75 weight percent a film-forming frit, 0 to 75 weight percent of a colorant. When the transferable covercoat is printed with an image from said thermal transfer ribbon to form an imaged covercoated transfer decal, the image has a higher adhesion to the covercoat than the covercoat has to the flexible substrate, the imaged covercoat has an elongation to break of at least about 1 percent, and the imaged covercoat can be separated from said flexible substrate with a peel force of less than about 30 grams per centimeter.

In one embodiment, the imaged covercoated transfer decal is subsequently used to transfer the image from the covercoated transfer sheet to a substrate to form an imaged substrate. The image may take the form of variable information (such as a lot number, a serial number, an identification number, a date and the like), a name, logo, trademark, make, model, manufacturer and the like, and/or an image, photograph, decoration, drawing, design, pattern and the like.

The imaged substrate may be comprised of a ceramic substrate (such as, e.g., a substrate comprised of glass, porcelain, ceramic whiteware material, metal oxides, one or more clays, porcelain enamel, and the like). The imaged substrate may comprise non-ceramic material (such as, e.g., natural and/or man-made polymeric material, thermoplastic material, elastomeric material, thermoset material, organic coatings, films, composites, sheets and the like).

Any substrate capable of receiving the imaged transfer decal of this invention may be used herein.

In one preferred embodiment, the thermal transfer ribbon of this invention is used to directly or indirectly prepare a digitally printed ceramic image on a ceramic substrate; as used herein, the term “ceramic substrate” includes a glass substrate.

As is known to those skilled in the art, a ceramic image on a glass or ceramic substrate may be opaque or translucent. It may be smooth and glossy or have a frosted appearance. The ceramic image may have a wide variety of colors that, in turn, may be muted or highly saturated. Reference may be had, e.g., to U.S. Pat. Nos. 6,092,942; 5,844,682; 5,585,555; 5,536,595; 5,270,012; 5,209,903; 5,076,990; 4,402,704; 4,396,393; and the like. The entire disclosure of each of these United States patents is hereby incorporated by reference into this specification.

As used in this specification, the term “substrate” refers to a material to which a printed image is affixed; and it is often used with reference to a ceramic substrate that is heat treated after the image is affixed to it.

By comparison, and as used in this specification, the term “support” refers to a material that is coated with one or more layers of material and, after being so coated, may be used to prepare means for transferring the printed image to the substrate. Thus, e.g., the term “support” may be used with regard to, e.g., a thermal transfer ribbon, a decal assembly, a transferable covercoat assembly, etc.

The process of this invention is applicable to both ceramic substrates (such as, e.g., substrates comprised of glass, porcelain, ceramic whitewares, metal oxides, clays, porcelain enamel coated substrates and the like) and non-ceramic substrates (such as, e.g., substrates comprised of polymers, thermoplastics, elastomers, thermosets, organic coatings, films, composites, sheets and the like) Any substrate capable of receiving the decal of this invention may be used herein.

As used herein, the term “ceramic” includes both glass, conventional oxide ceramics, and non-oxide ceramics (such as carbides, nitrides, etc.). When the ceramic material is glass, and in one preferred embodiment, such glass is preferably float glass made by the float process. See, e.g., pages 43 to 51 of “Commercial Glasses,” published by The American Ceramic Society, Inc. (of Columbus Ohio) in 1984 as “Advances in Ceramics, Volume 18.” Other glass or glass-containing substrates are described elsewhere in this specification.

In one embodiment, the ceramic substrate used in the process of this invention preferentially has a melting temperature of at least 550 degrees Celsius. As used in this specification, the term melting temperature refers to the temperature or range of temperatures at which heterogeneous mixtures, such as a glass batch, glazes, and porcelain enamels, become molten or softened. See, e.g., page 165 of Loran S. O'Bannon's “Dictionary of Ceramic Science and Engineering” (Plenum Press, New York, 1984). In one embodiment, it is preferred that the substrate have a melting temperature of at least about 580 degrees Celsius. In another embodiment, such melting temperature is from about 580 to about 1,200 degrees Celsius.

The ceramic substrate used in the process of this invention, in one embodiment, preferably is a material that is subjected to a temperature of at least about 550 degrees Celsius during processing and, in one aspect of this embodiment, comprises one or more metal oxides. Typical of such preferred ceramic substrates are, e.g., glass, ceramic whitewares, enamels, porcelains, etc. Thus, by way of illustration and not limitation, one may use the process of this invention to transfer and fix color images onto ceramic substrates such as dinnerware, outdoor signage, glassware, imaged giftware, architectural tiles, color filter arrays, floor tiles, wall tiles, perfume bottles, wine bottles, beverage containers, and the like.

A Process for Making a Ceramic Ink

In one preferred embodiment, a ceramic ink composition is produced that is comprised of from about 0.5 to about 85 weight percent of the frit of this invention.

Ceramic inks are typically prepared in liquid form. The ink vehicle may be water, organic solvent, or a molten solid such as a wax. Common solvents include, by way of illustration, xylene, isopropyl alcohol, ethyl acetate, acetone, ethanol, butanol, glycol ethers, lactates, glycol ether acetates, aldehydes, ketones, aromatic hydrocarbons and oils. Mixtures of two or more solvents are also suitable. Some presently preferred examples include, 2-butanone, toluene, diethylene glycol monobutyl ether, dipropylene glycol monomethyl ether, tripropylene glycol monomethyl ether and 1-methoxy 2 propanol, and the like. Molten binders include paraffin wax, carnauba wax, microcrystalline wax, montan wax, candalella wax and the like. The ink is also comprised of one or more carbonaceous binders such as poly(acrylates), poly(methacrylates), cellulose derivatives, poly(styrene-L co-maleic anhydride) polymers both partially esterified and non-esterified, poly(vinylpyrrolidone), poly(styrenes), polyvinylalcohols, polyamide, poly(vinylbutyral), ethylene vinyl acetate, polycaprolactone, polycarbonates, polyethers, polyurethanes, poly(esters), as well as rosin derived material such as hydrogenated rosins, rosin dimers, maleated rosin and rosin esters and the like. Carbonaceous binders are preferably added to the ink at a concentration of from about 5 to about 99.5 weight percent. Such binders are preferably first dissolved or dispersed in the vehicle before the addition of glass frit. To facilitate the dissolution or dispersion of the binders, the vehicle may be first heated in a jacketed vessel while stirring with a laboratory mixer. The temperature is typically held below the boiling point of the vehicle. The stirring should be vigorous enough to create a vortex in the vehicle. Once the desired temperature is reached, the carbonaceous binder may be slowly added to the vehicle with continued stirring. Besides binder, one or more plasticizers may also be added to the ink at this stage to adjust the coating or printing properties of the ink. For example, dioctyl phthalate (Chemcentral, Chicago, Ill.) may be added to the ink at 0 to 10 weight percent. One or more dispersants may also be added to the ink at this stage to facilitate the dispersion of the binder and/or the glass frit. For example, Disperbyk 180 (Byk-Chemie, Wallingford, Conn.) may be added to the ink at this stage at a level of 0.01 to about 10 weight percent. One or more gellants may be added to the ink at this stage to increase the low shear viscosity of the ink, helping to reduce or eliminate settling of glass frit or pigment. For example, 0.1 to 10 weight percent of polyamide gellant Uniclear 1 (Arizona Chemical, P.O. Box 550850, Jacksonville, Fla.) may be added to the ink. In addition to these additives, other additives may be incorporated into the ink. For example, film-forming polymers, dispersing agents, surfactants, rheology modifiers, defoamers, humectants, biocides, buffers, adhesion promoters, tackifiers, dyes and the like may be added to the ceramic ink to achieve the desired ink properties.

After the addition of binders, plasticizers and other additives to the ink is complete, the ink is preferably allowed to continue to stir until the solution appears clear and the dispersion appears homogenous. Fine glass frit may now be added to the ink. Such glass flit is preferably added at a concentration from about 0.5 to about 85 weight percent.

In a preferred embodiment, such frit is comprised of particles with a size distribution such that 90 percent of the particles have a size smaller than 10 microns. The flit is preferably added to the ink with stirring and mixed for at least two minutes at about 500 rpm. It is important at this stage that the flit be completely wetted by the liquid ink composition. At this stage, pigment may be optionally added to the ink. For example, typical black pigments include Shepherd black 376, a chrome nickel ferrite, Shepherd Black 444, a manganese ferrite spinel, Shepherd Black 430, copper chromite, Shepherd Black 411, a chrome ferrite, Ferro 1795, a copper manganese ferrite, a cobalt aluminium oxide, a nickel chromium oxide, and the like. Alternatively, the pigment may be a coloured frit, such as a blue frit, for example Johnson Matthey blue frit G1277B.

Frit and pigment may be combined in the form of an enamel that is a sintered combination of frit and pigment. Further the ink composition may comprise a pigment, or conceivably a frit or frit component that is fluorescent or luminescent. Such pigments include: magnesium fluorogermanate red (Meldform Germanium Ltd), Lumilux green CD117, Lumilux blue CD164, Lumilux red CD115 and Lumilux yellow/orange CD130 (All Lumilux products available from Allied Signal or its distributors, e.g. Chemproha, Chemie Partner BV), etc. Such pigments may be added to the ink in the amount of 0 to 42.5 weight percent. The pigment is preferably added to the ink with stirring and mixed for at least two minutes at about 500 rpm. It is important at this stage that the pigment also is completely wetted by the liquid ink composition. At this stage, the ink is ready to be subjected to milling to break up any agglomerates of frit or pigment particles and to fully disperse the frit and pigment in the ink composition.

Milling may be achieved by transferring the ink to a metal paint can and charging the can will an equal weight of 0.3 mm diameter YTZ milling media (Stanford Materials, 4 Meadowpoint, Aliso Viejo, Calif.). The mixture may either be rolled on a roller mill or shaken with a paint shaker until the frit is dispersed. Dispersion quality is preferably judged by drawing the milled ceramic ink across a Hegman grind gauge (Paul N. Gardner Company, Inc., 316N.E. First Street, Pompano Beach, Fla. 33060). A Hegman grind reading of 7 (particle size of 0-5 microns) indicates good dispersion of the glass frit.

In one embodiment, the temperature of the jacketed vessel containing the ceramic ink is reduced to 30° C. The vessel containing the ceramic ink may be placed under a Hockmeyer micro immersion mill (Hockmeyer Equipment Corporation, 6 Kitty Hawk Lane, NC) using a 0.50 mm screen and 1.4-1.6 mm YTZ media (Stanford Materials, 4 Meadowpoint, Aliso Viejo, Calif.). The milling basket of this immersion mill is placed in the ink and the mill started at 200 rpm. The ink is milled at this speed until all the air trapped in the ink is expelled. At this point, the speed of the mill is increased to 3000 rpm and aluminum foil is used to cover the jacketed vessel and shaft of the immersion mill in order to retard solvent loss due to evaporation. The ink is then milled for four hours until a 7.5 is obtained on a Hegman grind gauge. The head of the basket mill is then raised and the jacketed vessel removed from under the mill. At this stage the ink is ready for use.

Ceramic ink-compositions comprised of inorganic frit are well known to those skilled in the art. Reference may be had, e.g., to U.S. Pat. Nos. 4,102,101 (glass panes), 4,167,839 (glass panes), 4,390,565 (photocurable compositions for use as ceramic ink vehicles), 4,708,781 (process of simultaneously printing and electroforming ceramic articles), 5,212,212 (zinc-containing ceramic ink compositions) 5,418,041 (method of applying a ceramic image to a complex ceramic article), 5,749,292 (relief decorating of ceramic articles using screen printing processes), 5,831,651 (ink jet print head having ceramic ink pump member), 5,858,145 (multilayer circuit boards), 6,212,805 (panel with light permeable images), 6,241,837 (method of producing ceramic article with relief decoration), 6,824,639 (partial imaging of a substrate with superimposed layers), 6,504,559 (digital thermal printing process), 6,990,994 (thermal transfer assembly for ceramic imaging), and the like. The entire disclosure of each of these United States patents is hereby incorporated by reference into this specification.

In one embodiment, the ink comprising the frit of this invention is made in substantial accordance with the procedure described in International Publication No. WO 2005/052971 A1, the entire disclosure of which is hereby incorporated by reference into this specification.

The claims of such International Publication No. WO 2005/052971 A1 describe:

“1. A digital printing ink composition comprising particles of at least one glass flit or metal, said particles having a particle size less than 2 Sum, and a dispersion medium.”

“2. A composition according to claim 1, wherein the at least one glass frit or metal particles comprises between 10 and 70 wt %, preferably between 20 and 50 wt % of the composition.”

“3. A composition according to claim 1 or 2, further comprising at least one inorganic pigment.”

“4. A composition according to claim 1 or 2, farther comprising a colourless refractory material.”

“5. A composition according to any one of the preceding claims, having a total solids content! of at least 45 wt %, preferably at least 50 wt %.”

“6. A composition according to claim 3 or claim 5 as dependent upon claim 3, wherein the at least one inorganic pigment comprises between 1 and 40 wt % of the composition.”

“7. A composition according to any one of claims 3 or 5 as dependent upon claim 3, or claim 6, wherein the pigment is a black pigment, preferably copper chromite.”

“8. A composition according to any preceding claim, comprising at least one glass frit having a door particle size of less than 1.5 m, more preferably less than 1 An.”

“9. A composition according to any of the preceding claims and containing an inorganic; pigment, wherein the inorganic pigment has a door particle size of less than 2 μm, preferably less than 11 lm.”

“10. A composition according to any preceding claim, wherein the dispersion medium comprises one or more of water, alcohols, glycol ethers, lactates, glycol ether acetates, aldehydes, ketones, aromatic hydrocarbons and oils.”

“11. A composition according to any preceding claim further comprising one or more polymers chosen from: poly(acrylates), poly(methacrylates), cellulose derivatives, poly(styrene-L co-maleic anhydride) polymers both partially esterified and non-esterified, poly(vinylpyrrolidone), poly(styrenes), polyvinylalcohols), poly(vinylbutyral) and poly(esters).”

“12. A composition according to any preceding claim further comprising a rosin derived material such as hydrogenated rosins, rosin dimers, maleated rosin and rosin esters.”

“13. composition according to any preceding claim further comprising one or more additives chosen from: film-forming polymers, dispersing agents, surfactants, rheology modifiers, defoamers, humectants, biocides, buffers, adhesion promoters, tackifiers and dyes.”

“14. A composition according to any preceding claim and containing metal particles, wherein the metal particles are gold or silver nanoparticles.”

“15. A composition according to claim 1 or 4, containing no pigment and in the form of an etch imitation ink.”

“16. A composition according to any one of the preceding claims in the form of an ink concentrate.”

“17. A method for producing a composition according to any of the preceding claims and comprising a frit, the method comprising forming a dispersion of a glass frit in a dispersion medium, comminuting the dispersion to reduce the particle size of the frit, and filtering the dispersion to remove oversized frit particles.”

“18. A method according to claim 17, further comprising forming a second dispersion of an inorganic pigment in a solvent or dispersion medium, comminuting the second dispersion to reduce the particle size of the inorganic pigment, filtering the second dispersion to remove oversized pigment particles, and combining the filtered second dispersion with the filtered flit dispersion.”

“19. A method according to claim 18, wherein the first and second dispersion have approximately the same particle sizes.”

“20. A method according to claim 17, 18 or 19, wherein one or more polymers, rosin derived materials and/or additives is added to the composition prior to, during or after the comminution end filtering steps.”

“21. A method of producing a coating on a substrate, the method comprising applying a composition according to any of claims 1 to 16 to a substrate using a digital printing head, and heat treating the substrate or curing the deposited coating.”

“22. A method according to claim 21, wherein the substrate is one of a ceramic, a glass or a metal.”

“23. A method according to claim 21 or claim 22, wherein the coating is a decorative coating or a functional coating.”

“24. A method according to claim 13, wherein the substrate is automotive glass, and the coating is an obscuration coating.”

“25. A substrate coated using a method according to any of claims 21 to 24.”

The specification of International Publication WO 2005/052071 also suggests means of utilizing the frit composition of this invention in order to make a ceramic ink. Selected portions of this specification are quoted below.

“This invention relates to a composition suitable for application by an inkjet print head, to a method of producing such a composition and its use for the coating of substrates.”

“There are many advantages of using ink jet printing as a printing or coating technique. It can produce high quality prints at high speed. As a non-contact method, it can be used to print on a wide range of substrates having different surface textures. The image to be printed is stored digitally, thus obviating the need for screens, engraving etc. In addition, images can be altered easily and rapidly, thus allowing for more variation in prints. No down time or cleaning between different designs is required. As the ink is only deposited where required, the technique minimizes ink wastage and reduces cleaning requirements. The small size of the nozzles in a typical inkjet print head place stringent demands on the physico-chemical properties of any ink used, however. Factors such as pigment particle size and ink viscosity, and the quality of pigment and frit dispersion, are important to prevent nozzle blockage.”

“Compositions for application to substrates such as ceramics and glasses commonly include a powdered glass component or ‘Frit’. During subsequent heat treatment (“firing”) the frit melts and bonds to the substrate. Typically, the composition also contains an inorganic pigment, which does not itself melt during heat treatment, but is affixed to the substrate by, or incorporated with, the grit. A combination of a frit and a pigment is often termed an enamel.”

“Enamels are widely used to decorate or produce coatings on ceramics such as tableware, where the composition may be applied by simple screen-printing methods, by applying decals comprising the enamels or by manual application for example, using dipping or a brush. The properties of compositions applied by such techniques can vary within wide ranges without significantly affecting the final coating. Compositions which do not contain a frit can only be affixed to substrates which at least partially melt during heat treatment, such as those already coated with a flit-containing composition, or by applying an over-layer of a frit-containing composition.”

“It is well known to use organic pigments in inkjet ink formulations. These are soft materials and are available with a small particle size, in the order of tens to hundreds of nanometers. Such formulations are widely used for printing onto paper. It is less well known to use formulations containing harder, inorganic pigments. WO 98/51749 discusses inkjet compositions with low sedimentation rates, containing pigments of particle size less than 300′ nm Patent GB 2268505 discusses continuous inkjet printing of inks containing pigments of a i size 0.2-2.0 μm. The pigments are suspended in a solvent, such as MEK and printed onto ceramic or glass substrates prior to firing. U.S. Pat. No. 6,332,943, discuss formulations containing organic and/or inorganic pigments stabilised with particular dispersants. U.S. Pat. No. 6,110,266 describes pigment preparations containing particles of inorganic materials of particles size 0.1-50 nm.”

“There is little or no discussion of practicable inkjet inks containing a frit component or metal particles, and we do not believe that such inks have been successfully prepared and printed.”

“A frit may be defined as ‘any fused substance or mixture quenched to a glass-like form’ and is thus an amorphous material, as opposed to inorganic pigments which are very often crystalline and thus possess a primary particle size. Frits are also generally harder materials than organic pigments and as such, there is a danger that they could abrade the nozzles of an inkjet t printer. The other concern with frit (and indeed inorganic pigments) is that they are dense materials. Compared to organic pigments which have densities of the order of 1 g per cm³, frits have densities in the order of 2-5 g per cm³ This means that compositions containing them may segregate more rapidly than conventional inkjet inks. The properties of brittleness, hardness and high density combine to make frit a highly difficult material to formulate into an ink suitable for inkjet printing. Similar problems apply to metal particles. The present invention provides an improved composition which can be applied to a substrate by digital printing techniques and fixed thereto by heat treatment. Although the prime interest of the Applicants is in inks formulated for thermal transfer the inks prepared according to this invention are to be suitable for other digital printing systems using liquid, thermoplastic or solid inks. The skilled person will determine necessary characteristics such as viscosity, drying characteristics etc.”

“The glass frit may be any suitable glass frit, for example a bismuth silicate frit, zinc borosilicate frit, lead silicate frits or other suitable frits. Mixtures of two or more glass frits are also suitable. In general, the particular frit chosen will depend upon the substrate and the firing profile, as is conventional.”

“Preferably, the at least one glass frit or metal particles comprises between . . . , 20 and 50 wt % of the composition.”

“It should be noted that, in the case of ceramic inks for ink jet printing applications the pigment and frit particles must be very finely dispersed to prevent blockage of inkjet print heads Preferably, the particle size of the frit and pigment must be less than 2 microns, more preferably less than 1 micron and most especially less than 0.5 micron.”

“When adapting the inks of this invention to ink jet printing, after grinding to reduce the particle size it is preferred to also filter the dispersion to remove oversized frit particles. Frit and pigments agglomerates may easily plug the print head nozzle.”

In an alternative ink preparation method for frit/pigment combinations, there is provided a separate dispersion of the inorganic pigment in a solvent, milling the dispersion to reduce the particle size of the inorganic pigment, filtering the second dispersion to remove oversized pigment particles, and combining the filtered second dispersion with the filtered flit dispersion.

Ceramic inks may be applied directly to a substrate as is the case in inkjet printing or they may be initially applied to a transfer sheet and subsequently transferred to a substrate. In either case, a method of producing an image on a substrate comprises applying a ceramic ink to a substrate using a digital print technique such as an inkjet printing head, thermal transfer printhead or electrophotographic printhead. The substrate may be heated or not.

The ceramic image may be a decorative coating such as a picture or pattern. Alternatively, the method may be used to provide a functional coating. Some examples of functional coatings include security markings, including information tagging or information marking and barcodes, I and, coatings on glass sheets to provide safety contrast bands to indicate the presence of glass sheets to pedestrians, barrier coatings or bands including UV barrier coatings, such as black obscuration bands for vehicle glass. In the case of metal inks, such as gold or silver, functional coatings such as conductive tracks may be produced, or a decorative coating in the case of gold.

Gold particle-containing inks may also comprise solubilised gold compounds which yield a gold film.

A Thermal Transfer Ribbon Comprised of Ceramic Ink

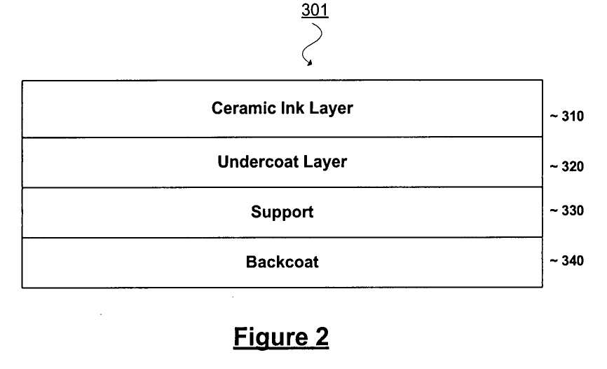

FIG. 2 is a schematic representation of one preferred thermal ribbon 301 comprised of a preferred ceramic ink layer 310, an undercoat layer 320, a support 330 and a backcoat 340.

Referring again to FIG. 2, and in the preferred embodiment depicted therein, it will be seen that a undercoat 320 is disposed on top of and bonded to the top surface of the ribbon support 330. The undercoat 320 is preferably transferred, along with the ceramic ink layer 310, to a receiving sheet or substrate. The undercoat 320 preferably has a coating weight of at least about 0.1 gram per square meter. It is preferred to use a coating weight for undercoat 320 of at least 1 gram per square meter; and it is more preferred to use a coating weight for undercoat 320 of at least about 2 grams per square meter. As will be apparent, the coating weight referred to herein is a dry weight, by weight of components which contain less than 1 percent of solvent.

The coating composition used to apply undercoat 320 onto the support 330 optionally contains glass frit with a melting temperature of at least about 300 degrees Celsius and, more preferably, about 550 degrees Celsius. As used in this specification, the term frit refers to a glass which has been melted and quenched in water or air to form small friable particles which then are processed for milling for use as the major constituent of porcelain enamels, flitted glazes, frit chinaware, and the like. See, e.g., page 111 of Loran S. O'Bannon's “Dictionary of Ceramic Science and Engineering,” supra. As used herein, the terms frit and flux are used interchangeably.

As used herein, the terms frit, flux, opacification agents, pigments and mixtures thereof are all refer to materials that are preferably composed of “metal oxides.”

In one embodiment, and referring again to FIG. 2, the frit used in the process of this invention has a melting temperature of at least about 750 degrees Celsius. In another embodiment, the frit used in the process of this invention has a melting temperature of at least about 950 degrees Celsius.

One may use commercially available frits. Thus, by way of illustration and not limitation, one may use a frit sold by the Johnson Matthey Ceramics Inc. (498 Acorn Lane, Downington, Pa. 19335) as product number 94C1001 (“Onglaze Unleaded Flux”), 23901 (“Unleaded Glass Enamel Flux,”), and the like. One may use a flux sold by the Cerdec Corporation of P.O. Box 519, Washington, Pa. 15301 as product number 9630.

In one embodiment, the melting temperature of the frit used is either substantially the same as or no more than 50 degrees Celsius lower than the melting point of the substrate to which the colored image is to be affixed.

In another embodiment, the melting point of the frit used is at least 50 degrees Celsius lower than the melting point of the opacifying agent used in the thermal transfer ribbon. In one aspect of this embodiment, the melting point of the frit used is at least about 100 degrees Centigrade lower than the melting point of the opacifying agent used in the thermal transfer ribbon. As indicated hereinabove, the opacifying agent(s) is one embodiment of the metal oxide containing ceramic material.

The frit used in the coating composition, before it is melted onto the substrate by the heat treatment process described elsewhere in this specification, preferably has a particle size distribution such that substantially all of the particles are smaller than about 10 microns. In one embodiment, at least about 80 weight percent of the particles are smaller than 5.0 microns.

One may use many of the frits known to those skilled in the art such as, e.g., those described in U.S. Pat. Nos. 5,562,748; 5,476,894; 5,132,165; 3,956,558; 3,898,362; and the like. Similarly, one may use some of the frits disclosed on pages 70-79 of Richard R. Eppler et al.'s “Glazes and Glass Coatings” (The American Ceramic Society, Westerville, Ohio, 2000). In one embodiment, the frit described in this specification is used.

Referring again to FIG. 2, the undercoat 320 optionally comprises at least about 25 weight percent of one or more frits, by total dry weight of all components in undercoat 320. In one embodiment, from about 35 to about 85 weight percent of frit material is used in undercoat 320. In another embodiment, from about 65 to about 75 percent of such frit material is used.

It is preferred that the frit material used in undercoat 320 comprise at least about 5 weight percent, by dry weight, of silica. As used herein, the term silica is included within the meaning of the term metal oxide; and the preferred frits used in the process of this invention comprise at least about 98 weight percent of one or more metal oxides selected from the group consisting of silicon, lithium, sodium, potassium, calcium, magnesium, strontium, barium, bismuth, zinc, boron, aluminum, silicon, zirconium, lead, cadmium, titanium, and the like.

Referring again to FIG. 2, undercoat 320 preferably comprises one or more thermoplastic binder materials in a concentration of from about 0 to about 75 percent, based upon the dry weight of frit and binder in such undercoat 320. In one embodiment, the binder is present in a concentration of from about 15 to about 35 percent. In another embodiment, the undercoat 320 comprises from about 15 to about 75 weight percent of binder.

One may use any of the thermal transfer binders known to those skilled in the art. Thus, e.g., one may use one or more of the thermal transfer binders disclosed in U.S. Pat. Nos. 6,127,316; 6,124,239; 6,114,088; 6,113,725; 6,083,610; 6,031,556; 6,031,021; 6,013,409; 6,008,157; 5,985,076; and the like. The entire disclosure of each of these United States patents is hereby incorporated by reference into this specification.

By way of further illustration, one may use a binder which preferably has a softening point from about 45 to about 150 degrees Celsius and a multiplicity of polar moieties such as, e.g., carboxyl groups, hydroxyl groups, chloride groups, carboxylic acid groups, urethane groups, amide groups, amine groups, urea, epoxy resins, and the like. Some suitable binders within this class include polyester resins, bisphenol-A polyesters, polyvinyl chloride, copolymers made from terephthalic acid, polymethyl methacrylate, vinylchloride/vinylacetate resins, epoxy resins, nylon resins, urethane-formaldehyde resins, polyurethane, mixtures thereof, and the like.

In one embodiment a mixture of two synthetic resins is used. Thus, e.g., one may use a mixture comprising from about 40 to about 60 weight percent of polymethyl methacrylate and from about 40 to about 60 weight percent of vinylchloride/vinylacetate resin. In this embodiment, these materials collectively comprise the binder.

In one embodiment, the binder comprises polybutylmethacrylate and polymethylmethacrylate, comprising from 10 to 30 percent of polybutylmethacrylate and from 50 to 80 percent of the polymethyl methacrylate. In one embodiment, this binder comprises cellulose acetate propionate, ethylenevinylacetate, vinyl chloride/vinyl acetate, urethanes, etc.

One may obtain these binders from many different commercial sources. Thus, e.g., some of them may be purchased from Dianal America Company of 9675 Bayport Blvd., Pasadena, Tex. 77507; suitable binders available from this source include “Dianal BR 113” and “Dianal BR 106.” Similarly, suitable binders may also be obtained from the Eastman Chemicals Company (Tennessee Eastman Division, Box 511, Kingsport, Tenn.).

Referring again to FIG. 2, in addition to the binder, the undercoat 320 may optionally contain from about 0 to about 75 weight percent of wax and, preferably, from about 5 to about 20 weight percent of such wax. In one embodiment, undercoat 320 comprises from about 5 to about 10 weight percent of such wax. Suitable waxes which may be used include, e.g., carnauba wax, rice wax, beeswax, candelilla wax, montan wax, paraffin wax, microcrystalline waxes, synthetic waxes such as oxidized wax, ester wax, low molecular weight polyethylene wax, Fischer-Tropsch wax, and the like. These and other waxes are well known to those skilled in the art and are described, e.g., in U.S. Pat. No. 5,776,280. One may also use ethoxylated high molecular weight alcohols, long chain high molecular weight linear alcohols, copolymers of alpha olefin and maleic anhydride, polyethylene, polypropylene, and the like.

These and other suitable waxes are commercially available from, e.g., the Baker-Hughes Baker Petrolite Company of 12645 West Airport Blvd., Sugarland, Tex.

In one preferred embodiment, carnauba wax is used as the wax. As is known to those skilled in the art, carnauba wax is a hard, high-melting lustrous wax which is composed largely of ceryl palmitate; see, e.g., pages 151-152 of George S. Brady et al.'s “Material's Handbook,” Thirteenth Edition (McGraw-Hill Inc., New York, N.Y., 1991). Reference also may be had, e.g., to U.S. Pat. Nos. 6,024,950; 5,891,476; 5,665,462; 5,569,347; 5,536,627; 5,389,129; 4,873,078; 4,536,218; 4,497,851; 4,610,490; and the like. The entire disclosure of each of these United States patents is hereby incorporated by reference into this specification.

Undercoat 320 may also be comprised of from about 0 to 16 weight percent of one or more plasticizers adapted to plasticize the resin used. Those skilled in the art are aware of which plasticizers are suitable for softening any particular resin. In one embodiment, there is used from about 1 to about 15 weight percent, by dry weight, of a plasticizing agent. Thus, by way of illustration and not limitation, one may use one or more of the plasticizers disclosed in U.S. Pat. No. 5,776,280 including, e.g., adipic acid esters, phthalic acid esters, chlorinated biphenyls, citrates, epoxides, glycerols, glycol, hydrocarbons, chlorinated hydrocarbons, phosphates, esters of phthalic acid such as, e.g., di-2-ethylhexylphthalate, phthalic acid esters, polyethylene glycols, esters of citric acid, epoxides, adipic acid esters, and the like.

In one embodiment, undercoat 320 comprises from about 6 to about 12 weight percent of the plasticizer that, in one embodiment, is dioctyl phthalate. The use of this plasticizing agent is well known and is described, e.g., in U.S. Pat. Nos. 6,121,356; 6,117,572; 6,086,700; 6,060,214; 6,051,171; 6,051,097; 6,045,646; and the like. The entire disclosure of each of these United States patents is hereby incorporated by reference into this specification.

Other suitable plasticizers may be obtained from, e.g., the Eastman Chemical Company.

Referring again to FIG. 2, and in the preferred embodiment depicted therein, undercoat 320 is optionally comprised of one or more opacification agents. Opacification agent(s), when it is used, is preferably used at a weight percent from about 0 percent to about 50 percent.

As is known to those skilled in the art, the opacification agent functions to introduce whiteness or opacity into the ceramic ink by utilizing a substance that disperses in the coating as discrete particles which scatter and reflect some of the incident light. In one embodiment, the opacifying agent is used on a transparent ceramic substrate (such as glass) to improve image contrast properties.

One may use opacifying agents that are known to work with ceramic substrates. Thus, e.g., one may use one or more of the agents disclosed in U.S. Pat. Nos. 6,022,819; 4,977,013 (titanium dioxide); 4,895,516 (zirconium, tin oxide, and titanium dioxide); 3,899,346; and the like. The disclosure of each of these United States patents is hereby incorporated by reference into this specification.

One may obtain opacifying agents from, e.g., Johnson Matthey Ceramic Inc., supra, as, e.g., “Superpax Zirconium Opacifier.”

The opacification agent used, in one embodiment, preferably has a melting temperature at least about 50 degrees Celsius higher than the melting point of the frit(s) used in 320. Generally, the opacification agent(s) has a melting temperature of at least about 350 degrees Celsius.

The opacification agent, in one embodiment, preferably has a refractive index of greater than 2.0 and, preferably, greater than 2.4.

The opacification agent, in one embodiment, preferably has a particle size distribution such that substantially all of the particles are smaller than about 20 microns and, more preferably, about 10 microns. In one embodiment, at least about 80 weight percent of the particles are smaller than 5.0 microns.

Referring again to FIG. 2, the ceramic ink layer 310 is preferably comprised of from about 15 to about 94.5 weight percent of a solid, volatilizable carbonaceous binder; in one preferred embodiment, the ceramic ink layer 310 comprises from about 20 to about 40 weight percent of such solid, volatilizable carbonaceous binder.

As used herein, the term carbonaceous refers to a material that is composed of carbon. The term volatilizable, as used in this specification, refers to a material which, after having been heated to a temperature of greater than 500 degrees Celsius for at least 6 minutes in an atmosphere containing at least about 15 volume percent of oxygen, is transformed into gas and will leave less than about 5 weight percent (by weight of the original material) of a residue comprised of carbonaceous material.

The solid, volatilizable carbonaceous binder may be one or more of the resins, and/or waxes and/or plasticizers, for example, to the thermoplastic binders described elsewhere in this specification.

Referring again to FIG. 2, the ceramic ink layer 310 is preferably comprised of from about 5 to about 75 weight percent of a film forming glass frit that melts at a temperature of greater than about 550 degrees Celsius. As is known to those skilled in the art, such a film forming material is able to form a continuous film when heat treated at a temperature of above 550 degrees Celsius.

In one preferred embodiment, the frosting ink layer comprises from about 35 to about 75 weight percent of the film forming glass frit. In another embodiment, the frosting ink layer comprises from about 40 to about 75 weight percent of the film forming glass frit.

The film forming glass frit used in ceramic ink layer 310 preferably has a melting temperature greater than 300 degrees Celsius.

Referring again to FIG. 2, and in one embodiment, the ceramic ink layer 310 is preferably comprised of at least about 0.5 weight percent of opacifying agent with a melting temperature of at least 50 degrees Celsius above the melting temperature of the film forming glass frit, a refractive index of greater than about 1.6 and a particle size distribution such that substantially all of its particles are smaller than about 20 microns. One may use other opacifying agents such as, e.g., Superpax Zircon Opacifier. This and other suitable opacifying agents are described elsewhere in this specification.

This opacifying agent is one embodiment of the metal oxide containing ceramic colorant that is used in applicants' process; one other such embodiment is a metal oxide containing pigment.

In one embodiment, from about 2 to about 25 weight percent of the opacifying agent is used. In another embodiment, from about 5 to about 20 weight percent of the opacifying agent is used. Thus, e.g., one may 8.17 weight percent of such Superpax Zircon Opacifier opacifying agent.

In one preferred embodiment, it is preferred that the refractive index of the opacifying agent(s) used in the ceramic ink layer 310 be greater than about 1.6 and, preferably, be greater than about 1.7.

In one preferred embodiment, the film forming glass frit(s) and the opacifying agent(s) used in the ceramic ink layer 310 is chosen so that the refractive index of the film forming glass frit material(s) and the refractive index of the opacifying agent material(s) preferably differ from each other by at least about 0.1 and, more preferably, by at least about 0.2. In another preferred embodiment, the difference in such refractive indices is at least 0.3, with the opacifying agent having the higher refractive index.

The film forming glass flit(s) and the opacifying agent(s) used in the ceramic ink layer 310 is preferably chosen such that melting point of the opacifying agent(s) is at least about 50 degrees Celsius higher than the melting point of the film forming glass frit(s) and, more preferably, at least about 100 degrees Celsius higher than the melting point of the film forming glass frit. In one embodiment, the melting point of the opacifying agent(s) is at least about 500 degrees Celsius greater than the melting point of the film forming glass frit(s). Thus, it is generally preferred that the opacifying agent(s) have a melting temperature of at least about 1,200 degrees Celsius.

It is preferred that the weight/weight ratio of opacifying agent/film forming glass frit used in the ceramic ink layer 310 be no greater than about 1.25

Referring again to FIG. 2, and in one embodiment, thereof, the ceramic ink layer 310 is optionally comprised of from about 1 to about 25 weight percent of platy particles; in an even more preferred aspect of this embodiment, the concentration of the platy particles is from about 5 to about 15 weight percent. As is known to those skilled in the art, a platy particle is one whose length is more than three times its thickness. Reference may be had, e.g., to U.S. Pat. Nos. 6,277,903; 6,267,810; 6,153,709; 6,139,615; 6,124,031; 6,004,467; 5,830,364; 5,795,501; 5,780,154; 5,728,442; 5,693,397; 5,645,635; 5,601,916; 5,597,638; 5,560,983; 5,460,935; 5,457,628; 5,447,782; 5,437,720; 5,443,989; 5,364,828; 5,242,614; 5,231,127; 5,227,283; 5,196,131; 5,194,124; 5,153,250; 5,132,104; 4,548,801; 4,544,761; 4,465,797; 4,405,727; 4,154,899; 4,131,591; 4,125,411; 4,087,343; and the like. The entire disclosure of each of these United States patents is hereby incorporated by reference into this specification.

The platy particles are preferably platy inorganic particles such as, e.g., platy talc. Thus, by way of illustration and not limitation, one may use “Cantal 290” micronized platy talc sold by the Canada Talc company of Marmora Mine Road, Marmora, Ontario, Canada. This platy talc has a particle size distribution such that substantially all of its particles are smaller than about 20 microns. Alternatively, or additionally, one may use, e.g., Cantal 45-85 platy particles, and/or Sierralite 603 platy particles; Sierralite 603 particles are sold by Luzenac America, Inc. of 9000 East Nicols Avenue, Englewood, Colo.

In one preferred embodiment, the ceramic ink layer 310 optionally contains from 0 to about 66 volume percent of an inorganic pigment. It is preferred that such optional inorganic pigment be a metal oxide pigment. When said metal oxide pigment is used in ceramic ink layer 310, said pigment should have a refractive index of greater than 1.6.

The metal oxide containing pigments are one embodiment of the metal oxide containing ceramic colorants used in the process of this invention. The pigments that work well in this embodiment of applicants' process preferably each contain at least one metal-oxide. Thus, a blue colorant can contain the oxides of a cobalt, chromium, aluminum, copper, manganese, zinc, etc. Thus, e.g., a yellow colorant can contain the oxides of one or more of lead, antimony, zinc, titanium, vanadium, gold, and the like. Thus, e.g., a red colorant can contain the oxides of one or more of chromium, iron (two valence state), zinc, gold, cadmium, selenium, or copper. Thus, e.g., a black colorant can contain the oxides of the metals of copper, chromium, cobalt, iron (plus two valence), nickel, manganese, and the like. Furthermore, in general, one may use colorants comprised of the oxides of calcium, cadmium, zinc, aluminum, silicon, etc.

Suitable pigments and colorants are well known to those skilled in the art. See, e.g., U.S. Pat. Nos. 6,120,637; 6,108,456; 6,106,910; 6,103,389; 6,083,872; 6,077,594; 6,075,927; 6,057,028; 6,040,269; 6,040,267; 6,031,021; 6,004,718; 5,977,263; and the like. The disclosure of each of these United States patents is hereby incorporated by reference into this specification.

By way of further illustration, some of the pigments which can be used in this embodiment of the process of this invention include those described in U.S. Pat. Nos. 6,086,846; 6,077,797 (a mixture of chromium oxide and blue cobalt spinel); 6,075,223 (oxides of transition elements or compounds of oxides of transition elements); 6,045,859 (pink coloring element); 5,988,968 (chromium oxide, ferric oxide); 5,968,856 (glass coloring oxides such as titania, cesium oxide, ferric oxide, and mixtures thereof); 5,962,152 (green chromium oxides); 5,912,064; 5,897,885; 5,895,511; 5,820,991 (coloring agents for ceramic paint); 5,702,520 (a mixture of metal oxides adjusted to achieve a particular color); and the like. The entire disclosure of each of these United States patents is hereby incorporated by reference into this specification.

The ribbons produced by one embodiment of the process of this invention are preferably leach-proof and will not leach toxic metal oxide. This is unlike the prior art ribbons described by Tanaka at Column 1 of U.S. Pat. No. 5,665,472, wherein he states that: “In the case of the thermal transfer sheet containing a glass frit in the binder of the hot-melt ink layer, lead glass has been used as the glass frit, posing a problem that lead becomes a toxic, water-soluble compound.” Without wishing to be bound to any particular theory, applicants believe that this undesirable leaching effect occurs because the prior art combined the frit and colorant into a single layer, thereby not leaving enough room in the formulation for sufficient binder to protect the layer from leaching.

The particle size distribution of the pigment used in layer 320 should preferably be within a relatively narrow range. It is preferred that the colorant have a particle size distribution such that at least about 90 weight percent of its particles are within the range of 0.2 to 20 microns.

The pigment used preferably has a refractive index greater than 1.4 and, more preferably, greater than 1.6. In one embodiment, the pigment does not decompose and/or react with the molten frit when subjected to a temperature in range of from about 550 to about 1200 degrees Celsius.

The thermal ribbon 301 depicted in FIG. 2 is preferably prepared by coating ceramic ink layer 310 at a coating weight of from about 2.0 to about 15 grams per square meter onto the polyester support. In one embodiment, the coating weight of the ceramic ink layer 310 is from about 4 to about 10 grams per square meter. The ceramic ink layer 301 is comprised of glass frit and thermoplastic binder, described elsewhere in this specification. In additional, ceramic ink layer 301 may optionally be comprised of opacification agents, pigments, waxes, platy particles, plasticizers all of which have been described elsewhere in this specification.

In the embodiment depicted in FIG. 2, the support 330 may be any flexible support typically used in thermal transfer ribbons such as, e.g., the flexible supports described in U.S. Pat. No. 5,776,280, the entire disclosure of this patent is hereby incorporated by reference into this specification.

In one embodiment, flexible support 330 is a flexible material that comprises a smooth, tissue-type paper such as, e.g., 30-40 gauge capacitor tissue. In another embodiment, flexible support 330 is a flexible material consisting essentially of synthetic polymeric material, such as poly(ethylene terephthalate) polyester with a thickness of from about 1.5 to about 15 microns which, preferably, is biaxially oriented. Thus, by way of illustration and not limitation, one may use poly(ethylene terephthalate) film supplied by the Toray Plastics of America (of 50 Belvere Avenue, North Kingstown, R.I.) as catalog number F53.

By way of further illustration, flexible support 330 may be any of the flexible substrate films disclosed in U.S. Pat. No. 5,665,472, the entire disclosure of which is hereby incorporated by reference into this specification. Thus, e.g., one may use films of plastic such as polyester, polypropylene, cellophane, polycarbonate, cellulose acetate, polyethylene, polyvinyl chloride, polystyrene, nylon, polyimide, polyvinylidene chloride, polyvinyl alcohol, fluororesin, chlorinated resin, ionomer, paper such as condenser paper and paraffin paper, nonwoven fabric, and laminates of these materials.

Affixed to the bottom surface of support 330 is backcoating layer 340, which is similar in function to the “backside layer” described at columns 2-3 of U.S. Pat. No. 5,665,472, the entire disclosure of which is hereby incorporated by reference into this specification. The function of this backcoating layer 340 is to prevent blocking between a thermal backing sheet and a thermal head and, simultaneously, to improve the slip property of the thermal backing sheet.

Backcoating layer 340, and the other layers which form the ribbons of this invention, may be applied by conventional coating means. Thus, by way of illustration and not limitation, one may use one or more of the coating processes described in U.S. Pat. Nos. 6,071,585 (spray coating, roller coating, gravure, or application with a kiss roll, air knife, or doctor blade, such as a Meyer rod); 5,981,058 (myer rod coating); 5,997,227; 5,965,244; 5,891,294; 5,716,717; 5,672,428; 5,573,693; 4,304,700; and the like. The entire disclosure of each of these United States patents is hereby incorporated by reference into this specification.

Thus, e.g., backcoating layer 340 may be formed by dissolving or dispersing the above binder resin containing additive (such as a slip agent, surfactant, inorganic particles, organic particles, etc.) in a suitable solvent to prepare a coating liquid. Coating the coating liquid by means of conventional coating devices (such as Gravure coater or a wire bar) may then occur, after which the coating may be dried.

One may form a backcoating layer 340 of a binder resin with additives such as, e.g., a slip agent, a surfactant, inorganic particles, organic particles, etc.

Binder resins usable in the layer 340 include, e.g., cellulosic resins such as ethyl cellulose, hydroxyethylcellulose, hydroxypropylcellulose, methylcellulose, cellulose acetate, cellulose acetate buytryate, and nitrocellulose. Vinyl resins, such as polyvinylalcohol, polyvinylacetate, polyvinylbutyral, polyvinylacetal, and polyvinylpyrrolidone, also may be used. One also may use acrylic resins such as polyacrylamide, polyacrylonitrile-co-styrene, polymethylmethacrylate, and the like. One may also use polyester resins, silicone-modified or fluorine-modified urethane resins, and the like.

In one embodiment, the binder comprises a cross-linked resin. In this case, a resin having several reactive groups, for example, hydroxyl groups, is used in combination with a crosslinking agent, such as a polyisocyanate.

In one embodiment, a backcoating layer 340 is prepared and applied at a coat weight of 0.05 grams per square meter. This backcoating 340 preferably is polydimethylsiloxane-urethane copolymer sold as ASP-2200 by the Advanced Polymer Company of New Jersey.

One may apply backcoating layer 340 at a coating weight of from about 0.01 to about 2 grams per square meter, with a range of from about 0.02 to about 0.4 grams per square meter being preferred in one embodiment and a range of from about 0.5 to about 1.5 grams per square meter being preferred in another embodiment.

Thermal transfer ribbon 300 may be digitally printed to an image receiving sheet. It is preferred to print digital image(s) with thermal transfer ribbon 300 using a thermal transfer printer. Such printers are well known to those skilled in the art and are described in International Publication No. WO97/00781, published on Jan. 7, 1997, the entire disclosure of which is hereby incorporated by reference into this specification. As is disclosed in this publication, a thermal transfer printer is a machine that creates an image by melting ink from a film ribbon and transferring it at selective locations onto a receiving material. Such a printer normally comprises a print head including a plurality of heating elements that may be arranged in a line. The heating elements can be operated selectively.

Alternatively, or additionally, the image(s) may be printed by means of xerography, ink jet printing, silk screen printing, lithographic printing, and the like.

Alternatively, one may use one or more of the thermal transfer printers disclosed in U.S. Pat. Nos. 6,124,944; 6,118,467; 6,116,709; 6,103,389; 6,102,534; 6,084,623; 6,083,872; 6,082,912; 6,078,346; and the like. The disclosure of each of these United States patents is hereby incorporated by reference into this specification.

Digital thermal transfer printers are readily commercially available. Thus, e.g., one may use a printer identified as Gerber Scientific's Edge 2 sold by the Gerber Scientific Corporation of Connecticut. With such a printer, the digital color image(s) may be applied by one or more appropriate ribbon(s) in the manner discussed elsewhere in this specification

Process to Produce a Ceramic Ink Decal

In this portion of the specification, applicants discuss a covercoated transfer sheet suitable for transferring images to a ceramic substrate. This covercoated transfer sheet comprises a flat, flexible support and a transferable covercoat releasably bound to said flat, flexible support, wherein, when said transferable covercoat is printed with an image to form an imaged covercoat, said image has a higher adhesion to said covercoat than said covercoat has to said flexible support, said imaged covercoat has an elongation to break of at least about 1 percent, and said imaged covercoat can be separated from said flexible support with a peel force of less than about 30 grams per centimeter.

In FIG. 3, a covercoated receiving sheet 351 is illustrated. The receiving sheet 351 comprises a transferable covercoat 360 which preferably has a coating weight of from about 1 to about 10 grams per square meter. The covercoat 360 preferably is comprised of at least 80 weight percent of one or more of the thermoplastic binders described elsewhere in this specification. The thermoplastic binder material(s) used in the covercoat preferably has an elongation to break of more than about 1 percent, as determined by the standard A.S.T.M. test.

The transferable covercoat 360, after being subjected to a temperature of 500 degrees Celsius for at least 6 minutes, preferably produces less than about 1 weight percent of ash, based upon the weight of the uncombusted covercoat.

In a preferred embodiment the receiving sheet 351 comprises a transferable covercoat 360 which is substantially free of glass frit (containing less than about 5 weight percent of glass). By way of illustration and not limitation, the covercoat 360 may comprised of suitable thermoplastic materials which include, e.g., polyvinylbutyral, ethyl cellulose, cellulose acetate propionate, polyvinylacetal, polymethylmethacrylate, polybutylmethacrylate, and mixtures thereof, styrenated acrylic resin, polyester, polyvinyl chloride, polyethylene-co-vinylacetate, polystyrene-co-butadiene, polyvinylacetate, and the like. In general, the covercoat is preferably comprised of at least about 70 weight percent of one or more of these polymeric entities.

It is has been found that certain acrylates, such as polymethylmethacrylate, have ambient temperature elongations to break that are too low to be useful in applicants' process. By comparison, these acrylates may be used in prior art processes at the elevated temperatures required thereby, such as, e.g., the process of U.S. Pat. No. 5,069,954 (see, e.g., the paragraph beginning at line 59 of column 4 of such patent).

In one embodiment, the covercoat 360 comprises from about 0 to about 10 weight percent of tackifying agent, by total weight of tackifying agent and covercoat binder. As used herein, the term tackifying agent includes both plasticizing agents and tackifiers. See, e.g., U.S. Pat. No. 5,069,954 (at column 6) wherein the use of sucrose acetate iso-butyrate is described. It is preferred not to use more than about 10 weight percent of such tackifying agent in that it has been found that over tackifying of the covercoat 360 often limits the use of the covercoat in thermal transfer printing processes. The excess tackifying agent creates such adhesion between the covercoated substrate and the thermal transfer ribbon that undesired pressure transfer of the ink occurs.

Referring again to FIG. 3, the support 380 is typically paper. However, this support 380 may be any type of flat, thin, flexible sheet, for example, polyester or polyolefin films, non-woven sheets and the like. The support 380 for the decal should first be coated with a release layer 370 and then a covercoat layer 360. The covercoated support should have the characteristics of being able to receive a thermally printed digital image from the various thermal transfer ribbons described elsewhere in this specification. After printing onto such coated supports, a ceramic decal is formed. A further characteristic of these decals is that, after the decal has been attached to the ceramic substrate, the support 380 on which the decal was formed preferably is able to be cleanly separated from the image. This separation should occur between the release layer 370 and the covercoat 360 such that the covercoat and the image remain entirely on the ceramic substrate.

In a preferred embodiment, the release layer 370 preferably has a thickness of from about 0.2 to about 2.0 microns and comprises at least about 50 weight percent of wax.

Referring again to FIG. 3, and the transferable covercoat layer 360, and in one embodiment, the transferable covercoat layer 360 is comprised of ethylcellulose. Such a covercoat may be prepared, in one illustrative embodiment, by dissolving 12 grams of ethylcellulose with a mixture of 16.4 grams of isopropyl alcohol, 68.17 grams of toluene, and 3.42 grams of dioctyl phthalate that has been heated to 50 degrees Celsius. The solution thus formed is then applied to a wax/resin coated substrate with a Meyer rod to achieve a coating weight of about 10 grams per square meter. In this embodiment, covercoat layer 360 comprises at least about 25 weight percent of thermoplastic material with an elongation to break of greater than about 1 percent. In one embodiment, the covercoat layer 360 comprises at least about 50 weight percent of thermoplastic material with an elongation to break of greater than 1 percent. In another embodiment, the covercoat layer 360 comprises thermoplastic material with an elongation to break greater than 5 percent.

Referring again to FIG. 3, in one preferred embodiment, covercoated transfer sheet 351 is comprised of a thermoplastic release layer 370 applied to support 380. The thermoplastic release layer 370 provides a surface from which transferable covercoat 360 may be easily separated.

In one embodiment, the covercoat layer 360 is incorporated into a covercoated transfer sheet 351 for transferring images to a ceramic substrate, wherein said covercoated transfer sheet 351 comprises a flat, flexible support and a transferable covercoat releasably bound to said flat, flexible support, wherein, when said transferable covercoat is printed with an image to form an imaged covercoat, said image has a higher adhesion to said covercoat than said covercoat has to said flexible substrate, said imaged covercoat has an elongation to break of at least about 1 percent, and said imaged covercoat can be separated from said flexible substrate with a peel force of less than about 30 grams per centimeter.

Referring again to FIG. 3, in one preferred embodiment, ceramic ink receiver sheet 351 is comprised of a wax release layer 370 applied to support 380. This wax release layer 370 preferably has a thickness of from about 0.2 to about 2.0 microns and typically comprises at least about 50 weight percent of wax. Wax release layer 370 may be used to facilitate the transfer of transferable covercoat 360 to a glass or ceramic substrate. In such an image transfer, image receiver sheet 351 is laminated to a glass or ceramic substrate at a temperature sufficient to melt wax release layer 370. Support 380 may then be removed. Such covercoated transfer papers 351 are often referred to as heat transfer paper, i.e., a commercially available paper with a wax coating possessing a melt point in the range of from about 65 to about 85 degrees Celsius which is coated with a layer of ethylcellulose that, in one embodiment, is about 10 grams/square meter thick. Such heat transfer paper is discussed, e.g., in U.S. Pat. Nos. 6,126,669; 6,123,794; 6,025,860; 5,944,931; 5,916,399; 5,824,395; 5,032,449; and the like. The entire disclosure of each of these United States patents is hereby incorporated by reference into this specification

The transferable covercoat 360 may optionally contain from about 2 to about 80 weight percent (by total weight of the covercoat) of one or more of the frits described elsewhere in this specification. In one preferred embodiment, the covercoat 360 comprises from about 50 to about 60 weight percent of such frit.

The transferable covercoat 360 may also optionally contain from about 1 to about 40 weight percent of opacifying agent, by total weight of covercoat. In one embodiment, both such frit and such opacifying agent are present in the covercoat 360, the amount of frit and the amount of opacifying agent, in combination, exceeds the amount of binder in the covercoat 360, and the amount of frit in the covercoat 360 exceeds the amount of opacifying agent.

The covercoat 360 preferably contains from 20 to about 100 weight percent of one or more of the binders described elsewhere in this specification. When the covercoat 360 also contains frit and/or opacifying agent, then the covercoat 360 comprises less than about 50 weight percent of such binder.

The transferable covercoat 360 may also optionally contain from about 1 to about 40 weight percent of inorganic pigment, by total weight of covercoat. In one embodiment, both such frit and such pigment are present in the covercoat 360, the amount of frit and the amount of pigment, in combination, exceeds the amount of binder in the covercoat 360, and the amount of frit in the covercoat 360 exceeds the amount of pigment.

The covercoat 360 preferably contains from 20 to about 100 weight percent of one or more of the binders described elsewhere in this specification. When the covercoat 360 also contains frit and/or pigment, then the covercoat 360 comprises less than about 50 weight percent of such binder.

Referring again to FIG. 3, it is preferred that support 380 be smooth, uniform in thickness, and flexible.

In one embodiment, the flexible support 380 has a surface energy of less than about 50 dynes per centimeter. Surface energy, and means for measuring it, are well known to those skilled in the art. Reference may be had, e.g., to U.S. Pat. Nos. 5,121,636 (surface energy meter); 6,225,409; 6,221,444; 6,075,965; 6,007,918; 5,777,014; and the like. The entire disclosure of each of these United States patents is hereby incorporated by reference into this specification.

In one embodiment, the flexible support 380 has a surface energy of less than about 40 dynes per centimeters.

In one preferred embodiment, the flexible support 380 either consists essentially of or comprises at least 80 weight percent of a synthetic polymeric material such as, e.g., polyethylene, polyester, nylon, polypropylene, polycarbonate, poly(tetrafluoroethylene), fluorinated polyethylene-co-propylene, polychlorotrifluoroethylene, and the like.

In one preferred embodiment, the flexible support 380 comprises at least about 90 weight percent of polyethylene or polypropylene or polybutylene, or mixtures thereof.

The flexible support 380 preferably has a thickness of from about 50 microns to about 250 microns. It is preferred that the thickness of support 380 not vary across the support 380 by more than about 15 percent.

In one embodiment, the support 380 does soften when exposed to organic solvent(s) or water.

In one embodiment, the flexible support 380 is adapted to separate from a transferable covercoat 360 upon the application of minimal force. Thus, e.g., and referring to 351, the flexible support 380 is preferably adapted to release from covercoat 360 upon the application of a linear stress of less than about 100 grams per centimeter and, more preferably, less than about 30 grams per centimeter, at a temperature of 20 degrees Celsius. It is preferred that the peel strength required to separate the covercoat 360 be less than about 15 grams per centimeter at 20 degrees Celsius.

One may determine the force required to separate a covercoat from a flexible support by a test in which 1.27 centimeter×20.32 centimeter strips of covercoated support are prepared. For each such sample, the covercoat is then manually separated at 20 degrees Celsius from the substrate backing for 2.54 centimeters at the top of each strip. Each half of the strip is then mounted in the grips of a tensile device manufactured by the Sintech Division of MTS Systems company (P.O. Box 14226, Research Triangle Park, Raleigh, N.C. 22709) and identified as Sintech model 200/S. 200/S. Such use of the Sintech 200/S machine is well known. Reference may be had to, e.g., international patent publications WO0160607A1, WO0211978A, WO0077115A1, and the like; the entire disclosure of each of these patent publications is hereby incorporated by reference into this specification. The peel adhesion is measured at 25.4 centimeters per minute with a 5 pound load cell at a temperature of 20 degrees Celsius and ambient pressure.

Referring again to FIG. 3, transferable covercoat sheet 351 is comprised of a paper support 380 and a release layer 370.

In one embodiment, the surface energy of support 380 is less than 60 dynes per centimeter. In this embodiment, the flexible support 380 preferably comprises at least about 80 weight percent of, or consists essentially of, a cellulosic material such as, e.g., paper.

When paper is used as the flexible support 380, it preferably has a basis weight of at least about 50 to about 200 grams per square meter. In one embodiment, the basis weight of the paper 380 is from about 45 to about 65 grams per square meter.

In one embodiment, the support 380 is a 90 gram per square meter basis paper made from bleached softwood and hardwood fibers. The surface of this paper is sized with starch.

In the embodiment depicted in FIG. 3, the flexible support/paper 380 is preferably coated with and contiguous with a release layer 370. Thus, e.g., the paper 380 may be coated with a release layer by extrusion coating a polyethylene to a coat weight of 20 grams per square meter.

The release layer 370 need not necessarily comprise wax. The release layer 370 does preferably comprise a material that, when coated upon the flexible support 380, provides a smooth surface with a surface energy of less than about 50 dynes per centimeter.

In one embodiment, the release layer 370 comprises a polyolefin, such as, e.g., polyethylene, polypropylene, polybutylene, and mixtures thereof, to a coatweight on the faceside of 24 grams per square meter and on the backside of 27 grams per square meter.

In one embodiment, it is preferred to coat the release layer 370 onto the support 380 by means of extrusion, at a temperature of from about 200 to about 300 degrees Celsius. Extrusion coating of a resin is well known. Reference may be had, e.g., to U.S. Pat. Nos. 5,104,722; 4,481,352; 4,389,445; 5,093,306; 5,895,542; and the like. The entire disclosure of each of these United States patents is hereby incorporated by reference into this specification.

It is preferred that the release layer coating 370 be substantially smooth. In one embodiment, the coated support has a Sheffield smoothness of from about 1 to about 150 Sheffield Units and, more preferably, from about 1 to about 50 Sheffield Units. Means for determining Sheffield smoothness are well known. Reference may be had, e.g., to U.S. Pat. Nos. 5,451,559; 5,271,990 (image receptor heat transfer paper), 5,716,900; 6,332,953; 5,985,424; and the like. The entire disclosure of each of these United States patents is hereby incorporated by reference into this specification.

Similarly, the uncoated substrate 380 (see FIG. 350) also has a surface energy of less than 40 dynes per centimeter and smoothness of from about 10 to about 150 Sheffield Units.

Referring again to FIG. 3, and in the preferred embodiment depicted therein, the release layer 370 may be of any composition that will produce the desired surface energy and smoothness upon coating the support 380. Thus, by way of illustration and not limitation, one may utilize a cured silicone release layer. Release layers comprised of silicone are well known. Reference may be had, e.g., to U.S. Pat. Nos. 5,415,935 (polymeric release film); 5,139,815 (acid catalyzed silicone release layer); 5,654,093; 5,761,595; 5,543,231 (radiation curable silicone release layer); and the like. The entire disclosure of each of these United States patents is hereby incorporated by reference into this specification.

By way of further illustration, one may use fluoropolymer release agents. See, e.g., U.S. Pat. Nos. 5,882,753 (extrudable release coating); 5,807,632; 6,248,435; and the like. The entire disclosure of each of these United States patents is hereby incorporated by reference into this specification.

Transfer or Images to a Ceramic Substrate

In the assembly 409 depicted in FIG. 4, after the covercoated receiving sheet has been imaged with a ceramic ink image 410 which has been digitally applied with the use of the thermal transfer ribbon 300 by means of the printing process described elsewhere in this specification.

Thus, for example, in one embodiment the ceramic ink image 410 and transferable covercoat 360 are transferred to a ceramic substrate 460 with the assembly 409 depicted in FIG. 4. This imaged ceramic assembly 451 (see FIG. 5) comprises a ceramic substrate 460 on which a ceramic ink image 410 is disposed. As will be apparent to those skilled in the art, after the ceramic ink image 410 has been transferred to the substrate 460, the substrate 460 may be heat treated to either sinter it or to cause the materials disposed on it to flow and adhere to it. When such heat treating occurs, the frit in layers 360 and 410 melts and reforms as glass.

Referring again to FIG. 5, the imaged ceramic assembly 451 is preferably heat treated to burn off substantially all of the carbonaceous material contained in the transferable covercoat 360 and the ceramic ink image 410 of the assembly. In general, the assembly is subjected to a temperature of from at least about 350 degrees Celsius for at least about 5 minutes.

In one embodiment, when the substrate 460 is a clear substrate (such as, e.g., glass), one may measure and compare the transmission density of the un-heat treated and heat treated ceramic ink images by means of, e.g., a densitometer. In another embodiment, when the substrate 460 is an opaque substrate, one may measure and compare the reflection density of the un-heat treated and heat treated ceramic ink images by means of, e.g., a densitometer. Such uses of a densitometer are well known. Reference may be had, e.g., to U.S. Pat. Nos. 3,614,241 (automatic recording densitometer which simultaneously determines and records the optical density of a strip of photographic film); 5,525,571; 5,118,183; 5,062,714; and the like. The entire disclosure of each of these United States patents is hereby incorporated by reference into this specification.

Without wishing to be bound by any particular theory, applicants believe that this erosion can occur when gases are formed during the heat treating and disrupt the ceramic ink image 410 as they escape from the heat treated assembly.

Regardless of the cause of such erosion, its existence damages the optical properties of the heat treated substrate. The process of the instant invention produces a product in which such erosion is substantially absent.

One may determine the difference in opacity between the un-heat treated ceramic ink image 410 and the heat treated ceramic ink image with standard TAPPI test T519. This difference in opacity is often referred to as the “delta opacity,” and it preferably is less than about 15 percent. In one embodiment, such delta opacity is less than about 8 percent. In yet another embodiment, such delta opacity is less than about 2 percent.

In one embodiment, the substrate 460 used comprises at least about 10 weight percent of an element selected from the group consisting of aluminum, silicon, magnesium, beryllium, titanium, boron, mixtures thereof, and the oxides and/or carbides and/or nitrides thereof. In one aspect of this embodiment, the preferred element is silicon, and its preferred compound is silica.

In one embodiment, the substrate 460 contains at least about 50 weight percent of silica.

In another embodiment, the substrate 460 contains at least about 60 weight percent of silica. In yet another embodiment, the substrate 460 contains at least about 70 weight percent of silica. In one aspect of each of these embodiments, the substrate also contains minor amounts of the oxides of calcium and/or lead and/or lithium and/or cerium.

In one embodiment, the substrate 460 has a melting point greater than about 300 degrees Celsius.

In one embodiment, the substrate 460 is flat. In another embodiment, the substrate 460 is curved or arcuate. In one embodiment, the substrate is an optical fiber onto which digital information (such as, e.g., a bar code) has been printed.

In one embodiment, the substrate 460 has a Sheffield smoothness of less than about 200 and, more preferably, less than about 100. In one aspect of this embodiment, the Sheffield smoothness of the substrate is less than about 50 and, more preferably, less than about 20.

In one embodiment, the substrate 460 is transparent. In another embodiment, the substrate is tinted. In yet another embodiment, the substrate is opaque.

In one embodiment, the substrate 460 has a thickness range of about 0.01 inches to 1.0 inches. In another embodiment, the substrate 460 has a thickness range about 0.1 inches to 0.8 inches.

In one embodiment, the substrate 460 comprises at least about 50 weight percent silicon or consists essentially of glass. As is known to those skilled in the art, glass is an amorphous solid made by fusing silica with a basic oxide. See, e.g., pages 376-383 of George S. Brady et al.'s “Materials Handbook,” Thirteenth Edition (McGraw-Hill, Inc., New York, N.Y. 1991).

The substrate 460 may be, e.g., bottle glass. As is known to those skilled in the art, bottle glass is a soda-lime glass with a greenish color due to iron impurities.

The substrate 460 may be, e.g., crown glass, which is a hard soda-lime glass that may contain, e.g., 72 percent of silica, 13 percent of calcium oxide, and 15 percent of sodium oxide. Crown glass is highly transparent and will take a brilliant polish.

The substrate 460 may be, e.g., hard glass (or “Bohemian glass”), which is a potash-lime glass with a high silica content.

The substrate 460 may be, e.g., a lead glass or a lead-alkali glass, with a lead content that ranges from low to high.

The substrate 460 may be, e.g., a borosilicate glass that contains boron oxide.

The substrate 460 may be, e.g., an aluminosilicate glass.

The substrate 460 may be, e.g., a Vicor glass, i.e., a silica glass made from a soft alkaline glass by leaching in hot acid to remove the alkalies and them heating (to 1093 degrees Celsius) to close the pores and shrink the glass.

The substrate 460 may be, e.g., a phosphate glass in which the silica is replaced by phosphorous pentoxide.

The substrate 460 may be, e.g., a sodium-aluminosilicate glass.

The substrate 460 may be fused silica glass, containing 100 percent of silica. Because of its high purity level, fused silica is one of the most transparent glasses.

The substrate 460 may be a flint glass, i.e. a highly transparent soda-lime quartz glass.

The substrate 460 may be a crystal glass that often contains lead to impart brilliance.

The substrate 460 may be an English crystal glass, which is a potash glass containing up to 33 percent of lead oxide. This glass has a high clarity and brilliancy.

The substrate 460 may be a 96 percent silica glass.

The substrate 460 may be a boric oxide (“borax”) glass. In one aspect of this embodiment, the glass used is “invisible glass” which is a borax glass surface treated with a thin film of sodium fluoride. It transmits 99.6% of all visible light and, thus, gives the impression of invisibility.

The substrate 460 may be optical glass, which usually is a flint glass of special composition and which contains silica, soda (sodium carbonate), barium, boron, and lead.

The substrate 460 may be plate glass, i.e., any glass that has been cast or rolled into a sheet and then ground or polished. As is known to those skilled in the art, the good grades of plate glass are, next to optical glass, the most carefully prepared and the most perfect of all of the commercial glasses.

The substrate 460 may be, e.g., conductive glass, i.e., a plate glass with a thin coating of stannic oxide.

The substrate 460 may be, e.g., a transparent mirror made by coating plate glass on one side with a thin film of chromium. This glass is a reflecting mirror when the light behind the glass is less than in front, and it is transparent when the light intensity is higher behind the glass.

The substrate 460 may be, e.g., a colored glass. As is known to those skilled in the art, metal salts are used in glass for coloring as well as controlling the glass characteristics. Manganese oxide colors glass violet to black. A mixture of cobalt oxide and ceric oxide produces “Jena blue glass.” A mixture of selenium and cadmium sulfide produces Ruby glass with a rich red color. Amber glass is made with controlled mixtures of sulfur and iron oxide. Neophane glass is glass containing neodymium oxide. Opalescent glass (or opal glass) has structures that cause light falling on them to be scattered, and they thus are white or translucent.

The substrate 460 may be a Monax glass, i.e., a white diffusing glass for lamp shades and architectural glass.

The substrate 460 may be an oxycarbide glass, in which carbon has been substituted for oxygen (or even nitrogen).

The substrate 460 may be an optical fiber comprising glass.

The substrate 460 may be a glass-ceramic. As is known to those skilled in the art, glass ceramic materials are a family of fine-grained crystalline materials made by a process of controlled crystallization from special glass compositions containing nucleating agents.

The substrate 460 may itself be a coating on another substrate. Thus, e.g., the substrate may be a porcelain enamel coating on a steel substrate.

In a preferred heat treating process, assembly 451 is exposed to temperatures ranging from about 600 degrees Celsius to about 1200 degrees Celsius. In one embodiment, assembly 451 is oscillated to prevent bending or distortion as a standard operating procedure of the tempering process. The duration of exposure of assembly 451 is determined by the thickness of the ceramic substrate and the temperature of the heat treatment. For example, for ¼″ glass the duration is often from about 2 minutes to about 3 minutes at about 700 degrees Celsius. For a ½″ glass substrate, the duration often extends to from about 5 minutes to about 6 minutes at about 700 degrees Celsius.

The heat treatment is often conducted in a furnace. After the heat treatment in furnace, the assembly 451 is preferably transported directly to a quenching chamber. The quenching chamber supplies high volumes of circulated room temperature air that, in one embodiment, is generated by two 500-horsepower turbine motors.

In one embodiment, the duration of exposure to quenching is roughly the same as described for the heat exposure process; and the quenching preferably rapidly brings the assembly 451 back to ambient temperature.

### EXAMPLES

The following Examples are presented to illustrate certain embodiments of the invention but are not to be deemed limitative thereof. Unless otherwise specified, all parts are by weight, and all temperatures are in degrees Centigrade.

Stable colorants have been produced by reducing metallic glass components and precipitating them in glasses. The glasses are fritted, as described in this specification and then ground to a particle size of 6-10 microns. These are then reduced by flowing hydrogen at a temperature between 100° C. less than and the glass transition temperature up to the glass. During the reduction process, large agglomerates of frit may be produced. The resulting powders are reground after reduction to remove large agglomerates so that digital printing inks may be produced. These can be used in inks as the glassy phase, which still surrounds the nano-particles. Black and red colorants are specifically described in this specification. Several low zinc compositions have been produced for use with a particular iron manganese black pigment, which is sensitive to zinc. Several advances include the reduction of ground powder as opposed to bulk glass; the making of a pigment with reduced glass, which will retain its flowability; the use of gaseous reducing agents such as hydrogen, methane and the like to quickly reduce the glass because of very fast diffusion rates; the use of a temperature near, but below the glass transition temperature; the use of bismuth, nickel, or copper for the nano-phase particle etc.

### Example 1

A glass batch composed of 50 mole percent SiO₂, 5 mole percent Bi₂O₃, 15.5 mole percent B₂O₃, 6.5 mole percent Na₂O, 1 mole percent Cu₂O, 10 mole percent BaO, 5 mole percent ZnO, 3 mole percent Li₂O, 1 mole percent ZrO₂, 2 mole percent NiO and 1 mole percent Al₂O₃ was prepared and thoroughly mixed in a V-blender for 5 minutes. 1000 grams of the glass batch was transferred to a crucible made of mulite (Al₃(SiO₂)₂) from DFC Ceramics (515 South 9th Street, Cañon City, Colo. 81212). This glass batch was placed in an electric kiln and heated to 1150° C. in air. The batch was soaked at 1150 C for 1 hour at which time the composition was brought into a liquid state and a solution of the ingredients was formed. The crucible was removed from the kiln and the molten mixture was slowly poured into a 5 gallon pail of room temperature containing water in order to form the glass frit. The frit was separated from the water by filtering through a 1 mm stainless steel screen. The flit was then dry in air for 24 hours and then placed in a ball mill along with 1 inch diameter alumina media. The ball mill was rolled on a roller mill for 24 hours and a white powder was formed. The powder was sifted through a 10 micron screen to remove any remaining larger glass flit particles (these particles could be added back into the ball mill for additional grinding. The sifted glass frit was then placed in a stainless steel reaction vessel. The vessel was heated to 400° C. and a mixture of 4 percent hydrogen gas and 96 per nitrogen gas was passed through the chamber for 24 hours to reduce metal oxides in the frit. When the frit was removed from the reaction chamber it was extremely black in color. The black frit was then placed in a ball mill along with 1 inch diameter alumina media. The ball mill was rolled on a roller mill for 24 hours. The black frit was sifted through a 10 micron screen to remove any remaining larger particles. The resulting product could be added to a printing ink.

### Example 2

A glass batch composed of 51 mole percent SiO₂, 9.5 mole percent Bi₂O₃, 15.5 mole percent B₂O₃, 6.5 mole percent Na₂O, 2 mole percent SrO, 2 mole percent ZnO, 7.5 mole percent Li₂O, 1 mole percent ZrO₂, 2 mole percent NiO, 2 mole percent TiO₂ and 1 mole percent Al₂O₃ was prepared and thoroughly mixed in a V-blender for 5 minutes. 1000 grams of the glass batch was transferred to a crucible made of mulite (Al₃(SiO₂)₂) from DFC Ceramics (515 South 9th Street, Cañon City, Colo. 81212). This glass batch was placed in an electric kiln and heated to 1100° C. in air. The batch was soaked at 1100° C. for 2 hours at which time the composition was brought into a liquid state and a solution of the ingredients was formed. The crucible was removed from the kiln and the molten mixture was slowly poured into a 5 gallon pail at room temperature containing water in order to form the glass frit. The flit was separated from the water by filtering through a 1 mm stainless steel screen. The frit was then dry in air for 24 hours and then placed in a ball mill along with 1 inch diameter alumina media. The ball mill was rolled on a roller mill for 24 hours and a white powder was formed. The powder was sifted through a 10 micron screen to remove any remaining larger glass frit particles (these particles could be added back into the ball mill for additional grinding. The sifted glass frit was then placed in a stainless steel reaction vessel. The vessel was heat to 350° C. and a mixture of 4 percent hydrogen gas and 96 per nitrogen gas was passed through the chamber for 24 hours to reduce metal oxides in the frit. When the flit was removed from the reaction chamber it was extremely black in color. The black frit was then placed in a ball mill along with 1 inch diameter alumina media. The ball mill was rolled on a roller mill for 24 hours. The black frit was sifted through a 10 micron screen to remove any remaining larger particles. The resulting product could be added to a printing ink.

### Example 3

A glass batch composed of 53 mole percent SiO₂, 9.5 mole percent Bi₂O₃, 15.5 mole percent B₂O₃, 6.5 mole percent Na₂O, 2 mole percent SrO, 2 mole percent ZnO, 7.5 mole percent Li₂O, 1 mole percent ZrO₂, 2 mole percent NiO and 1 mole percent Al₂O₃ was prepared and thoroughly mixed in a V-blender for 5 minutes. 1000 grams of the glass batch was transferred to a crucible made of mulite (Al₃(SiO₂)₂) from DFC Ceramics (515 South 9th Street, Cañon City, Colo. 81212). This glass batch was placed in an electric kiln and heated to 1200° C. in air. The batch was soaked at 1200° C. for 4 hours at which time the composition was brought into a liquid state and a solution of the ingredients was formed. The crucible was removed from the kiln and the molten mixture was slowly poured into a 5 gallon pail at room temperature containing water in order to form the glass frit. The frit was separated from the water by filtering through a 1 mm stainless steel screen. The frit was then dry in air for 24 hours and then placed in a ball mill along with 1 inch diameter alumina media. The ball mill was rolled on a roller mill for 24 hours and a white powder was formed. The powder was sifted through a 10 micron screen to remove any remaining larger glass frit particles (these particles could be added back into the ball mill for additional grinding. The sifted glass frit was then placed in a stainless steel reaction vessel. The vessel was heat to 400° C. and a mixture of 4 percent hydrogen gas and 96 per nitrogen gas was passed through the chamber for 24 hours to reduce metal oxides in the frit. When the frit was removed from the reaction chamber it was extremely black in color. The black frit was then placed in a ball mill along with 1 inch diameter alumina media. The ball mill was rolled on a roller mill for 24 hours. The black frit was sifted through a 10 micron screen to remove any remaining larger particles. The resulting product could be added to a printing ink.

### Example 4

A glass batch composed of 53 mole percent SiO₂, 9.5 mole percent Bi₂O₃, 15.5 mole percent B₂O₃, 6.5 mole percent Na₂O, 2 mole percent CaO₂, 2 mole percent ZnO, 6.5 mole percent Li₂O, 2 mole percent NiO, 2 mole percent TiO₂ and 1 mole percent Al₂O₃ was prepared and thoroughly mixed in a V-blender for 5 minutes. 1000 grams of the glass batch was transferred to a crucible made of mulite (Al₃(SiO₂)₂) from DFC Ceramics (515 South 9th Street, Cañon City, Colo. 81212). This glass batch was placed in an electric kiln and heated to 1200 C in air. The batch was soaked at 1200° C. for 4 hours at which time the composition was brought into a liquid state and a solution of the ingredients was formed. The crucible was removed from the kiln and the molten mixture was slowly poured into a 5 gallon pail at room temperature containing water in order to form the glass frit. The frit was separated from the water by filtering through a 1 mm stainless steel screen. The frit was then dried in air for 24 hours and then placed in a ball mill along with 1 inch diameter alumina media. The ball mill was rolled on a roller mill for 24 hours and a white powder was formed. The powder was sifted through a 10 micron screen to remove any remaining larger glass frit particles (these particles could be added back into the ball mill for additional grinding). The sifted glass frit was then placed in a stainless steel reaction vessel. The vessel was heat to 400° C. and a mixture of 4 percent hydrogen gas and 96 per nitrogen gas was passed through the chamber for 24 hours to reduce metal oxides in the frit. When the frit was removed from the reaction chamber it was extremely black in color. The black frit was then placed in a ball mill along with 1 inch diameter alumina media. The ball mill was rolled on a roller mill for 24 hours. The black frit was sifted through a 10 micron screen to remove any remaining larger particles. The resulting product could be added to a printing ink.

To characterize the domain size of the reduced metal oxide moieties in this frit sample, X-ray scattering was used. The frit was mounted on a sample holder and placed in a Phillips X-ray Scattering Spectrometer. The X-ray scattering was taken at a angle of 10 to 70 degrees using copper k-alpha line, the voltage was 40 KV at 30 milliamps. The step size was 0.04 degrees and a second count time was used. The internal standard was silica. It was determined that the domain size of the reduced metal oxide moieties in this glass frit sample were on the order of 25 nanometers.

The density of this frit was found to be 2.6 grams per cubic centimeter.

### Example 5

A glass batch composed of 72 weight percent Ferro 261 glass frit (Ferro Corporation, Washington, Pa.) and 28 weight percent Bi₂O₃ was prepared and thoroughly mixed in a V-blender for 5 minutes. 1000 grams of the glass batch was transferred to a crucible made of mulite (Al₃(SiO₂)₂) from DFC ceramics of CO. This glass batch was placed in an electric kiln and heated to 1200° C. in air. The batch was soaked at 1200° C. for 4 hours at which time the composition was brought into a liquid state and a solution of the ingredients was formed. The crucible was removed from the kiln and the molten mixture was slowly poured into a 5 gallon pail at room temperature containing water in order to form the glass frit. The frit was separated from the water by filtering through a 1 mm stainless steel screen. The frit was then dry in air for 24 hours and then placed in a ball mill along with 1 inch diameter alumina media. The ball mill was rolled on a roller mill for 24 hours and a white powder was formed. The powder was sifted through a 10 micron screen to remove any remaining larger glass frit particles (these particles could be added back into the ball mill for additional grinding. The sifted glass frit was then placed in a stainless steel reaction vessel. The vessel was heat to 500° C. and a mixture of 4 percent hydrogen gas and 96 per nitrogen gas was passed through the chamber for 24 hours to reduce metal oxides in the frit. When the frit was removed from the reaction chamber it was extremely black in color. The black frit was then placed in a ball mill along with 1 inch diameter alumina media. The ball mill was rolled on a roller mill for 24 hours. The black frit was sifted through a 10 micron screen to remove any remaining larger particles. The resulting product could be added to a printing ink.

### Example 6

A glass batch composed of 99 weight percent Ferro 261 glass frit (Ferro Corporation, Washington, Pa.) and 1 weight percent Cu₂O was prepared and thoroughly mixed in a V-blender for 5 minutes. 1000 grams of the glass batch was transferred to a crucible made of mulite (Al₃(SiO₂)₂) from DFC ceramics of CO. This glass batch was placed in an electric kiln and heated to 1450° C. in air. The batch was soaked at 1450° C. for 1 hour at which time the composition was brought into a liquid state and a solution of the ingredients was formed. The crucible was removed from the kiln and the molten mixture was slowly poured into a 5 gallon pail containing water at room temperature in order to form the glass flit. The frit was separated from the water by filtering through a 1 mm stainless steel screen. The frit was then dry in air for 24 hours and then placed in a ball mill along with 1 inch diameter alumina media. The ball mill was rolled on a roller mill for 24 hours and a green powder was formed. The powder was sifted through a 10 micron screen to remove any remaining larger glass frit particles (these particles could be added back into the ball mill for additional grinding. The sifted glass frit was then placed in a stainless steel reaction vessel. The vessel was heat to 500° C. and a mixture of 4 percent hydrogen gas and 96 per nitrogen gas was passed through the chamber for 24 hours to reduce metal oxides in the frit. When the frit was removed from the reaction chamber it was extremely red in color. The red frit was then placed in a ball mill along with 1 inch diameter alumina media. The ball mill was rolled on a roller mill for 24 hours. The red flit was sifted through a 10 micron screen to remove any remaining larger particles. The resulting product could be added to a printing ink.

### Example 7

### Frit of Example 4

In this example a covercoated transfer sheet was prepared with a flexible substrate. The flexible substrate was a 90 gram per square meter basis paper made from bleached softwood and hardwood fibers. The surface was sized with starch. This base paper was coated with a release layer by extrusion coating a polyethylene and extrudable wax (Epolene, from Eastman Chemical Corporation of Kingsport, Tenn.) mixture to a coatweight of 20 gram per square meter.

A covercoat coating composition was prepared for application to the face coat of the flexible substrate. The cover coat was prepared by coating Joncryl 617 (a styrene/acrylic emulsion sold by Johnson Polymers, Racine, Wis.) at a dry coat weight of 15 grams per square meter using a Meyer rod. The coated paper was then allowed to dry at ambient temperature for 16 hours.

In this example a thermal transfer ribbon was prepared for printing onto covercoated transfer paper.

A thermal transfer ink ribbon was prepared by first heating 400 grams of solvent grade toluene to 70° C. in a jacketed 1.2 L vessel while stirring said solvent with a laboratory mixer at 500 rpm. 33.00 g of dioctyl phthalate (Chemcentral, Chicago, Ill.) and 8.40 g of Disperbyk 180 (Byk-Chemie, Wallingford, Conn.) were added to the solvent thus prepared and left under heat and agitation for five minutes to ensure that the solution had become homogenous. Next, 62.76 g of Dianal BR113 (an acrylic copolymer purchased from Dianal America Inc., 9675 Bayport Boulevard, Pasadena, Tex.), 15.48 g of Elvax 250 (an ethylene-vinyl acetate copolymer purchased from DuPont Polymer Products, 1007 Market Street, Wilmington, Del.) and 4.80 g of the polyamide gellant, Uniclear 1 (Arizona Chemical, P.O. Box 550850, Jacksonville, Fla.) were added to the heated solvent and mixed at 70° C. for 15 minutes until all the resins were dissolved and the solution was transparent and pale yellow in color. 475.86 g of the frit prepared in Example 4 was then added to the solution under agitation and mixed for two minutes at 500 rpm to ensure complete wetting of this frit. The frit was quite coarse but with a maximum agglomerate size of around 500 microns. At this point, the mixer was removed and the temperature of the jacketed vessel containing the resin solution was reduced to 30° C. While still cooling, this vessel was placed under a Hockmeyer micro immersion mill (Hockmeyer Equipment Corporation, 6 Kitty Hawk Lane, NC) using a 0.50 mm screen and 1.4-1.6 mm YTZ media (Stanford Materials, 4 Meadowpoint, Aliso Viejo, Calif.). The milling basket of the immersion mill was placed in the ink and the mill started at 200 rpm. The ink was milled at this speed until all the air trapped in the ink was expelled. At this point, the speed of the mill was increased to 3000 rpm and aluminum foil was used to cover the jacketed vessel and shaft of the immersion mill in order to retard solvent loss due to evaporation. The ink was thus milled for four hours until a 7.5 was obtained on a Hegman grind gauge. The head of the basket mill was then raised and the jacketed vessel removed from under the mill. The ink was then poured from the vessel into a quart size steel paint can. This ink was coated via a gravure coating process to give a dry coatweight of 6.5 grams per square meter on to a backcoated thermal transfer film. The backcoating was prepared by applying a mixture of styrene acrylonitrile Lustran SAN33 (Bayer Polymers, 100 Bayer Rd. Pittsburgh, Pa.), Zinc Sterate (Zeller & Gmelin GMBH, Schloss-Strauss 201D-7332 Elislengenfils, Germany), Zelec NK (Dupont Corp, 1007 Market St., Wilmington, Del.) and Printex XE2 (Degussa Corp, 65 Challenger Rd., Ridgefield, N.J.) and Homogenol L18 (KAO Specialities Americas, 243 Woodbine St., High Point, N.C.) at a coatweight of 0.23 grams per square meter using a gravure coating process to a 5.7 micron thick poly(ethylene terepthalate) film (Toray Plastics America, Providence, R.I.).

A ceramic decal was then prepared by printing the thermal transfer ribbon of this example onto the covercoated transfer sheet of this example. The image used was 3″×3.5″ solid fill box. The ribbon was printed onto the decal using a Zebra 140Xii Thermal Transfer printer (Zebra Technologies, 333 Corporate Woods Parkway, Vernon Hills, Ill. 60061) at a printing speed of 2 ips and a darkness setting of 26. The decal was then overprinted with a heat activatable layer. Said heat activatable thermal transfer ribbon was prepared with a 5.7 micron thick poly(ethylene terephthalate) film (Toray Plastics America, 50 Belver Avenue, North Kingstown, R.I. 02852) as the substrate film. The film was backcoated with a mixture of styrene acrylonitrile Lustran SAN33 (Bayer polymers, 100 Bayer Rd. Pittsburgh, Pa.), Zinc Sterate (Zelller & Gmelin GMBH, Schloss-Strauss 201D-7332 Elislengenfils, Germany), Zelec NK (Dupont Corp, 1007 Market St., Wilmington, Del.) and Printex XE2 (Degussa Corp, 65 Challenger Rd., Ridgefield, N.J.) and Homogenol L18 (KAO Specialities Americas, 243 Woodbine St., High Point, N.C.) at a dry coatweight of 0.23 grams per square meter. The backcoat was applied by gravure coating.

The heat activatable overprint ink was prepared by first making a mill-base using 85 grams of toluene and 15 grams of Polywax 500 (a polyethylene wax supplied by Baker Pertrolite, 12645 W. Airport Rd., Sugar Land Tex.). These components were milled via an attritor with steel ball media. The final overprint composition was then prepared by heating 53.55 grams of toluene to 70° C. and stirring in 6.2 grams of the Elvax 40W (Dupont Polymers, 1007 Market St., Wilmington, Del.) and 6.2 grams of the Ceramer 67 (Baker Petrolite, 12645 W. Airport Rd., Sugar Land Tex.). Both materials were allowed to dissolve in the hot toluene. Thereafter 33.47 grams of the mill-base was stirred into this mixture. The mixture was then coated onto the polyester substrate at a dry coating weight of 2.0 gram per square meter using a gravure coating method.

The heat activatable overprint was printed over the entire printed area of the decal. The ceramic heat activatable overprint, ceramic image and covercoating were then transferred off the decal and onto a glass substrate via hot lamination. The overprinted imaged decals were placed image side down onto the glass substrate. A thermally stable tape (3M 5413 polyimide tape) was affixed about 1 inch back and on both sides of the leading edge of the image, making sure to keep the leading edge of the image under tension between the tapes on the glass substrate. The glass substrate and affixed decal are then heated via shuttling of the glass substrate/decal assembly over banks of IR heat lamps. The paper backside of the decal is monitored until a temperature of 185-195 degrees Fahrenheit is achieved. At this temperature the overprint/adhesive has softened sufficiently to deform and adhere to the glass. Once this temperature is achieved the glass substrate/decal assembly is passed through a set of nip rollers to laminate the softened overprint to the glass. The glass substrate/decal assembly is then allowed to cool to below 160° F. and the paper backing is gently peeled off by hand leaving the overprint and fritted image on the glass.

The glass substrate/decal assembly was then tempered at 1266 degrees Fahrenheit for 3 minutes and then quenched with room temperature air. In this process, the carbonaceous binders were oxidatively removed from the image, and the glass flit softened and coalesced into a layer strongly adhered to the surface of the glass substrate. It is estimated that the density of the coalesced flit is approximately 3.2 grams per cubic centimeter.

The thickness of the fired ink layer was estimated to be 1.6 microns.

A Macbeth TD904 model Transmission Densitometer (Macbeth Corporation, Little Britain Rd, Newburg, N.Y. 12550) was used to measure the ortho (visible) transmission density of the tempered image. The transmission density was found to be 1.03. The Td/micron was 0.644.

The tempered image was measured for color via the Datacolor International Spectraflash 600 Spectrophotometer (Lawrenceville, N.J.). The imaged glass was placed in the sample holder with the image facing the light source. The white portion of a Morest chart was used as a backing for the glass. Measured in CIELab color space the L* value was 27.04, “a*” value was 0.69, the “b*” value was 1.18, C* was 1.37 and h was 59.42.

An acid resistance test was performed using ASTM Standard Tests C724 and 1048 (GANA Standard test D.3.3.2) in which 4 drops of 10% citric acid were placed on the fired ceramic image and covered with watch glass for 15 minutes. The watch glass was removed and any remaining liquid removed with a dry cloth. The image was then graded on a scale from 1 to 7 based on the visual appearance of the area attacked by the acid. For “Grade 1,” no attack was apparent, For “Grade 2, there was an appearance of an iridescence of visible stain on the exposed surface when viewed at a 45 degree angle that was not apparent at angles less than 30 degrees. For “Grade 3,” there was a definite stain which does not blur reflected images and is visible at angles less than 30 degrees. For “Grade 4,” there was a definite stain with a gross color change or strongly iridescent surface visible at angles less than 30 degrees and which may blur reflected images. For “Grade 5,” the surface was dull or matte with chalking possible. For “Grade 6,” the surface was dull or matte with chalking possible. For “Grade 6,” there was significant removal of enamel with chalking possible.

The citric acid test was performed via ASTM Standard Test 1048 and was graded a 1.

### Example 8

An ink was prepared with the black frit prepared in Example 4 by mixing 5.5 grams of this black flit with 4.5 g of dioctyl phthalate (Chemcentral, Chicago, Ill.). A glass substrate was prepared by making a square 3″×3″ box border on glass with a 35 micron thick adhesive tape. The black ink was then coated with a “0” meyer rod which slid along the taped edges of the substrate, thus metering the ink onto the substrate at a thickness of 35 microns. The tape was then removed and the coated glass was heat treated in a box kiln (Vcella, Pasadena, Calif.) at 1250° F. for 4 minutes and allowed to cool ambiently. The dioctyl phthalate was burned off in the firing and a hard, clear glassy layer remained. It was estimated that the fired black frit had a density of 2.6 g/cc and a thickness of 11.9 microns.

A Perkin Elmer Lamda 35 UV/Vis Spectrophotometer with a Scan Interval of 600.00-500.00 nm, a Data Interval of 1, a Slit of 2.0 nm, a Scan Speed of 240 nm/min was used to measure the percent transmission of the fired black frit of this example. The fired black flit sample was prepared on a 4″×4″ pieces of 6 mm thick float glass. A blank piece of 6 mm thick float glass was used as a reference sample. The cell holders spectrophotometer were removed from the unit. The two pieces of glass (sample and reference) were then clipped together and placed on a stand. This assembly was then placed in the UV/Vis unit between the standard cell holder placement and the outboard side of the instrument (approximately 1 cm from outer edge of unit). The samples were then scanned, and the percent transmission at 550 nm was found to 0.002. This corresponds to a transmission density of 4.70 and a Td/micron of 0.39. Considering that this sample is considerable thinner than the 30 micron thick samples described in U.S. Pat. No. 5,710,081, the percent transmission at 550 nm is considerable lower than the 0.8 to 1.4 values reported in the '081 patent. Clearly, the reduced frit of this example is much blacker than the frits described as black in the '081 patent. The flit of this example allows 400 times less 550 nm light to pass through it than the blackest of the frits described in the '081 patent.

### Example 9

The experiment of this Example was conducted in substantial accordance with the procedure described in Example 7, except the ink layer was prepared as follows: A thermal transfer ink was prepared by first heating 400 g of solvent grade toluene to 70° C. in a jacketed 1.2 L vessel while stirring said solvent with a laboratory mixer at 500 rpm. 33.00 g of dioctyl phthalate (Chemcentral, Chicago, Ill.) and 8.40 g of Disperbyk 180 (Byk-Chemie, Wallingford, Conn.) were added to the solvent thus prepared and left under heat and agitation for five minutes to ensure that the solution had become homogenous. Next, 62.76 g of Dianal BR113 (an acrylic copolymer purchased from Dianal America Inc., 9675 Bayport Boulevard, Pasadena, Tex.), 15.48 g of Elvax 250 (an ethylene-vinyl acetate copolymer purchased from DuPont Polymer Products, 1007 Market Street, Wilmington, Del.) and 4.80 g of the polyamide gellant, Uniclear 1 (Arizona Chemical, P.O. Box 550850, Jacksonville, Fla.) were added to the heated solvent and mixed at 70° C. for 15 minutes until all the resins were dissolved and the solution was transparent and pale yellow in color. 475.86 g of the frit prepared in Example 4 were then added to the solution under agitation and mixed for two minutes at 500 rpm to ensure complete wetting of this frit. The frit was quite coarse but with a maximum agglomerate size of around 500 microns. At this point, the mixer was removed and the temperature of the jacketed vessel containing the resin solution was reduced to 30° C. While still cooling, this vessel was placed under a Hockmeyer micro immersion mill (Hockmeyer Equipment Corporation, 6 Kitty Hawk Lane, NC) using a 0.50 mm screen and 1.4-1.6 mm YTZ media (Stanford Materials, 4 Meadowpoint, Aliso Viejo, Calif.). The milling basket of the immersion mill was placed in the ink and the mill started at 200 rpm. The ink was milled at this speed until all the air trapped in the ink was expelled. At this point, the speed of the mill was increased to 3000 rpm, and aluminum foil was used to cover the jacketed vessel and shaft of the immersion mill in order to retard solvent loss due to evaporation. The ink was thus milled for four hours until a 7.5 was obtained on a Hegman grind gauge. The head of the basket mill was then raised and the jacketed vessel removed from under the mill.

The ink was then poured from the vessel into a quart size steel paint can. The total yield of the ink was 990 g. 495 g of the ink was poured into another quart size paint can and 80 g of Shepherd Black 444 (a manganese ferrite black spinel from Shepherd Chemical, 4539 Dues Dr., Cincinnati, Ohio) was added along with 53.38 g of solvent grade toluene to balance the percent solids with the unpigmented ink in the first can. 300 g of 0.3 mm ceramic milling media were then added to the paint can containing the pigmented ink which was then placed into a red devil paint shaker and shaken through four cycles at four minutes each. Again a hegman grind of 7.5 was obtained. The ceramic media was then filtered using a 400 micron filter bag.

As in Example 7, the black ink was used to prepare a thermal transfer ribbon which in turn was used to print a ceramic decal. The image was transferred from the decal to a 6 mm thick float glass substrate. The glass substrate/image assembly was then tempered at 1266 degrees Fahrenheit for 3 minutes and then quenched with room temperature air. In this process the carbonaceous binders were oxidatively removed from the image, and the glass frit softened and coalesced into a layer strongly adhered to the surface of the glass substrate. It is estimated that the density of the coalesced frit is approximately 3.56 grams per cubic centimeter.

The thickness of the fired ink layer was estimated to be 1.4 microns.

A Macbeth TD904 model Transmission Densitometer (Macbeth Corporation, Little Britain Rd, Newburg, N.Y. 12550) was used to measure the ortho (visible) transmission density of the tempered image. The transmission density was found to be 1.35. The Td/micron was 0.964.

The tempered image was measured for color via the Datacolor International Spectraflash 600 Spectrophotometer (Lawrenceville, N.J.). The imaged glass was placed in the sample holder with the image facing the light source. The white portion of a Morest chart was used as a backing for the glass. Measured in CIELab color space the L* value was 28.04, the “a*” value was −0.06, the “b*” value was −1.55, C* was 1.55 and the h value was 267.80.

A citric acid test was performed via ASTM 1048. The sample rated a 2 for citric acid.

### Example 10

This experiment of this example was conducted substantially in accordance with the procedure described in Example 7 except the ink layer was prepared as follows: A thermal transfer ink was prepared by first heating 400 g of solvent grade toluene to 70° C. in a jacketed 1.2 L vessel while stirring said solvent with a laboratory mixer at 500 rpm. 33.00 g of dioctyl phthalate (Chemcentral, Chicago, Ill.) and 8.40 g of Disperbyk 180 (Byk-Chemie, Wallingford, Conn.) were added to the solvent thus prepared and left under heat and agitation for five minutes to ensure that the solution had become homogenous. Next, 62.76 g of Dianal BR 13 (an acrylic copolymer purchased from Dianal America Inc., 9675 Bayport Boulevard, Pasadena, Tex.), 15.48 g of Elvax 250 (an ethylene-vinyl acetate copolymer purchased from DuPont Polymer Products, 1007 Market Street, Wilmington, Del.) and 4.80 g of the polyamide gellant, Uniclear 1 (Arizona Chemical, P.O. Box 550850, Jacksonville, Fla.) was added to the heated solvent and mixed at 70° C. for 15 minutes until all the resins were dissolved and the solution was transparent and pale yellow in color. 316.86 g of Ferro 20-8413 glass frit (an unleaded glass frit from Ferro Corp., 1000 Lakeside Ave., Cleveland, Ohio) and 159.00 g of Shepherd Black 444 (a manganese ferrite black spinel from Shepherd Chemical, 4539 Dues Dr., Cincinnati, Ohio) were then added to the solution under agitation and mixed for two minutes at 500 rpm to ensure complete wetting of this frit. At this point, the mixer was removed and the temperature of the jacketed vessel containing the resin solution was reduced to 30° C. While still cooling, this vessel was placed under a Hockmeyer micro immersion mill (Hockmeyer Equipment Corporation, 6 Kitty Hawk Lane, NC) using a 0.50 mm screen and 1.4-1.6 mm YTZ media (Stanford Materials, 4 Meadowpoint, Aliso Viejo, Calif.). The milling basket of the immersion mill was placed in the ink and the mill started at 200 rpm. The ink was milled at this speed until all the air trapped in the ink was expelled. At this point, the speed of the mill was increased to 3000 rpm and aluminum foil was used to cover the jacketed vessel and shaft of the immersion mill in order to retard solvent loss due to evaporation. The ink was thus milled for 1.5 hours until a 7.5 was obtained on a Hegman grind gauge. The head of the basket mill was then raised and the jacketed vessel removed from under the mill. The ink was then poured from the vessel into a quart size steel paint can. The total yield of the ink was 990 g.

As in Example 7, the black ink was used to prepare a thermal transfer ribbon which is turn was used to print a ceramic decal. The image was transferred from the decal to a 6 mm thick float glass substrate. The glass substrate/image assembly was then tempered at 1266 degrees Fahrenheit for 3 minutes and then quenched with room temperature air. In this process the carbonaceous binders were oxidatively removed from the image, and the glass frit softened and coalesced into a layer strongly adhered to the surface of the glass substrate. It is estimated that the density of the coalesced frit is approximately 3.56 grams per cubic centimeter.

The thickness of the fired ink layer was estimated to be 1.6 microns.

A Macbeth TD904 model Transmission Densitometer (Macbeth Corporation, Little Britain Rd, Newburg, N.Y. 12550) was used to measure the ortho (visible) transmission density of the tempered image. The transmission density was found to be 0.93. The Td/micron was 0.581.

The tempered image was measured for color via the Datacolor International Spectraflash 600 Spectrophotometer (Lawrenceville, N.J.). The imaged glass was placed in the sample holder with the image facing the light source. The white portion of a Morest chart was used as a backing for the glass. Measured in CIELab color space the Measured in CIELab color space the L* value was 27.63, the “a*” value was 0.48, the “b*” value was −0.49, C* was 0.69 and the h value was 314.42

A citric acid test was performed via ASTM 1048. The sample rated a 2 for citric acid.

### Example 11

The experiment of this Example was conducted substantially in accordance with the procedure described in Example 7 except the ink layer was prepared as follows: A thermal transfer ink was prepared by first heating 400 g of solvent grade toluene to 70° C. in a jacketed 1.2 L vessel while stirring said solvent with a laboratory mixer at 500 rpm. 33.00 g of dioctyl phthalate (Chemcentral, Chicago, Ill.) and 8.40 g of Disperbyk 2001 (Byk-Chemie, Wallingford, Conn.) were added to the solvent thus prepared and left under heat and agitation for five minutes to ensure that the solution had become homogenous. Next, 62.76 g of Dianal BR 13 (an acrylic copolymer purchased from Dianal America Inc., 9675 Bayport Boulevard, Pasadena, Tex.), 15.48 g of Elvax 250 (an ethylene-vinyl acetate copolymer purchased from DuPont Polymer Products, 1007 Market Street, Wilmington, Del.) and 4.80 g of the polyamide gellant, Uniclear 1 (Arizona Chemical, P.O. Box 550850, Jacksonville, Fla.) was added to the heated solvent and mixed at 70° C. for 15 minutes until all the resins were dissolved and the solution was transparent and pale yellow in color. 475.86 g of Alfred University Blue Frit was then added to the solution under agitation and mixed for two minutes at 500 rpm to ensure complete wetting of this flit. The flit was quite coarse but with a maximum agglomerate size of around 250 microns. At this point, the mixer was removed and the temperature of the jacketed vessel containing the resin solution was reduced to 30° C. While still cooling, this vessel was placed under a Hockmeyer micro immersion mill (Hockmeyer Equipment Corporation, 6 Kitty Hawk Lane, NC) using a 0.50 mm screen and 1.4-1.6 mm YTZ media (Stanford Materials, 4 Meadowpoint, Aliso Viejo, Calif.). The milling basket of the immersion mill was placed in the ink and the mill started at 200 rpm. The ink was milled at this speed until all the air trapped in the ink was expelled. At this point, the speed of the mill was increased to 3000 rpm and aluminum foil was used to cover the jacketed vessel and shaft of the immersion mill in order to retard solvent loss due to evaporation. The ink was thus milled for six hours until a 7.5 was obtained on a Hegman grind gauge, well known to those skilled in the art. The head of the basket mill was then raised and the jacketed vessel removed from under the mill. The ink was then poured from the vessel into a quart size steel paint can.

As in Example 7, the blue ink was used to prepare a thermal transfer ribbon which, in turn, was used to print a ceramic decal. The image was transferred from the decal to a 6 mm thick float glass substrate. The glass substrate/image assembly was then tempered at 1266 degrees Fahrenheit for 3 minutes and then quenched with room temperature air. In this process the carbonaceous binders were oxidatively removed from the image, and the glass flit softened and coalesced into a layer strongly adhered to the surface of the glass substrate. It is estimated that the density of the coalesced flit is approximately 3.2 grams per cubic centimeter.

The thickness of the fired ink layer was estimated to be 1.6 microns.

A Macbeth TD904 model Transmission Densitometer (Macbeth Corporation, Little Britain Rd, Newburg, N.Y. 12550) was used to measure the ortho (visible) transmission density of the tempered image. The transmission density was found to be 0.58. The Td/micron was 0.363.

Measured in CIELab color space the L* value was 44.71, “a*” value was −0.44, the “b*” value was −11.62, C* 11.63 and h 267.85.

A citric acid test was performed via ASTM 1048. The sample rated a 1 for citric acid.

### Example 12

The experiment of this example was conducted in substantial accordance with the procedure described in Example 8, except the ink layer was prepared as follows: A thermal transfer ink was prepared by first heating 400 g of solvent grade toluene to 70° C. in a jacketed 1.2 L vessel while stirring said solvent with a laboratory mixer at 500 rpm. 33.00 g of dioctyl phthalate (Chemcentral, Chicago, Ill.) and 8.40 g of Disperbyk 2001 (Byk-Chemie, Wallingford, Conn.) were added to the solvent thus prepared and left under heat and agitation for five minutes to ensure that the solution had become homogenous. Next, 62.76 g of Dianal BR113 (an acrylic copolymer purchased from Dianal America Inc., 9675 Bayport Boulevard, Pasadena, Tex.), 15.48 g of Elvax 250 (an ethylene-vinyl acetate copolymer purchased from DuPont Polymer Products, 1007 Market Street, Wilmington, Del.) and 4.80 g of the polyamide gellant, Uniclear 1 (Arizona Chemical, P.O. Box 550850, Jacksonville, Fla.) were added to the heated solvent and mixed at 70° C. for 15 minutes until all the resins were dissolved and the solution was transparent and pale yellow in color. 475.86 g of Alfred University Blue Frit was then added to the solution under agitation and mixed for two minutes at 500 rpm to ensure complete wetting of this frit. The frit was quite coarse but with a maximum agglomerate size of around 250 microns. At this point, the mixer was removed and the temperature of the jacketed vessel containing the resin solution was reduced to 30° C. While still cooling, this vessel was placed under a Hockmeyer micro immersion mill (Hockmeyer Equipment Corporation, 6 Kitty Hawk Lane, NC) using a 0.50 mm screen and 1.4-1.6 mm YTZ media (Stanford Materials, 4 Meadowpoint, Aliso Viejo, Calif.). The milling basket of the immersion mill was placed in the ink and the mill started at 200 rpm. The ink was milled at this speed until all the air trapped in the ink was expelled. At this point, the speed of the mill was increased to 3000 rpm and aluminum foil was used to cover the jacketed vessel and shaft of the immersion mill in order to retard solvent loss due to evaporation. The ink was thus milled for six hours until a 7.5 was obtained on a Hegman grind gauge. The head of the basket mill was then raised and the jacketed vessel removed from under the mill. The ink was then poured from the vessel into a quart size steel paint can. The total yield of the ink was 990 g. 495 g of the ink was poured into another quart size paint can and 80 g of Ferro 9025 blue-green superstain (a pigment and silica mixture from Ferro Corporation, 1000 Lakeside Ave., Cleveland, Ohio) was added along with 53.38 g of solvent grade toluene to balance the percent solids with the unpigmented ink in the first can. 300 g of 0.3 mm ceramic milling media were then added to the paint can containing the pigmented ink which was then placed into a red devil paint shaker and shaken through four cycles at four minutes each. Again a Hegman grind of 7.5 was obtained. The ceramic media was then filtered using a 400 micron filter bag.

As in Example 7, the blue ink was used to prepare a thermal transfer ribbon which, in turn, was used to print a ceramic decal. The image was transferred from the decal to a 6 mm thick float glass substrate. The glass substrate/image assembly was then tempered at 1266 degrees Fahrenheit for 3 minutes and then quenched with room temperature air. In this process the carbonaceous binders were oxidatively removed from the image, and the glass frit softened and coalesced into a layer strongly adhered to the surface of the glass substrate. It is estimated that the density of the coalesced frit is approximately 3.5 grams per cubic centimeter.

The thickness of the fired ink layer was estimated to be 1.4 microns.

Measured in CIELab color space the L* value was 39.47, “a*” value was −4.67, the “b*” value was −20.52, C* 21.04 and h 257.19.

A citric acid test was performed via ASTM 1048. The sample rated a 1 for citric acid resistance.

### Example 13

The ink of Example 7 was coated directly on to the non-tin side of a 305 mm by 305 mm piece of 6 mm thick glass using a 4.5″ wide bird type applicator (part number AP-3×0005 TS, supplied by Paul N. Gardner Company Incorporated, 316 NE First St., Pompano Beach, Fla.). The coating was applied to the glass at a width of 3″ on the glass substrate with a wet film thickness of 12 microns. The dry coating weight was 13.48 grams per square meter. The ink was drawn down the entire length of the glass, creating a uniform coating. The ink coating was air dried at room temperature; about 22 degrees C. The samples were then fired in a tempering oven for 240 seconds at 1266 degrees Fahrenheit and air quenched for another 240 seconds. It is estimated that the density of the coalesced frit was approximately 3.2 grams per cubic centimeter.

The thickness of the fired ink layer was estimated to be 3.34 microns.

A Macbeth TD904 model Transmission Densitometer (Macbeth Corporation, Little Britain Rd, Newburg, N.Y. 12550) was used to measure the ortho (visible) transmission density of the tempered image. The transmission density was found to be 2.21. The Td/micron was 0.662.

### Example 14

The ink of Example 13 was diluted in half with toluene and thoroughly mixed. It was then coated directly on to the non-tin side of a 305 mm by 305 mm piece of 6 mm thick glass using a 4.5″ wide bird type applicator (part number AP-3×0005 TS, supplied by Paul N. Gardner Company Incorporated, 316 NE First St., Pompano Beach, Fla.). The coating was applied to the glass at a width of 3″ on the glass substrate with a wet film thickness of 12 microns. The dry coating weight was 7.54 grams per square meter. The ink was drawn down the entire length of the glass, creating a uniform coating. The ink coating was air dried at room temperature; about 22 degrees C. The samples were then fired in a tempering oven for 240 seconds at 1266 degrees Fahrenheit and air quenched for another 240 seconds. It is estimated that the density of the coalesced frit is approximately 3.2 grams per cubic centimeter.

The thickness of the fired ink layer was estimated to be 1.87 microns.

A Macbeth TD904 model Transmission Densitometer (Macbeth Corporation, Little Britain Rd, Newburg, N.Y. 12550) was used to measure the ortho (visible) transmission density of the tempered image. The transmission density was found to be 0.93. The Td/micron was 0.497.

### Example 15

The ink of Example 14 was diluted in half with toluene and thoroughly mixed. It was then coated directly on to the non-tin side of a 305 mm by 305 mm piece of 6 mm thick glass using a 4.5″ wide bird type applicator (part number AP-3×0005 TS, supplied by Paul N. Gardner Company Incorporated, 316 NE First St., Pompano Beach, Fla.). The coating was applied to the glass at a width of 3″ on the glass substrate with a wet film thickness of 12 microns. The dry coating weight was 3.75 grams per square meter. The ink was drawn down the entire length of the glass, creating a uniform coating. The ink coating was air dried at room temperature; about 22 degrees C. The samples were then fired in a tempering oven for 240 seconds at 1266 degrees Fahrenheit and air quenched for another 240 seconds. It is estimated that the density of the coalesced frit is approximately 3.2 grams per cubic centimeter.

The thickness of the fired ink layer was estimated to be 0.93 microns.

A Macbeth TD904 model Transmission Densitometer (Macbeth Corporation, Little Britain Rd, Newburg, N.Y. 12550) was used to measure the ortho (visible) transmission density of the tempered image. The transmission density was found to be 0.48. The Td/micron was 0.516.

### Example 16

The experiment of this Example was conducted in substantial accordance with the procedure described in Example 7, except the ink layer was prepared as follows: A thermal transfer ink was prepared by first heating 200 g of solvent grade toluene to 70° C. in a jacketed 1.2 L vessel while stirring said solvent with a laboratory mixer at 500 rpm. 16.50 g of dioctyl phthalate (Chemcentral, Chicago, Ill.) and 4.2 g of Disperbyk 180 (Byk-Chemie, Wallingford, Conn.) were added to the solvent thus prepared and left under heat and agitation for five minutes to ensure that the solution had become homogenous. Next, 31.38 g of Dianal BR113 (an acrylic copolymer purchased from Dianal America Inc., 9675 Bayport Boulevard, Pasadena, Tex.), 7.74 g of Elvax 250 (an ethylene-vinyl acetate copolymer purchased from DuPont Polymer Products, 1007 Market Street, Wilmington, Del.) and 2.40 g of the polyamide gellant, Uniclear 1 (Arizona Chemical, P.O. Box 550850, Jacksonville, Fla.) was added to the heated solvent and mixed at 70° C. for 15 minutes until all the resins were dissolved and the solution was transparent and pale yellow in color. 158.43 g of the frit prepared in Example 4 were then added to the solution under agitation and mixed for two minutes at 500 rpm to ensure complete wetting of this frit. 79.5 g of Shepard Black 444 pigment were then added to the solution under agitation and mixed for two minutes at 500 rpm to ensure complete wetting of this pigment. The frit was quite coarse but with a maximum agglomerate size of around 500 microns. At this point, the mixer was removed and the temperature of the jacketed vessel containing the resin solution was reduced to 30° C. While still cooling, this vessel was placed under a Hockmeyer micro immersion mill (Hockmeyer Equipment Corporation, 6 Kitty Hawk Lane, NC) using a 0.50 mm screen and 1.4-1.6 mm YTZ media (Stanford Materials, 4 Meadowpoint, Aliso Viejo, Calif.). The milling basket of the immersion mill was placed in the ink and the mill started at 200 rpm. The ink was milled at this speed until all the air trapped in the ink was expelled. At this point, the speed of the mill was increased to 3000 rpm and aluminum foil was used to cover the jacketed vessel and shaft of the immersion mill in order to retard solvent loss due to evaporation. The ink was thus milled for four hours until a 7.5 was obtained on a Hegman grind gauge. The head of the basket mill was then raised and the jacketed vessel removed from under the mill. The ink was then poured from the vessel into a quart size steel paint can.

The ink of this Example was coated directly on to the non-tin side of a 305 mm by 305 mm piece of 6 mm thick glass using a 4.5″ wide bird type applicator (part number AP-3×0005 TS, supplied by Paul N. Gardner Company Incorporated, 316 NE First St., Pompano Beach, Fla.). The coating was applied to the glass at a width of 3″ on the glass substrate with a wet film thickness of 12 microns. The dry coating weight was 13.37 grams per square meter. The ink was drawn down the entire length of the glass, creating a uniform coating. The ink coating was air dried at room temperature; about 22 degrees C. The samples were then fired in a tempering oven for 240 seconds at 1266 degrees Fahrenheit and air quenched for another 240 seconds. It is estimated that the density of the coalesced frit is approximately 3.56 grams per cubic centimeter.

The thickness of the fired ink layer was estimated to be 2.98 microns.

A Macbeth TD904 model Transmission Densitometer (Macbeth Corporation, Little Britain Rd, Newburg, N.Y. 12550) was used to measure the ortho (visible) transmission density of the tempered image. The transmission density was found to be 2.08. The Td/micron was 0.698.

### Example 17

The ink of Example 16 was diluted in half with toluene and thoroughly mixed. It was then coated directly on to the non-tin side of a 305 mm by 305 mm piece of 6 mm thick glass using a 4.5″ wide bird type applicator (part number AP-3×0005 TS, supplied by Paul N. Gardner Company Incorporated, 316 NE First St., Pompano Beach, Fla.). The coating was applied to the glass at a width of 3″ on the glass substrate with a wet film thickness of 12 microns. The dry coating weight was 7.54 grams per square meter. The ink was drawn down the entire length of the glass, creating a uniform coating. The ink coating was air dried at room temperature; about 22 degrees C. The samples were then fired in a tempering oven for 240 seconds at 1266 degrees Fahrenheit and air quenched for another 240 seconds. It is estimated that the density of the coalesced frit is approximately 3.56 grams per cubic centimeter.

The thickness of the fired ink layer was estimated to be 1.66 microns.

A Macbeth TD904 model Transmission Densitometer (Macbeth Corporation, Little Britain Rd, Newburg, N.Y. 12550) was used to measure the ortho (visible) transmission density of the tempered image. The transmission density was found to be 1.44. The Td/micron was 0.867.

### Example 18

The ink of Example 17 was diluted in half with toluene and thoroughly mixed. It was then coated directly on to the non-tin side of a 305 mm by 305 mm piece of 6 mm thick glass using a 4.5″ wide bird type applicator (part number AP-3×0005 TS, supplied by Paul N. Gardner Company Incorporated, 316 NE First St., Pompano Beach, Fla.). The coating was applied to the glass at a width of 3″ on the glass substrate with a wet film thickness of 12 microns. The dry coating weight was 3.60 grams per square meter. The ink was drawn down the entire length of the glass, creating a uniform coating. The ink coating was air dried at room temperature; about 22 degrees C. The samples were then fired in a tempering oven for 240 seconds at 1266 degrees Fahrenheit and air quenched for another 240 seconds. It is estimated that the density of the coalesced frit is approximately 3.56 grams per cubic centimeter.

The thickness of the fired ink layer was estimated to be 0.80 microns.

A Macbeth TD904 model Transmission Densitometer (Macbeth Corporation, Little Britain Rd, Newburg, N.Y. 12550) was used to measure the ortho (visible) transmission density of the tempered image. The transmission density was found to be 0.79. The Td/micron was 0.988.

We claim:

1. A colored glass frit comprised of from about 1 to about 80 weight percent of metallic element material and from about 30 to about 80 mole percent of glassy network forming oxide material (by total moles of oxide material in said frit), wherein:
(a) said glassy network forming oxide material is homogeneously disposed in said colored glass flit,
(b) said metallic element material is in particulate form and has a particle size distribution such that at least 95 weight percent of its particles are smaller than 300 nanometers,
(c) said metallic element material is inhomogeneously dispersed within said glassy network forming oxide material,
(d) said colored glass flit has a specific surface area of less than 2 square meters per gram, and
(e) said glass frit, when formed into a coating with a thickness of 3 microns and deposited as a continuous film onto a 6 millimeter thick float glass substrate, has a transmission density of at least about 0.3.

2. The colored glass frit as recited in claim 1, wherein said glass flit, when formed into a coating with a thickness of 3 microns and deposited as a continuous film onto a 6 millimeter thick float glass substrate, has a transmission density of at least about 1.0.

3. The colored glass frit as recited in claim 2, wherein:
(a) said colored glass frit is comprised of from about 40 to about 60 mole percent of silica, by total moles of oxide material in said frit, and
(b) said glass frit is comprised of from about 20 to about 50 weight percent of said metallic element material.

4. The colored glass flit as recited in claim 2, wherein said glassy network forming oxide material is are selected from the list of oxides of silicon, boron, phosphorous, germanium, arsenic, beryllium and mixtures thereof.

5. The colored glass flit as recited in claim 2, wherein said colored glass frit is comprised of at least about 10 mole percent of B₂O₃ and 50 mole percent SiO₂ by total moles of oxide material in said frit.

6. The colored glass flit as recited in claim 4, wherein said metallic element is selected from the group consisting of copper, gold, silver, iron, bismuth, nickel, titanium, lead, indium, tin, cadmium, mercury, ruthenium, osmium, molybdenum, tantalum, zinc and mixtures thereof.

7. The colored glass frit as recited in claim 6, wherein said metallic element is bismuth.

8. The colored glass flit as recited in claim 6, wherein said metallic element is copper.

9. The colored glass frit as recited in claim 6, further comprising a pigment.

10. The colored glass flit as recited in claim 7, wherein said colored glass coating at a thickness of 3 microns, has a reflective color a chromaticity (a*) of from −15 to 15 and (b*) from −30 to 30 and a lightness (L*) of less than about 50 when expressed by the CIE Lab color coordinate system.

11. The colored glass frit as recited in claim 6, wherein said colored glass frit has a specific surface area of less than 1 square meter per gram.

12. The colored glass frit as recited in claim 6, wherein at least 90 weight percent of said metallic material has an average particle size of less than about 100 nanometers.

13. The colored glass frit as recited in claim 6, wherein at least about 80 weight percent of said metallic material has particle size less than about 45 nanometers.

14. The colored glass frit as recited in claim 6, wherein said frit has a density of at least about 3 grams per cubic centimeter.

15. The colored frit as recited in claim 6, wherein said frit has a density of at least about 3.5 grams per cubic centimeter.

16. The colored glass flit as recited in claim 1, wherein said glass frit, when formed into a coating with a thickness of 3 microns and deposited as a continuous film onto a 6 millimeter thick float glass substrate, has a transmission density of at least about 1.5.

17. The colored glass frit as recited in claim 9, wherein said frit is comprised of from about 5 to about 30 weight percent of pigment.

18. The colored glass frit as recited in claim 8, wherein said coating, has a reflective color represented by a chromaticity (a*) of from 30 to 80 and (b*) from 30 to 80 and a lightness L* of less than about 65 when expressed by the CIE Lab color coordinate system.

19. The colored glass frit as recited in claim 18, wherein said frit is comprised of particles of copper that are smaller than 100 nanometers.

20. A liquid ceramic ink comprised of from about 0.5 to about 85 weight percent of the colored frit recited in claim 1.

21. The liquid ceramic ink as recited in claim 20, further comprising from about 5 to about 99.5 weight percent of a carbonaceous binder.

22. The ceramic ink as recited in claim 21, wherein said liquid ceramic ink is comprised of from about 0.01 to about 10 weight percent of said carbonaceous binder.

23. The liquid ceramic ink as recited in claim 22, wherein at least 90 percent of said colored glass frit is in the form of particles with a particle size smaller than about 10 microns.

24. The liquid ceramic ink as recited in claim 23, further comprising pigment.

25. A thermal transfer ribbon comprised of the colored frit recited in claim 1, wherein said thermal transfer ribbon is also comprised of a flexible support.

26. The thermal transfer ribbon as recited in claim 25, wherein said ribbon is comprised of a ceramic ink layer.

27. The thermal transfer ribbon as recited in claim 26, wherein said ribbon is comprised of an undercoat layer disposed between said flexible support and said ceramic ink layer.

28. The thermal transfer ribbon as recited in claim 27, wherein a backcoat layer is disposed beneath said flexible support.

29. The thermal transfer ribbon as recited in claim 28, wherein said undercoat layer is contiguous with said flexible support.

30. The thermal transfer ribbon as recited in claim 29, wherein said colored frit is disposed within said ceramic ink layer

31. The thermal transfer ribbon as recited in claim 30, wherein said ceramic ink layer is comprised of at least 25 weight percent of said colored frit.

32. The thermal transfer ribbon as recited in claim 30, wherein said ceramic ink layer is comprised of from about 35 to about 85 weight percent of said colored frit.

33. The thermal transfer ribbon as recited in claim 30, wherein said ceramic ink layer is comprised of from about 65 to about 75 weight percent of said colored frit.

34. The thermal transfer ribbon as recited in claim 32, wherein said ceramic ink layer is comprised of at least about 5 weight percent, by dry weight, of silica.

35. The thermal transfer ribbon as recited in claim 33, wherein said ceramic ink layer is comprised of thermoplastic binder.

36. The thermal transfer ribbon as recited in claim 34, wherein said binder has a softening point from about 45 to about 150 degrees Celsius.

37. The thermal transfer ribbon as recited in claim 35, wherein said ceramic ink layer is comprised of wax.

38. The thermal transfer ribbon as recited in claim 37, wherein said colored glass frit is comprised of from about 5 to about 15 mole percent of B₂O₃, by total moles of oxide material in said frit.
